(19) United States
(12) Patent Application Publication
(10) Pub. No.: US 2006/0006354 A1
(43) Pub. Date: Jan. 12, 2006

(54) Optical sensors and algorithms for controlling automatic bathroom flushers and faucets

(76) Inventors: Fatih Guler, Winchester, MA (US); Natan E. Parsons, Brookline, MA (US); Yue Zhang, Nashua, NH (US); Xiaoxiong Mo, Lexington, MA (US); Kay Herbert, Winthrop, MA (US); Haiou Wu, West Roxbury, MA (US)

Correspondence Address: IVAN DAVID ZITKOVSKY PH.D PC, 5 MILITIA DRIVE, LEXINGTON, MA, 02421, US

(21) Appl. No.: 11/159,422

(22) Filed: Jun. 22, 2005

Related U.S. Application Data
(63) Continuation of application No. PCT/US03/41303, filed on Dec. 26, 2003.
Application No. PCT/US03/41303 is a continuation-in-part of application No. 10/421,359, filed on Apr. 23, 2003, now Pat. No. 6,948,697.

(30) Foreign Application Priority Data
Dec. 4, 2003 (WO) PCT/US03/38730
Jun. 24, 2003 (WO) PCT/US03/20117
Dec. 26, 2002 (WO) PCT/US02/41576
Dec. 4, 2002 (WO) PCT/US02/38757
Dec. 4, 2002 (WO) PCT/US02/38758

(51) Int. Cl. F16K 31/02

(52) U.S. Cl. 251/129.04

(57) ABSTRACT

The present invention is directed to novel optical sensors and novel methods for sensing optical radiation that can be used to control the operation of automatic faucets and flushers. The novel sensors and flow controllers require only small amounts of electrical power for sensing users of bathroom facilities, enabling battery operation for many years. An electronic system for controlling fluid flow may include an electromagnetic actuator, a controller and an optical sensor. Preferred embodiments include a control circuit constructed to sample periodically the detector based on the amount of light detected; a control circuit constructed to adjust a sample period based on the detected amount of light after determining whether a facility is in use; a detector optically coupled to the input port using an optical fiber; the input port may be located in an aerator of the electronic faucet; the system includes batteries for powering the electronic faucet. These embodiments may also include a variety of other features. A passive optical sensor includes a light detector sensitive to ambient (room) light for controlling the operation of automatic faucets or automatic bathroom flushers. An active optical sensor includes a light emitter and a light detector. The detected signals may be processed using novel algorithms

This application is a continuation of PCT Application PCT/US03/041303, filed on Dec. 26, 2003, which is a continuation-in-part of PCT Application PCT/US03/38730, entitled “Passive Sensors for Automatic Faucets and Bathroom Flushers” filed on Dec. 4, 2003, which claims priority from U.S. Application 60/513,722, “Automatic Faucets with Novel Flow Control Sensors,” filed on Oct. 22, 2003 and is a continuation-in-part of PCT Application PCT/US03/20117, “Irrigation Systems and Control Methods,” filed on Jun. 24, 2003; and PCT Application PCT/US02/41576, “Automatic Bathroom Flushers” filed on Dec. 26, 2002; all of which are incorporated by reference.

This application is also a continuation-in-part of PCT Application PCT/US02/38757, “Electronic Faucets for Long Term Operation,” filed on Dec. 4, 2002; and PCT Application PCT/US02/38758, “Automatic Bathroom Flushers,” filed on Dec. 4, 2002; both of which are incorporated by reference.

The present invention is directed to novel optical sensors and algorithms for controlling automatic bathroom flushers and faucets.

### BACKGROUND OF THE INVENTION

Automatic faucets and bathroom flushers have been used for many years. An automatic faucet typically includes an optical or other sensor that detects the presence of an object, and an automatic valve that turns water on and off, based on a signal from the sensor. An automatic faucet may include a mixing valve connected to a source of hot and cold water for providing a proper mixing ratio of the delivered hot and cold water after water actuation. The use of automatic faucets conserves water and promotes hand washing, and thus good hygiene. Similarly, automatic bathroom flushers include a sensor and a flush valve connected to a source of water for flushing a toilet or urinal after actuation. The use of automatic bathroom flushers generally improves cleanliness in public facilities.

In an automatic faucet, an optical or other sensor provides a control signal and a controller that, upon detection of an object located within a target region, provides a signal to open water flow. In an automatic bathroom flusher, an optical or other sensor provides a control signal to a controller after a user leaves the target region. Such systems work best if the object sensor is reasonably discriminating. An automatic faucet should respond to a user's hands, for instance, it should not respond to the sink at which the faucet is mounted, or to a paper towel thrown in the sink. Among the ways of making the system discriminate between the two it has been known to limit the target region in such a manner as to exclude the sink's location. However, a coat or another object can still provide a false trigger to the faucet. Similarly, this could happen to automatic flushers due to a movement of bathroom doors, or something similar.

An optical sensor includes a light source (usually an infra-red emitter) and a light detector sensitive to the IR wavelength of the light source. For faucets, the emitter and the detector (i.e., a receiver) can be mounted on the faucet spout near its outlet, or near the base of the spout. For flushers, the emitter and the detector may be mounted on the flusher body or on a bathroom wall. Alternatively, only optical lenses (instead of the emitter and the receiver) can be mounted on these elements. The lenses are coupled to one or several optical fibers for delivering light from the light source and to the light detector. The optical fiber delivers light to and from the emitter and the receiver mounted below the faucet.

In the optical sensor, the emitter power and/or the receiver sensitivity is limited to restrict the sensor's range to eliminate reflections from the sink, or from the bathroom walls or other installed objects. Specifically, the emitting beam should project on a valid target, normally clothing, or skin of human hands, and then a reflected beam is detected by the receiver. This kind of sensor relies on the reflectivity of a target's surface, and its emitting/receiving capabilities. Frequently, problems arise due to highly reflective doors and walls, mirrors, highly reflective sinks, the shape of different sinks, water in the sink, the colors and rough/shiny surfaces of fabrics, and moving users who are walking by but not using the facility. Mirrors, doors, walls, and sinks are not valid targets, although they may reflect more energy back to the receiver than rough surfaces at the right angle incidence. The reflection of valid targets such as various fabrics varies with their colors and the surface finish. Some kinds of fabrics absorb and scatter too much energy of the incident beam, so that less of a reflection is sent back to the receiver.

A large number of optical or other sensors are powered by a battery. Depending on the design, the emitter (or the receiver) may consume a large amount of power and thus deplete the battery over time (or require large batteries). The cost of battery replacement involves not only the cost of batteries, but more importantly the labor cost, which may be relatively high for skilled personnel.

There is still a need for an optical sensor for use with automatic faucets or automatic bathroom flushers that can operate for a long period of time without replacing the standard batteries. There is still a need for reliable sensors for use with automatic faucets or automatic bathroom flushers.

### SUMMARY OF THE INVENTION

The present invention is directed to novel optical sensors and novel methods for sensing optical radiation. The novel optical sensors and the novel optical sensing methods are used, for example, for controlling the operation of automatic faucets and flushers. The novel sensors and flow controllers (including control electronics and valves) require only small amounts of electrical power for sensing users of bathroom facilities, and thus enable battery operation for many years. A passive optical sensor includes a light detector sensitive to ambient (room) light for controlling the operation of automatic faucets or automatic bathroom flushers. An active optical sensor includes a light emitter and a light detector. The detected signals may be processed using novel algorithms

According to one aspect an electronic system for controlling fluid flow includes an electromagnetic actuator, a controller and an optical sensor. The controller is coupled to a power driver constructed to provide a drive signal to the actuator and thereby opening or closing a valve for the fluid flow. The optical sensor is constructed and arranged to provide a signal to the controller.

Preferred embodiments may include one or more of the following: The electronic system includes a leak detector constructed to detect the fluid flow across the closed valve. The leak detector includes at least two electric leads, wherein the electric leads are coupled to measure electric signal across the closed valve to determine the fluid flow across the valve in the closed state. The leak detector includes the electric leads constructed and arranged to measure resistance, capacitance or inductance across the closed valve.

The electronic system may further include an indicator constructed to indicate a leak detected by the leak detector.

The electronic system may be installed to control water flow in a faucet. The electronic system may be installed to control water flow in a bathroom flusher.

According to another aspect, an optical sensor for controlling a valve of an electronic faucet or bathroom flusher includes an optical element located at an optical input port and arranged to partially define a detection field. The optical sensor also includes a light detector and a control circuit. The light detector is optically coupled to the optical element and the input port, wherein the light detector is constructed to detect ambient light. The control circuit is constructed for controlling opening and closing of a flow valve. The control circuit is also constructed to receive signal from the light detector corresponding to the detected light.

The control circuit is constructed to sample periodically the detector. The control circuit is constructed to sample periodically the detector based on the amount of previously detected light. The control circuit is constructed to determine the opening and closing of the flow valve based on a background level of the ambient light and a present level of the ambient light. The control circuit is constructed to open and close the flow valve based on first detecting arrival of a user and then detecting departure of the user. Alternatively, the control circuit is constructed to open and close the flow valve based on detecting presence of a user.

The optical element includes an optical fiber, a lens, a pinhole, a slit or an optical filter. The optical input port is located inside an aerator of a faucet or next to an aerator of the faucet.

According to another aspect, an optical sensor for an electronic faucet includes an optical input port, an optical detector, and a control circuit. The optical input port is arranged to receive light. The optical detector is optically coupled to the input port and constructed to detect the received light. The control circuit controls opening and closing of a faucet valve, or a bathroom flusher valve.

Preferred embodiments of this aspect include one or more of the following features: The control circuit is constructed to sample periodically the detector based on the amount of light detected. The control circuit is constructed to adjust a sample period based on the detected amount of light after determining whether a facility is in use. The detector is optically coupled to the input port using an optical fiber. The input port may be located in an aerator of the electronic faucet. The system includes batteries for powering the electronic faucet.

According to yet another aspect, an optical sensor for controlling a valve of an electronic faucet or bathroom flusher include a light emitter, a light detector and a control circuit. The light emitter is constructed and arranged to emit light to a selected direction. The light detector is constructed and arranged to detect light corresponding to a reflection of the emitted light from a target. The control circuit for controlling opening and closing of a flow valve, wherein the control circuit is constructed to direct light emission from the light emitter and constructed to receive signal from the light detector corresponding to the detected light.

### BRIEF DESCRIPTION OF THE DRAWINGS

FIG. 1 is a schematic view of an automatic faucet system including a control circuit, a valve and a passive optical sensor for controlling water flow.

FIG. 1A is a cross-sectional view of a spout and a sink of the automatic faucet system of FIG. 1 using a fiberoptic coupling to the passive optical sensor.

FIG. 1B is a cross-sectional view of a spout and a sink of the automatic faucet system of FIG. 1 using an electric coupling to the passive optical sensor.

FIG. 1C is a cross-sectional view of an aerator used in the automatic faucet system of FIG. 1.

FIG. 1D is a cross-sectional view of another embodiment of the aerator used in the automatic faucet system of FIG. 1.

FIG. 1E is a perspective view of another embodiment of the aerator used in the automatic faucet system of FIG. 1.

FIG. 1F is a cross-sectional view of the aerator shown in FIG. 1D.

FIGS. 2 and 2A show schematically other embodiments of automatic faucet systems, including another embodiment of a valve and a passive optical sensor for controlling water flow.

FIGS. 3, 3A, 3B, 3C and 3D show schematically a faucet and a sink relative to different optical detection patterns used by passive optical sensors employed in the automatic faucet systems of FIGS. 1, 1B, 2, and 2A.

FIG. 4 shows schematically a side view of a toilet including an automatic flusher.

FIG. 4A shows schematically a side view of a urinal including an automatic flusher.

FIG. 4B is a perspective view of an automatic bathroom flusher used for flushing a toilet or a urinal, having a flusher cover removed.

FIG. 4C is a cross-sectional view of the flusher mainly illustrating an electronic control module and a solenoid actuator located inside of the flusher cover.

FIG. 4D is a perspective exploded view of the flusher cover shown in FIG. 4B.

FIGS. 5, 5A, 5B, 5C, 5D, 5E, 5F and 5G show schematically side and top views of different optical detection patterns used by passive optical sensors employed in the automatic toilet flusher of FIG. 4.

FIGS. 5H, 51, 5J, 5K and 5L show schematically side and top views of different optical detection patterns used by passive optical sensors employed in the automatic urinal flusher of FIG. 4A.

FIGS. 6, 6A, 6B, 6C, 6D and 6E show schematically optical elements used to form the different optical detection patterns shown in FIGS. 3 through 3D and in FIGS. 5 through 5L.

FIG. 7 is a cross-sectional view of another embodiment of an automatic flusher using a passive optical sensor for flushing toilets or urinals.

FIG. 7A is a cross-sectional view of another embodiment of an automatic flusher using an active optical sensor for flushing toilets or urinals.

FIG. 8 is a perspective exploded view of a valve device used in the automatic faucet system of FIGS. 1, 1A or 1B.

FIG. 8A is an enlarged cross-sectional view of the valve device shown in FIG. 8.

FIG. 8B is an enlarged cross-sectional view of the valve device shown in FIG. 8A, but partially disassembled for servicing.

FIG. 8C is a perspective view of the valve device of FIG. 4, including a leak detector for detecting water leaks in an automatic faucet system.

FIG. 9 is an enlarged cross-sectional view of a moving piston-like member used in the valve device shown in FIG. 7 or the valve device shown in FIGS. 8, 8A, and 8B.

FIG. 9A is a detailed perspective view of the moving piston-like member shown in FIG. 9.

FIG. 10 is block diagram of a control system for controlling a valve operating the automatic faucet systems of FIGS. 1 through 2A, or bathroom flushers of FIGS. 4B and 7.

FIG. 10A is block diagram of another control system for controlling a valve operating the automatic faucet systems of FIGS. 1 through 2A, or bathroom flushers of FIGS. 4, 4A and 7A.

FIG. 10B is a schematic diagram of a detection circuit used in passive optical sensor used in the automatic faucet system or the automatic flusher system.

FIG. 11 is a block diagram that illustrates various factors that affect operation and calibration of the active or passive optical sensor.

FIGS. 12, 12A, 12B, 12C, 12D, 12E, 12F, 12G, 12H and 12I show a flow diagram of an algorithm for processing optical data detected by the passive sensor operating the automatic flusher system of FIG. 4B or FIG. 7.

FIGS. 13, 13A and 13B show a flow diagram of an algorithm for processing optical data detected by the passive sensor operating the automatic faucet system.

FIGS. 14, 14A, 14B and 14C illustrate flow diagram of an algorithm for processing optical data detected by the active sensor operating the automatic flusher system of FIG. 7A.

FIGS. 15, 15A-I, 15A-II, 15B, 15C-I, 15C-II, 16D-I and 15D-II illustrate a flow diagram of an algorithm for processing optical data detected by either the active or passive sensor operating the automatic flusher system delivering water amounts depending on actual use.

### DETAILED DESCRIPTION OF ILLUSTRATIVE EMBODIMENTS

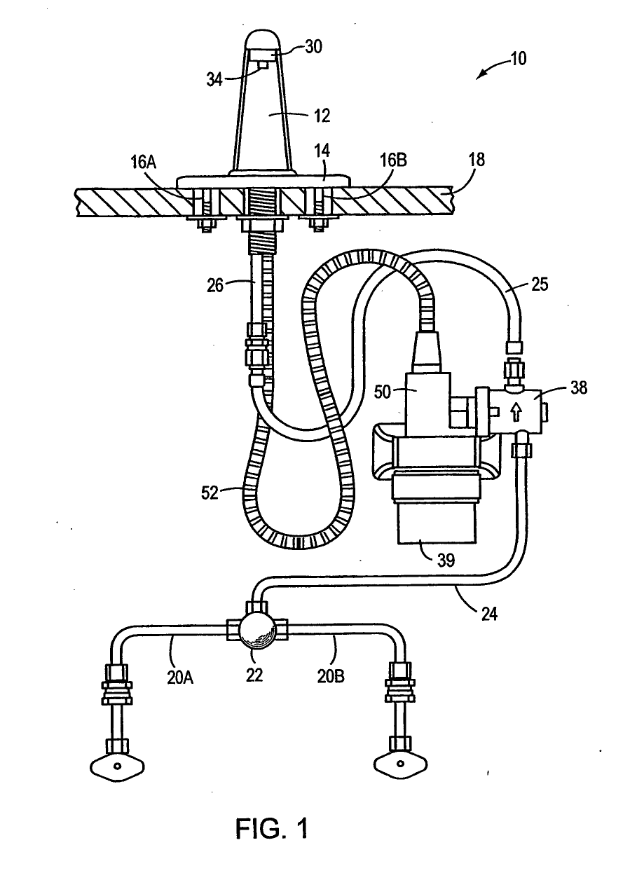

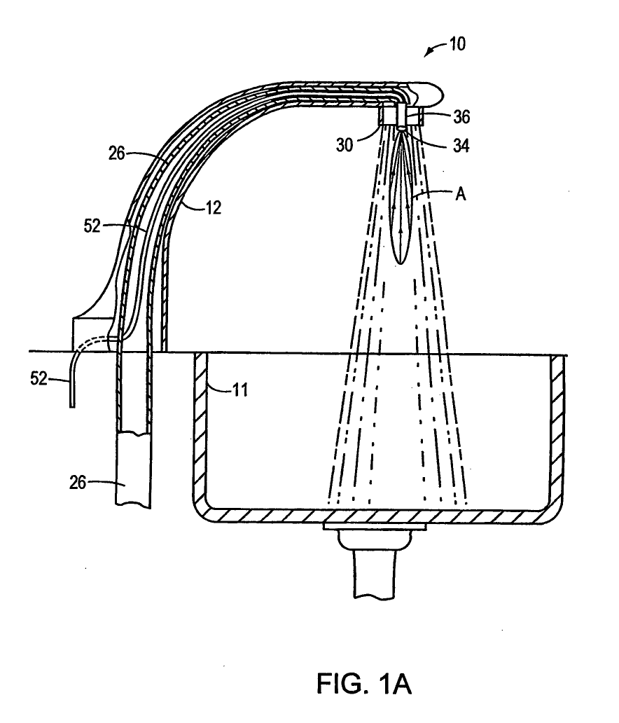

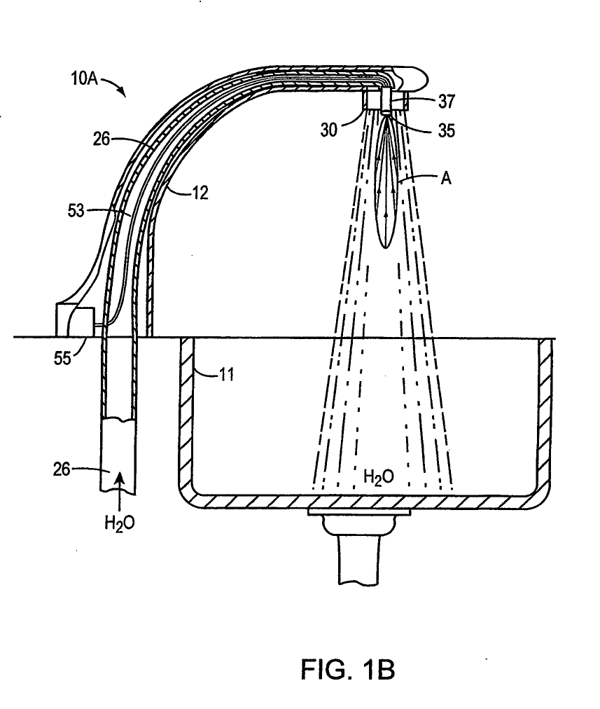

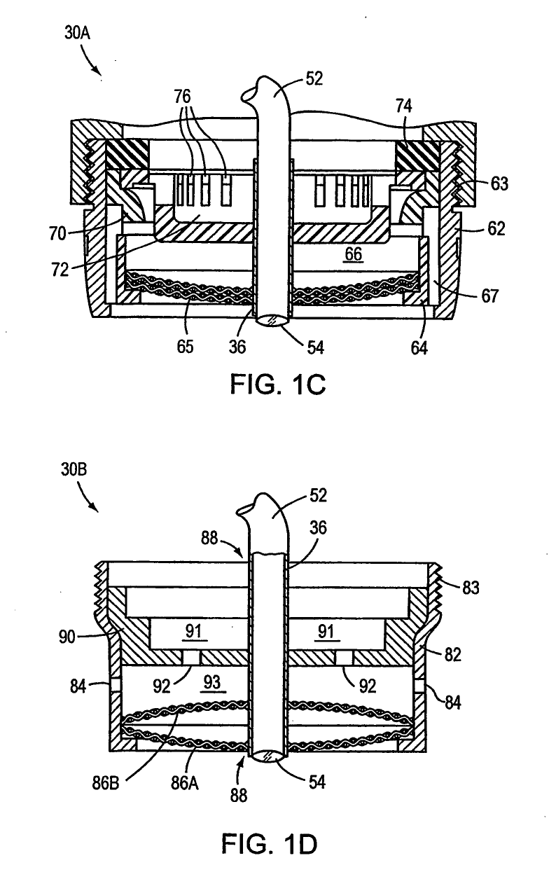

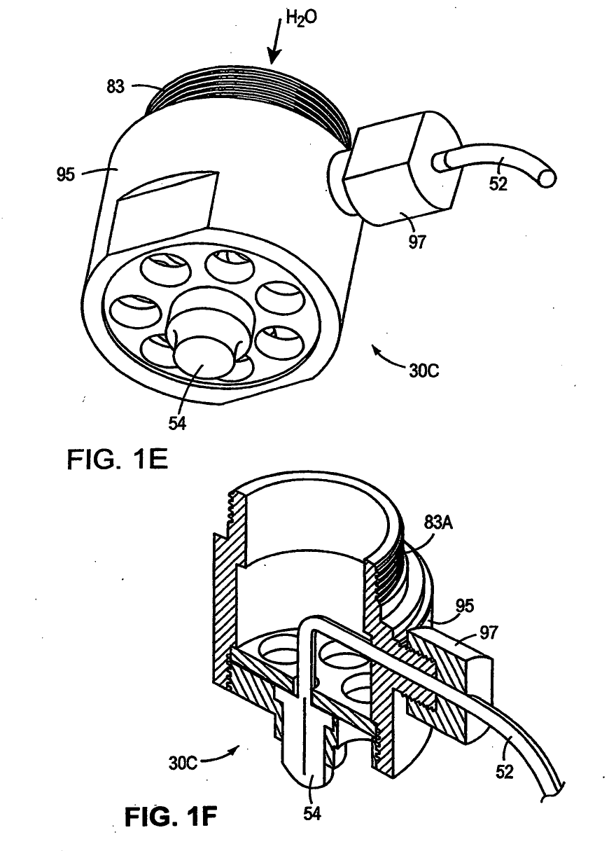

FIG. 1 shows an automatic faucet system 10 controlled by a sensor providing signals to a control circuit constructed and arranged to control operation of an automatic valve. The automatic valve, in turn, controls the flow of hot and cold water before or after mixing.

Automatic faucet system 10 includes a faucet body 12 and an aerator 30, including a sensor port 34. Automatic faucet system 10 also includes a faucet base 14 and screws 16A and 16B for attaching the faucet to a deck 18. A cold water pipe 20A and a hot water pipe 20B are connected to a mixing valve 22 providing a mixing ratio of hot and cold water (which ratio can be changed depending on the desired water temperature). Water conduit 24 connects mixing valve 22 to a solenoid valve 38. A flow control valve 38 controls water flow between water conduit 24 and a water conduit 25. Water conduit 25 connects valve 38 to a water conduit 26 partially located inside faucet body 12, as shown. Water conduit 26 delivers water to aerator 30. Automatic faucet system 10 also includes a control module 50 for controlling a faucet sensor and solenoid valve 38, powered by batteries located in battery compartment 39.

Referring to FIGS. 1 and 1A, in a first preferred embodiment, automatic faucet system 10 includes an optical sensor located in control module 50 and optically coupled by a fiberoptic cable 52 to sensor port 34 located in aerator 30. Sensor port 34 receives the distal end of fiberoptic cable 52, which may be coupled to an optical lens located at sensor port 34. The optical lens is arranged to have a selected field of view, which is preferably somewhat coaxial within the water stream discharged from aerator 30, when the faucet is turned on.

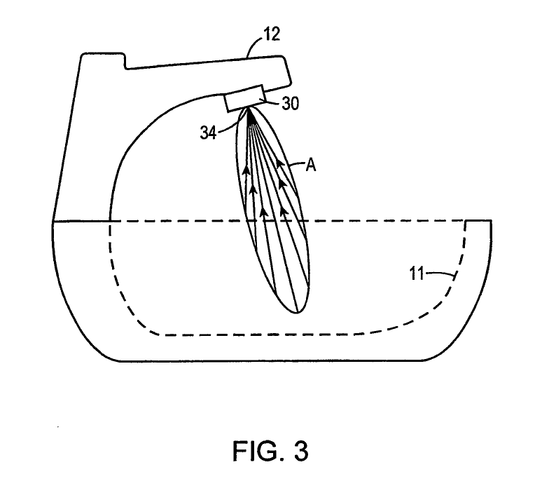

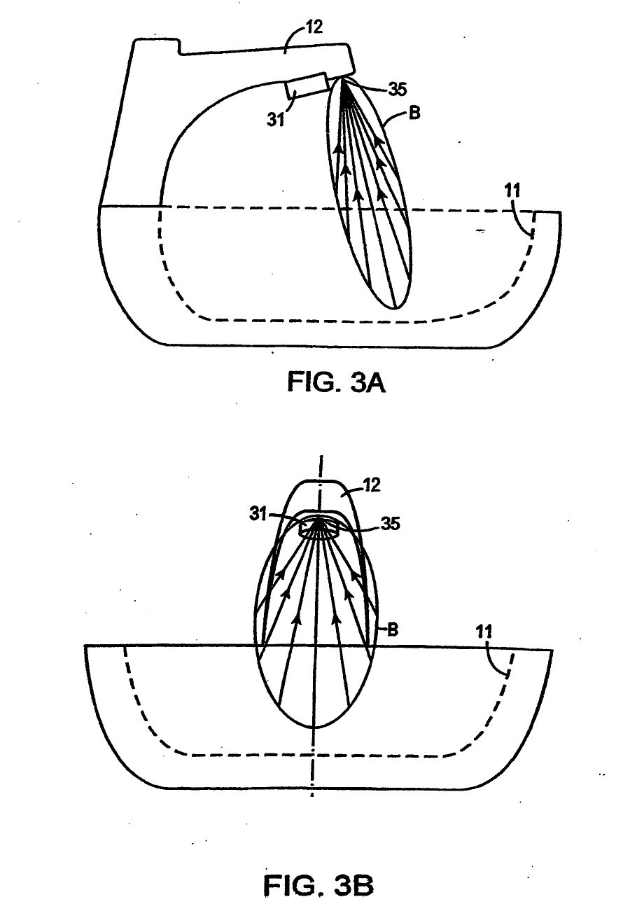

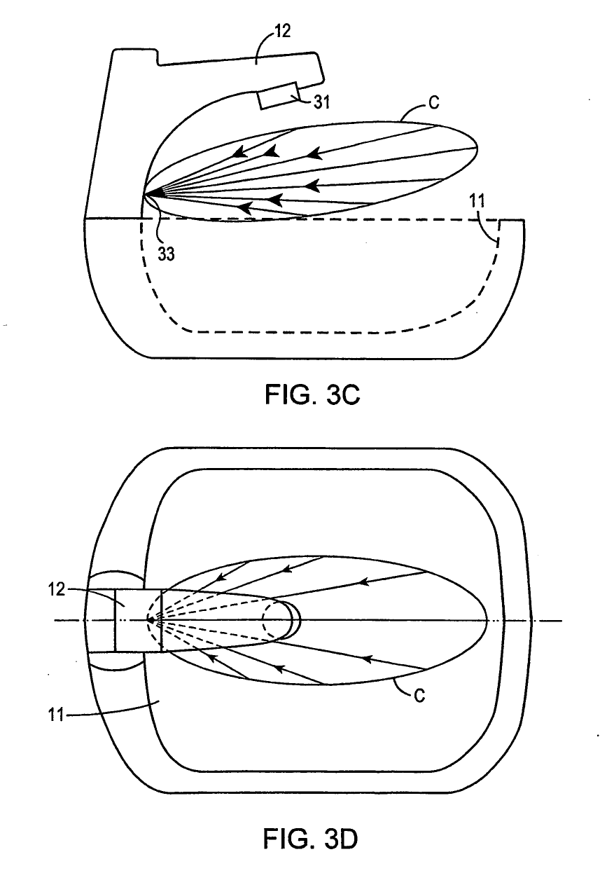

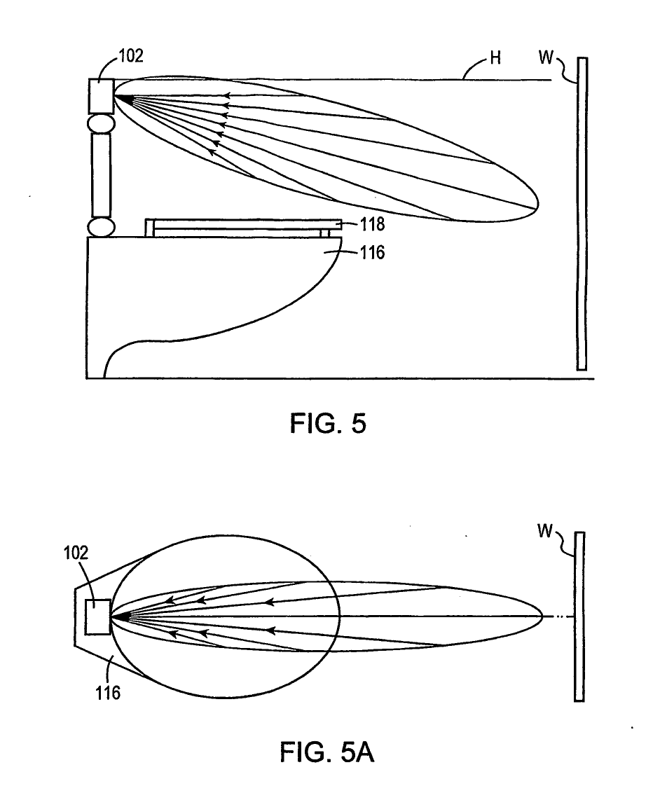

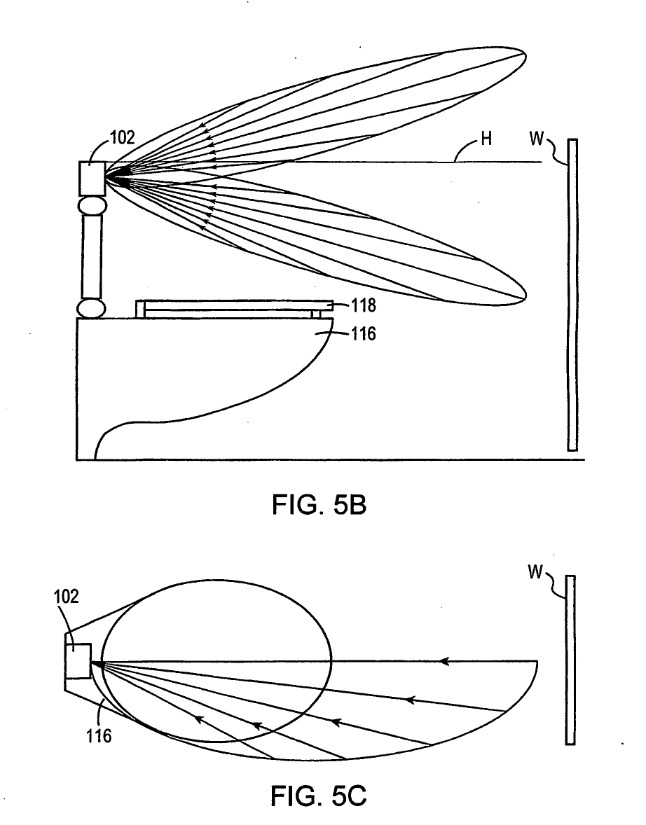

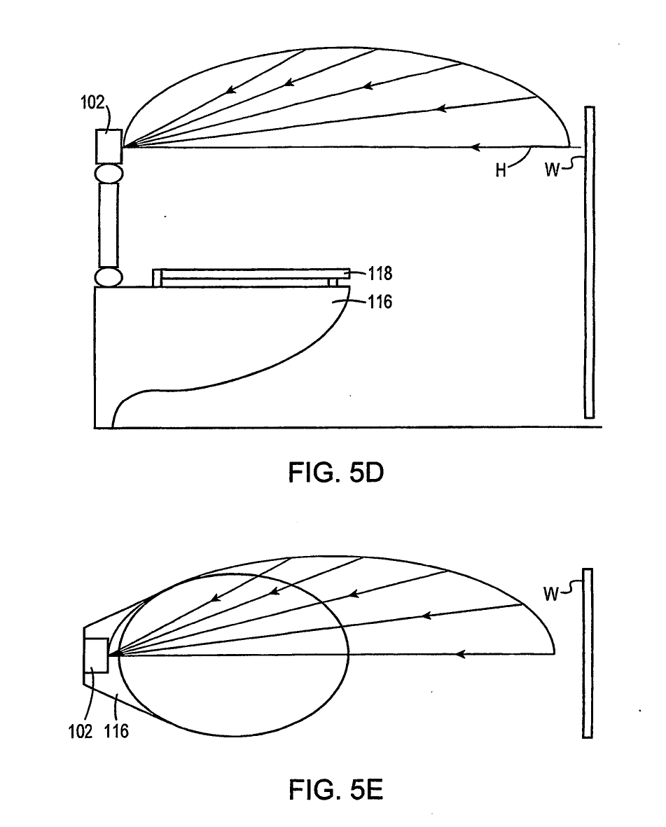

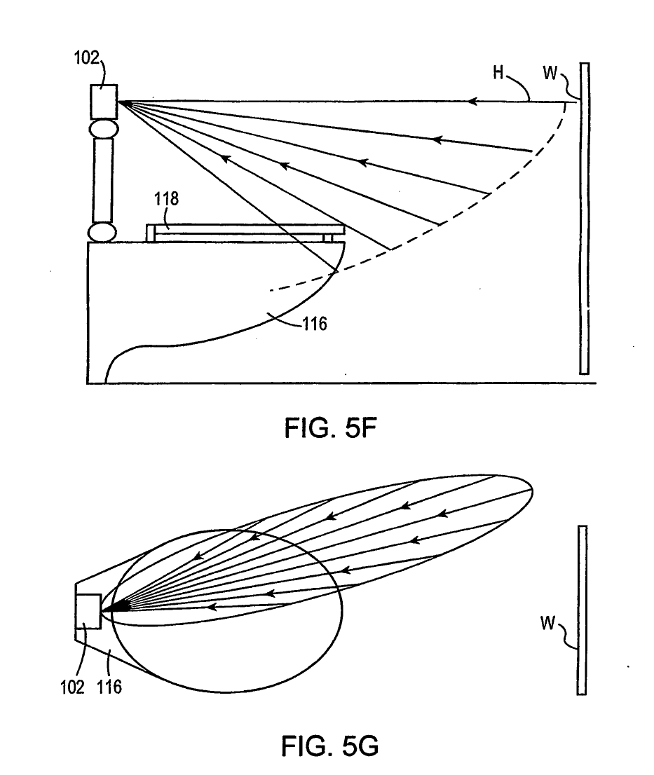

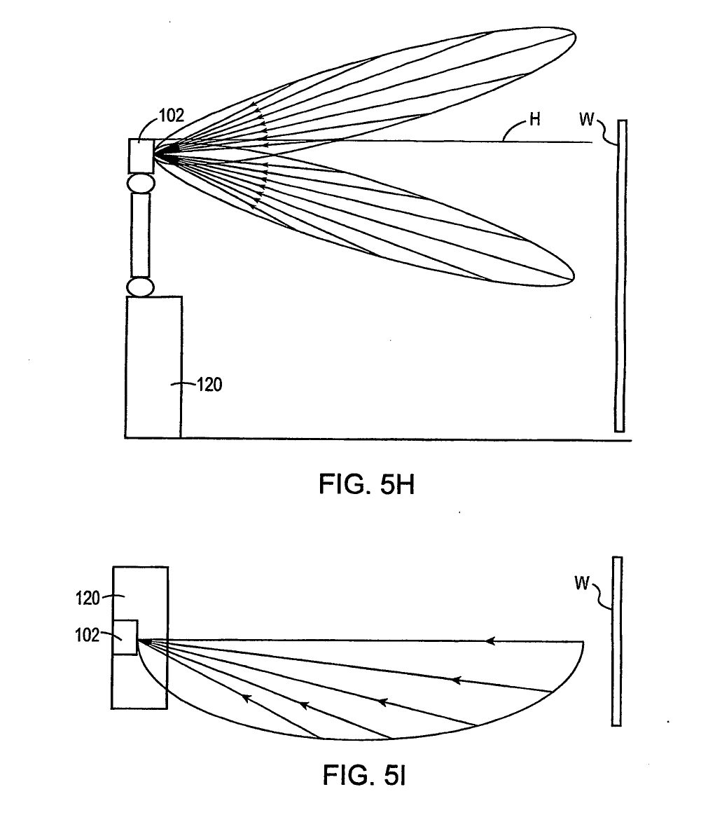

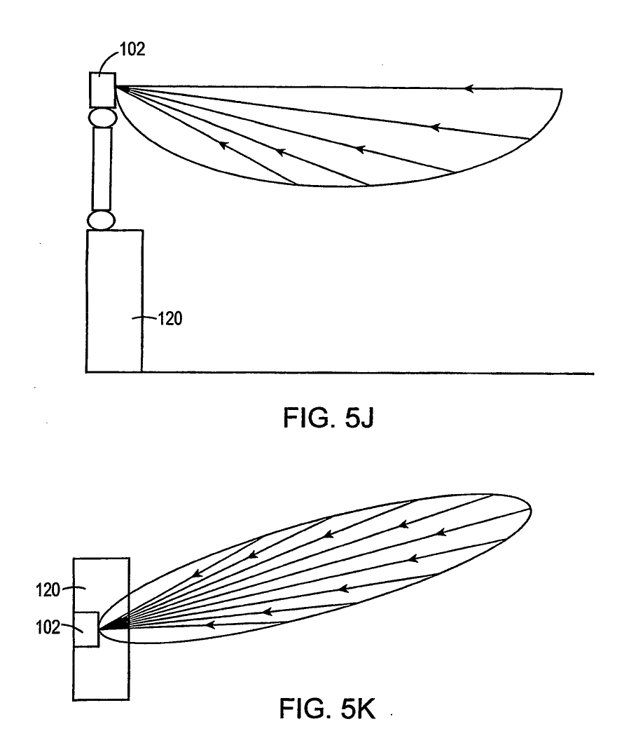

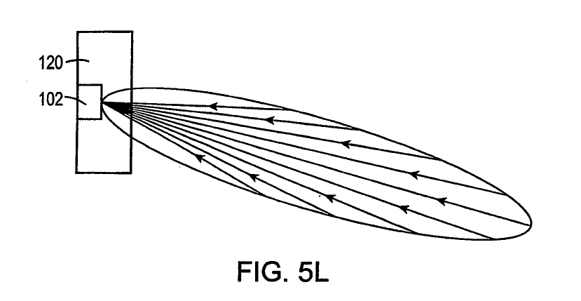

Alternatively, the distal end of fiberoptic cable 52 is polished and oriented to emit or to receive light directly (i.e., without the optical lens). Again, the distal end of fiberoptic cable 52 is arranged to have the field of view (for example, field of view A, FIG. 1A) directed toward sink 11, somewhat coaxial within the water stream discharged from aerator 30. Alternatively, sensor port 34 includes other optical elements, such as an array of pinholes or an array of slits having a selected size, geometry and orientation. The size, geometry and orientation of the array of pinholes or the array of slits is designed to provide a selected detection pattern (shown in FIGS. 3-3D, for a faucet and FIGS. 5-5L, for a flusher).

Referring still to FIGS. 1 and 1A, a fiberoptic cable 52 is preferably located inside water conduit 26 in contact with water. Alternatively, fiberoptic cable 52 could be located outside of the water conduit 26, but inside of faucet body 12. FIGS. 1C, 1D, and 1E show alternative ways to provide sensor port 34 inside aerator 30 and alternative ways to arrange an optical fiber 52 coupled to an optical lens 54. In other embodiments, optical lens 54 is replaced by an array of pinholes or an array of slits.

FIG. 1B illustrates a second preferred embodiment of the automatic faucet system. Automatic faucet system 10A includes faucet body 12 and an aerator 30 including an optical sensor 37 coupled to a sensor port 35. Optical sensor 37 is electrically connected by a wire 53 to an electronic control module 50 located inside the body of the faucet. In another embodiment, electronic control module 50 is located outside of the faucet body next to control valve 38 (FIG. 1).

In another embodiment, sensor port 35 receives an optical lens, located in from of optical sensor 37, for defining the detection pattern (or optical field of view). Preferably, the optical lens provides a field of view somewhat coaxial within the water stream discharged from aerator 30, when the faucet is turned on. In yet other embodiments, sensor port 35 includes other optical elements, such as an array of pinholes or an array of slits having a selected size, geometry and orientation. The size, geometry and orientation of the array of pinholes, or the array of slits are designed to provide a selected detection pattern (shown in FIGS. 3-3D, for a faucet and FIGS. 5-5L, for a flusher).

The optical sensor is a passive optical sensor that includes a visible or infrared light detector optically coupled to sensor port 34 or sensor port 35. There is no light source (i.e., no light emitter) associated with the optical sensor. The visible or near infrared (NIR) light detector detects light arriving at sensor port 34 or sensor port 35 and provides the corresponding electrical signal to a controller located in control unit 50 or control unit 55. The light detector (i.e., light receiver) may be a photodiode, or a photoresistor (or some other optical intensity element having an electrical output, whereby the sensory element will have the desired optical sensitivity). The optical sensor using a photo diode also includes an amplification circuitry. Preferably, the light detector detects light in the range from about 400-500 nanometers up to about 950-1000 nanometers. The light detector is primarily sensitive to ambient light and not very sensitive to body heat (e.g., infrared or far infrared light).

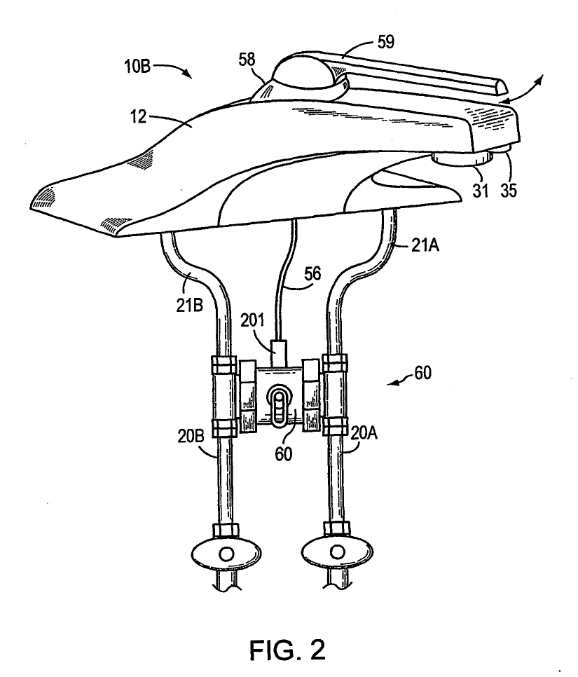

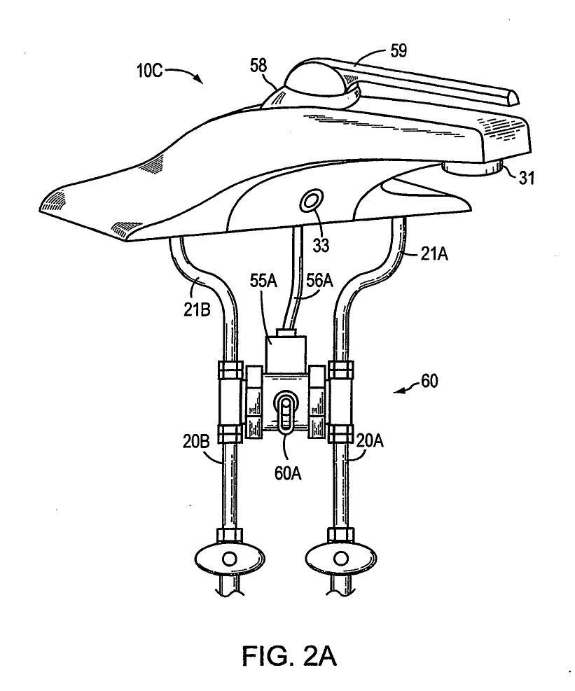

FIGS. 2 and 2A illustrate alternative embodiments of the automatic faucet system. Referring to FIG. 2, automatic faucet system 10B includes a faucet receiving water from a dual-flow faucet valve 60 and providing water from aerator 31. Automatic faucet 12 includes a mixing valve 58 controlled by a handle 59, which may be also coupled to a manual override for valve 60. Dual-flow valve 60 is connected to cold water pipe 20A and hot water pipe 20B, and controls water flow to the respective cold water pipe 21A and hot water pipe 21B.

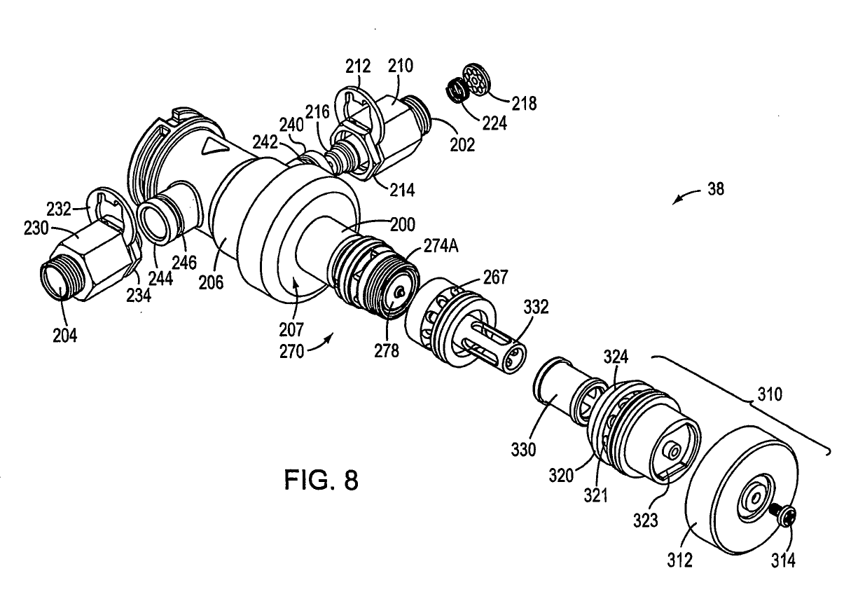

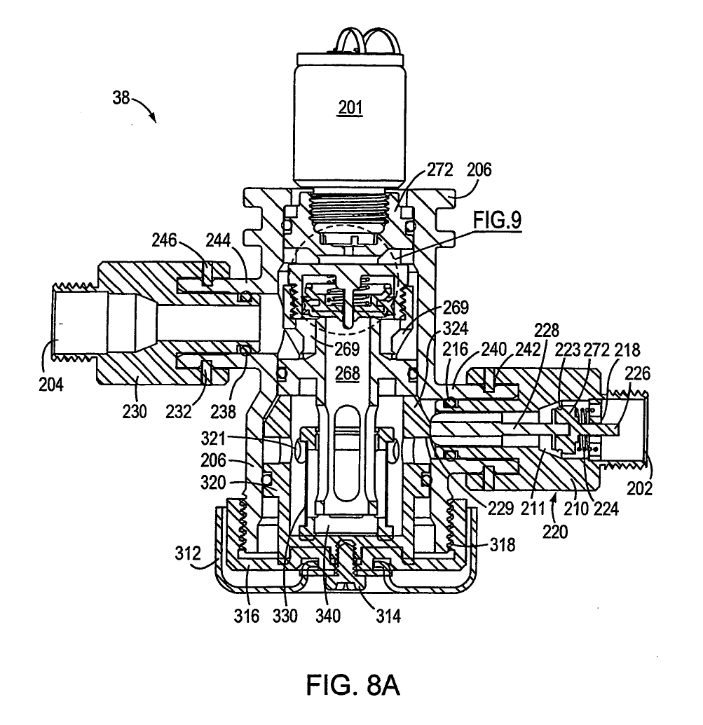

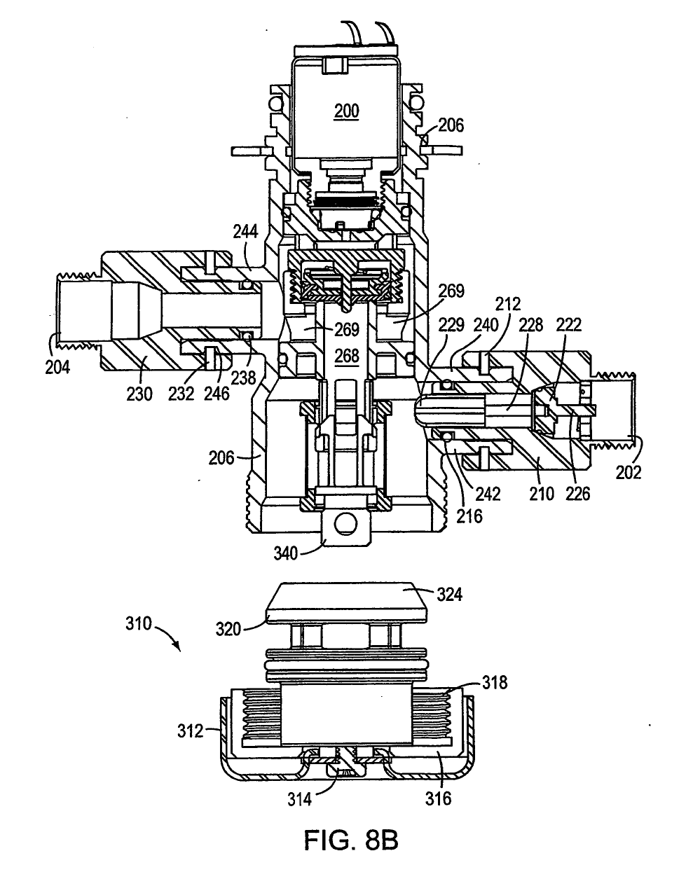

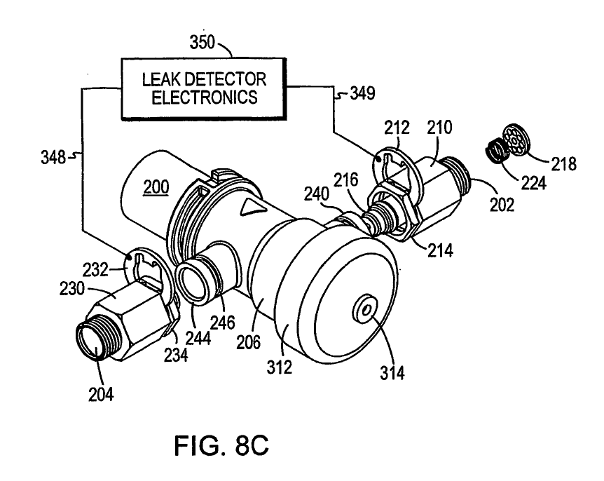

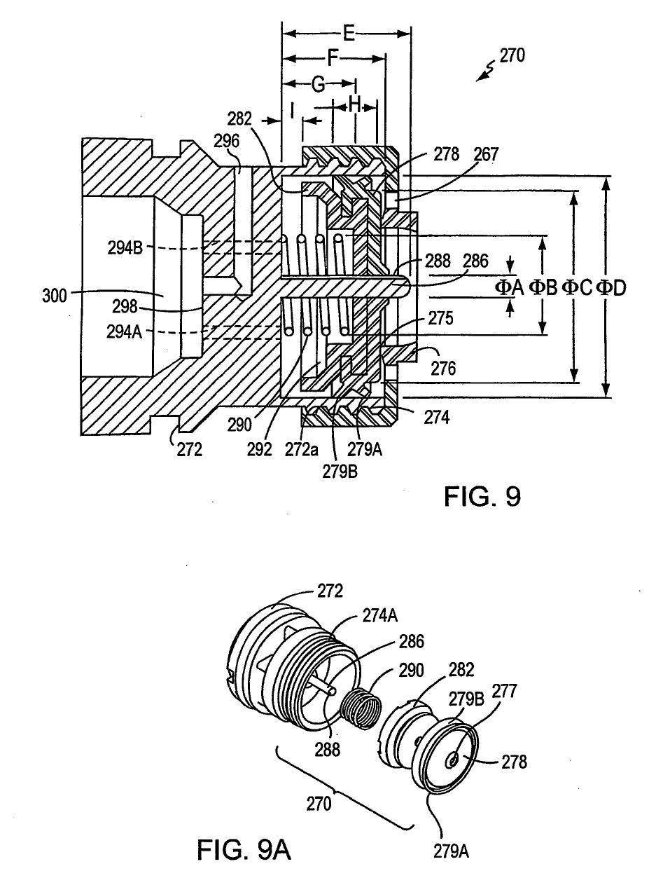

Dual flow valve 60 is constructed and arranged to simultaneously control water flow in both pipes 21A and 21B upon actuation by a single actuator 201 (See FIG. 8A). Specifically, valve 60 includes two flow valves arranged for controlling flow of hot and cold water in the respective water lines. The solenoid actuator 201 (FIG. 8A) is coupled to a pilot mechanism for controlling two flow valves. The two flow valves are preferably diaphragm operated valves (but may also be piston valves, or large flow-rate “fram” valves described in connection with FIGS. 9 and 9A). Dual flow valve 60 includes a pressure release mechanism constructed to change pressure in a diaphragm chamber of each diaphragm operated valve and thereby open or close each diaphragm valve for controlling water flow. Dual flow valve 60 is described in detail in PCT Application PCT/US01/43277, filed on Nov. 20, 2001, which is incorporated by reference.

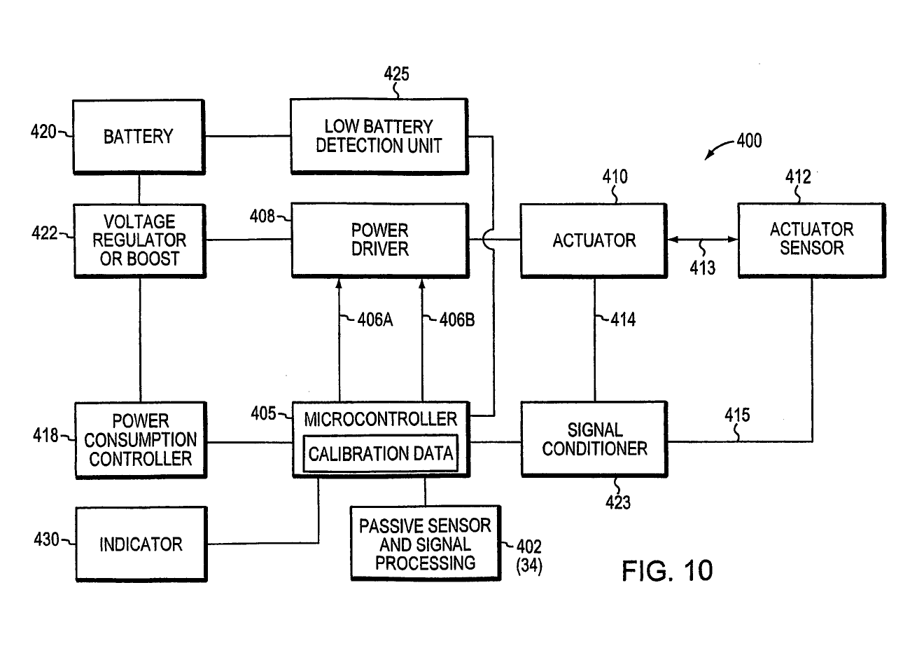

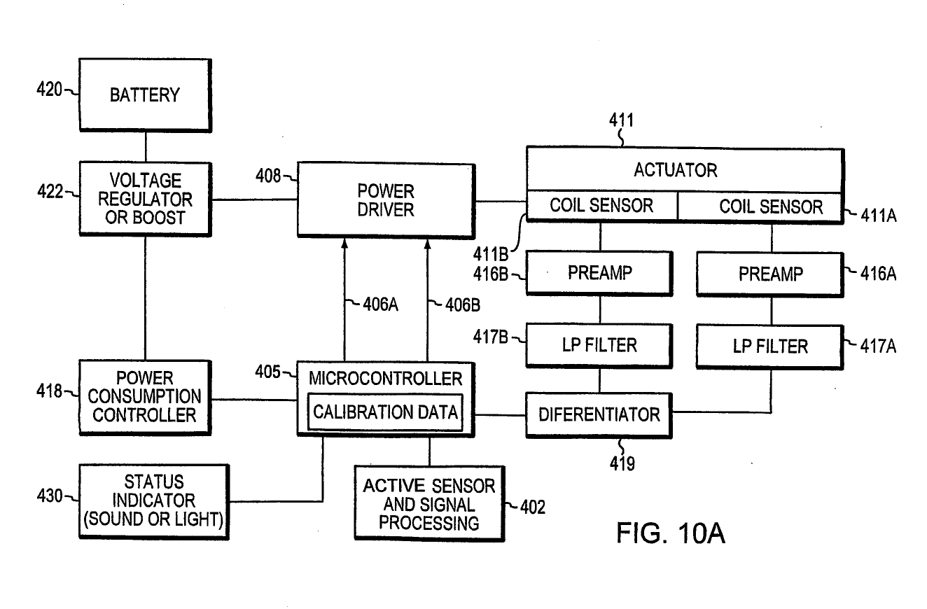

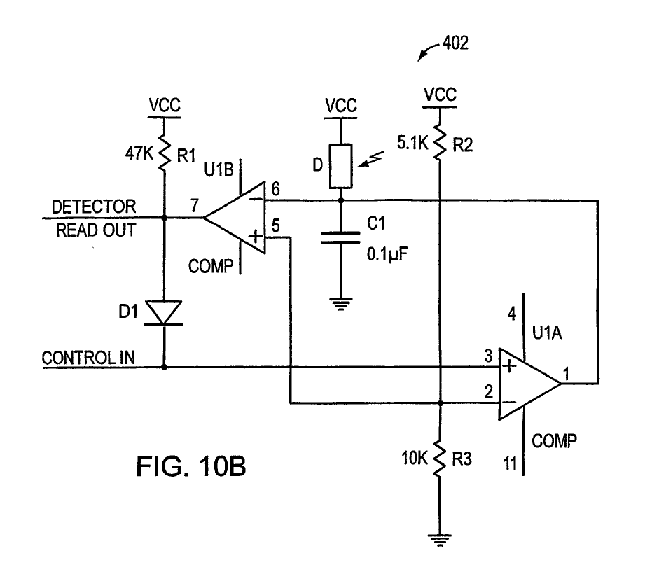

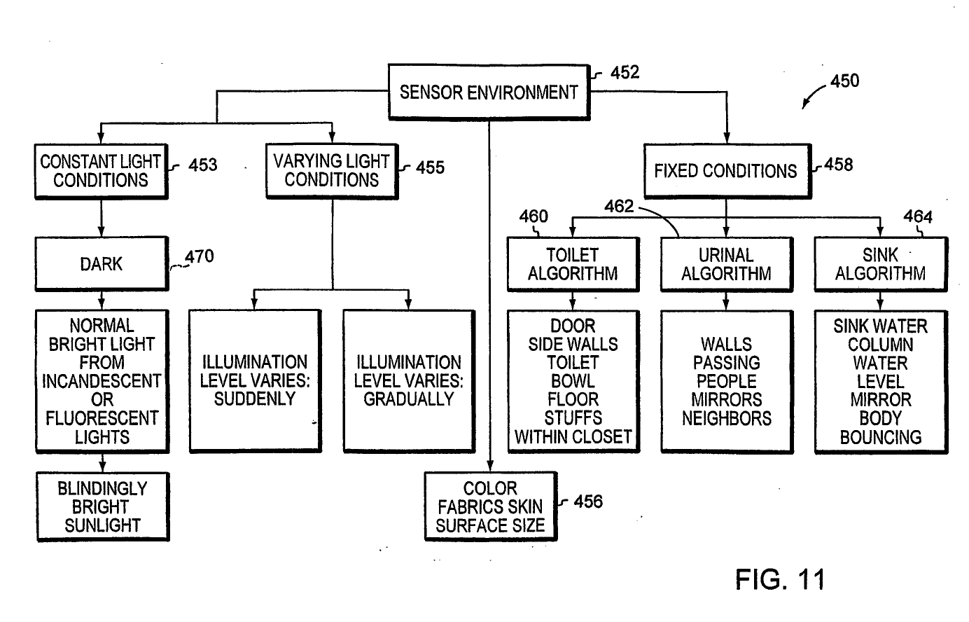

Referring still to FIG. 2, coupled to faucet body 12 there is a sensor port 35 for accommodating a distal end of an optical fiber (e.g., fiberoptic cable 52), or for accommodating a light detector. The fiberoptic cable delivers light from sensor port 35 to a light detector. In one preferred embodiment, faucet body 12 includes a control module with the light detector and a controller described in connection with FIGS. 10 and 10A. The controller provides control signals to solenoid actuator 201 via electrical cable 56. Sensor port 35 has a detection field of view (shown in FIGS. 3A and 3B) located outside of the water stream emitted from aerator 31.

Referring to FIG. 2A, automatic faucet system 10C includes faucet body 12 also receiving water from dual-flow faucet valve 60 and providing water from aerator 31. Automatic faucet 10C also includes mixing valve 58 controlled by handle 59. Dual-flow valve 60 is connected to cold water pipe 20A and hot water pipe 20B, and controls water flow to the respective cold water pipe 21A and hot water pipe 21B.

A sensor port 33 is coupled to faucet body 12 and is designed to have a field of view shown in FIGS. 3C and 3D. Sensor port 33 accommodates the distal end of an optical fiber 56A. The proximal end of optical fiber 56A provides light to an optical sensor located in a control module 55A coupled to dual flow valve 60. Control module 55A also includes the control electronics and batteries. The optical sensor detects the presence of an object (e.g., hands), or detects a change in the presence of the object (i.e., movement) in the sink area. Control electronics control the operation of and the readout from the light detector. The control electronics also include a power driver that controls the operation of the solenoid associated with valve 60. Based on the signal from the light detector, the control electronics direct the power driver to open or close solenoid valve 60 (i.e., to start or stop the water flow). The design and operation of actuator 201 (FIG. 8A) is described in detail in PCT Applications PCT/US02/38757; PCT/US02/38758; and PCT/US02/41576, all of which are incorporated by reference as if fully provided herein.

FIG. 1C shows a vertical cross-section of an aerator 30A located at the discharge end of the spout of faucet 12. Aerator 30A includes a barrel 62 attachable to faucet body 12 using threads 63. Barrel 62 supports a ring 64 which in turn supports wire mesh screens 65. Barrel 62 also supports an annular member 70, a jet-forming member 72, and an upper washer 74. Jet forming member 72 includes several elongated slots 76 for providing water passages. Jet forming member 72 and screens 65 include a passage 36 for optical fiber 52. Water flows through aerator 30A from top to bottom. In aerator 30A, a water stream flows from water conduit 26 (FIG. 1A) and is broken up by the vertically elongated slots 76 of the water jet-forming member 72. Then water flows through to wire mesh screens 65, which are supported by ring 64. Ring 64 also enables air intake (suction) through gaps 67 (which it forms between itself and the barrel 62) inside a chamber 66. Just above wire mesh screens 65, in chamber 66, air mixes with water so that a mixture of air and water passes through screens 65. The optical fiber 52 is located in the center of the above described elements inside a tubular member 36, which holds lens 54.

FIG. 1D shows a second embodiment of an aerator with a centrally located port for a passive sensor. In this embodiment, the aerator 30B includes at least two lenticularly arranged wire mesh members 86A and 86B, providing a central opening for a passage 88. Aerator 30B also includes an insert member 90 including several holes 92 and a central hole 88 for accommodating tubular member 52. Aerator 30B is attached to faucet 12 using threads 83. Water flows from water conduit 26 to an upper chamber 91 and then through holes 92. Air enters chamber 93 via holes 84. The mixture of water and air then flows through two screens 86A and 86B assembled in a lenticular arrangement. Housing 82 has a surrounding support part oriented inwards, which supports the two screens 86A and 86B. Optical fiber 52 extends inside water pipe 26 (FIG. 1A) through aerator 30B from the top and through the wire mesh screens 86A and 86B. As the individual water jets formed by holes 92 enter lower chamber 93, air is drawn via openings 84 into chamber 93. Inside chamber 93, water mixes with air and the mixture is forced through screens 86A and 86B.

FIGS. 1E and 1F show alternative ways to provide the optical field aligned with the water stream (i.e., alternative embodiment of an aerator and a sensor port located therein). FIG. 1E is a perspective view of an aerator 30C and FIG. 1F is a cross-sectional view of aerator 30C used in the automatic faucet system of FIG. 1. Aerator 30C is coupled to faucet body 12 and the water conduit 26 using using threads 83. Optical fiber 52 is located outside the water conduit and introduced via an adapter 97. Alternatively, adapter 97 can include the light detector coupled to a control module using an electrical cable instead of fiberoptic cable 52. (For simplicity, the wire mesh members and the air openings are not shown in FIGS. 1E and 1F).

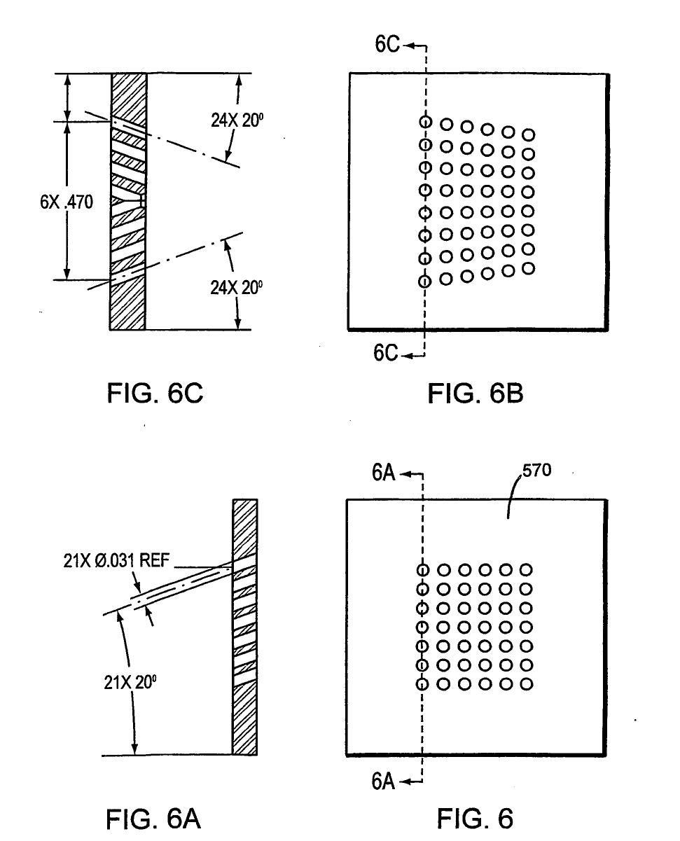

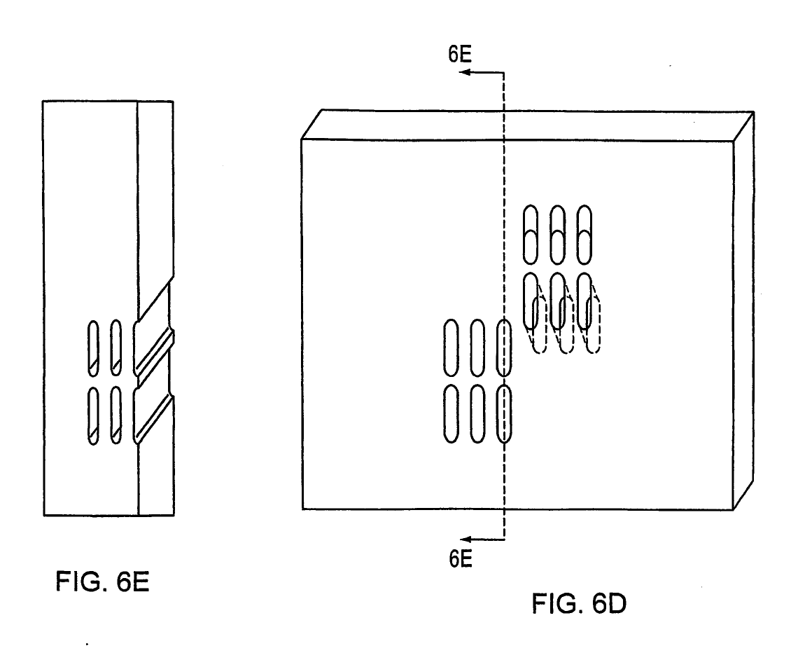

FIG. 3 shows schematically a cross-sectional view of a first preferred detection pattern (A) for the passive optical sensor installed in automatic faucet 12. The detection pattern A is associated with sensor port 34 and is shaped by a lens, or an element selected from the optical elements shown in FIGS. 6-6E. The detection pattern A is selected to receive reflected ambient light primarily from sink 11. The pattern's width is controlled, but the range is much less controlled (i.e., FIG. 3 shows pattern A only schematically because detection range is not really limited).

A user standing in front of a faucet will affect the amount of ambient (room) light arriving at the sink and thus will affect the amount of light arriving at the optical detector. On the other hand, a person just moving in the room will not affect significantly the amount of detected light. A user having his hands under the faucet will alter the amount of ambient (room) light being detected by the optical detector even more. Thus, the passive optical sensor can detect the user's hands and provide the corresponding control signal. Here, the detected light doesn't depend significantly on the reflectivity of the target surface (unlike for optical sensors that use both a light emitter and a receiver). After hand washing, the user removing his hands from under the faucet will again alter the amount of ambient light detected by the optical detector. Then, the passive optical sensor provides the corresponding control signal to the controller (explained in connection with FIGS. 10, 10A and 10B).

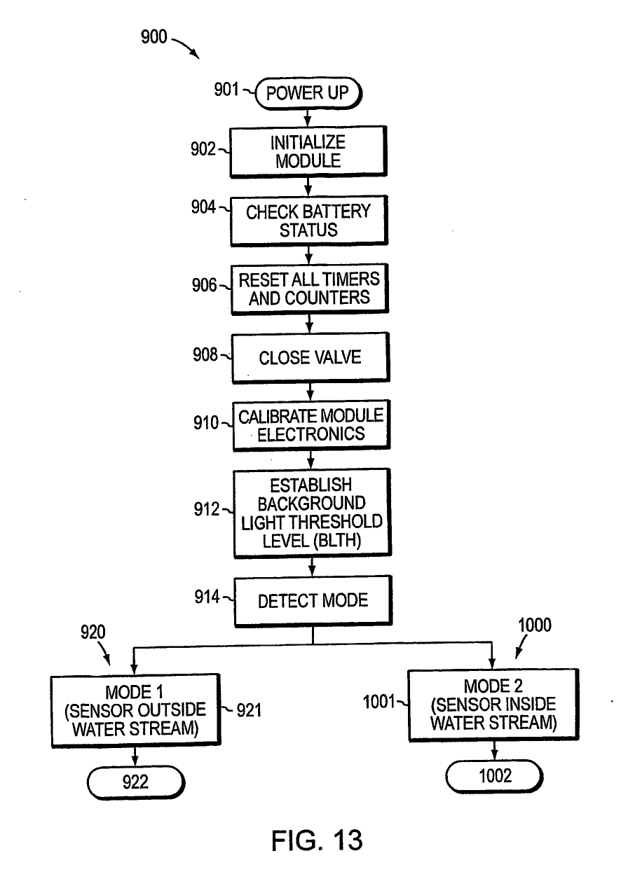

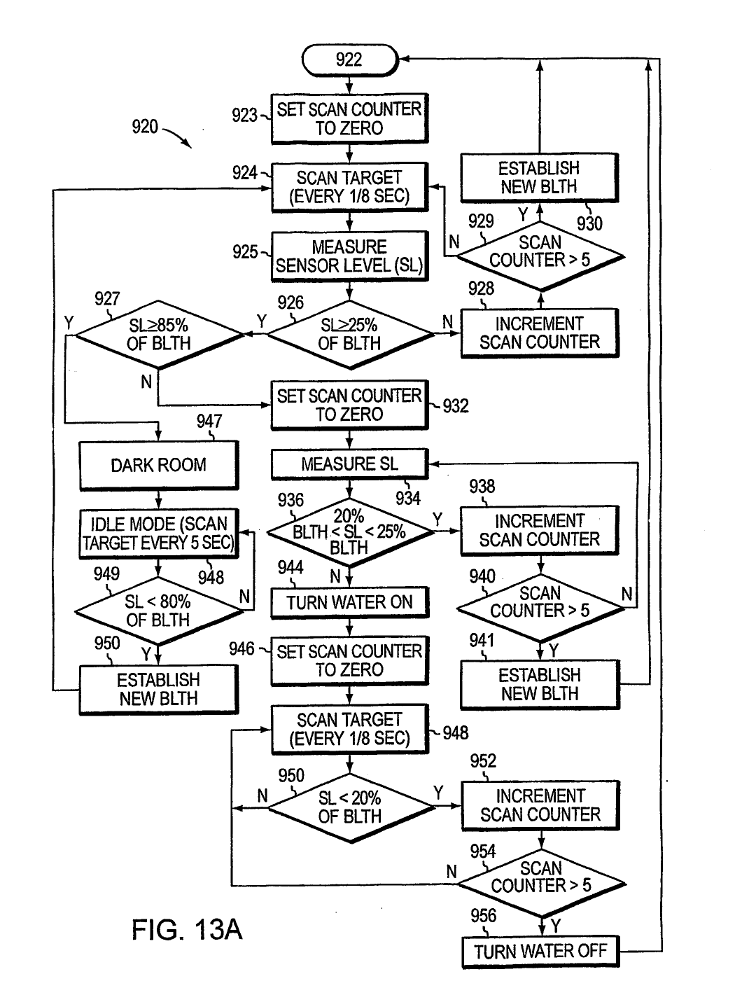

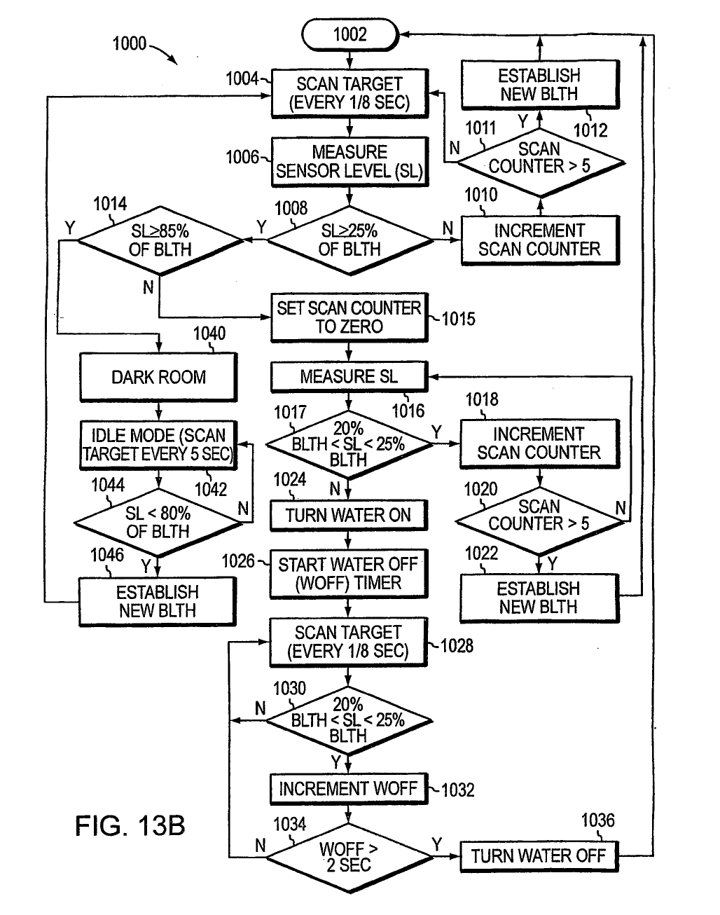

FIGS. 3A and 3B show schematically a second preferred detection pattern (B) for the passive optical sensor installed in automatic faucet 10B. The detection pattern B is associated with sensor port 35, and again may be shaped by a lens, or an optical element shown in FIGS. 6-6E. A user having his hands under faucet 10B alters the amount of ambient (room) light detected by the optical detector. As mentioned above, the detected light doesn't depend significantly on the reflectivity of the user's hands (unlike for optical sensors that use both a light emitter and a receiver). Thus, the passive optical sensor detects the user's hands and provides the corresponding control signal to the controller. FIGS. 13, 13A, and 13B illustrate detection algorithms used for the detection patterns A and B.

FIGS. 3C and 3D show schematically another detection pattern (C) for the passive optical sensor installed in automatic faucet 10C. The detection pattern C is associated with sensor port 33, and is shaped a selected optical element. The selected optical element achieves a desired width and orientation of the detection pattern, while the range is more difficult to control. In this embodiment, a user standing in front of faucet 10C will alter the amount of detected ambient light somewhat more than a user passing by. In this embodiment, light reflections from sink 11 influence the detected light only minimally.

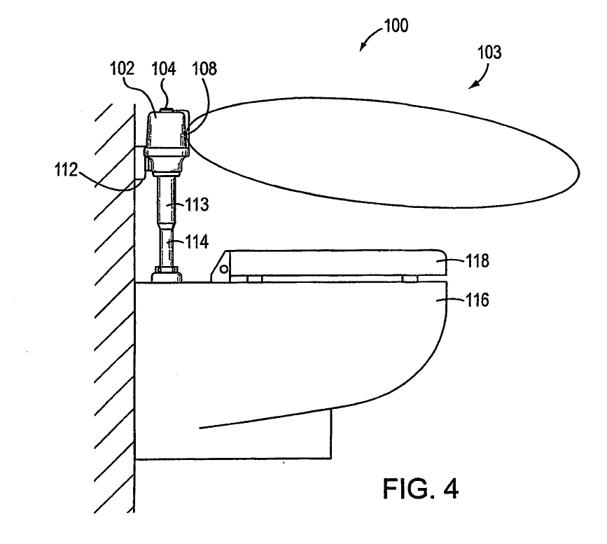

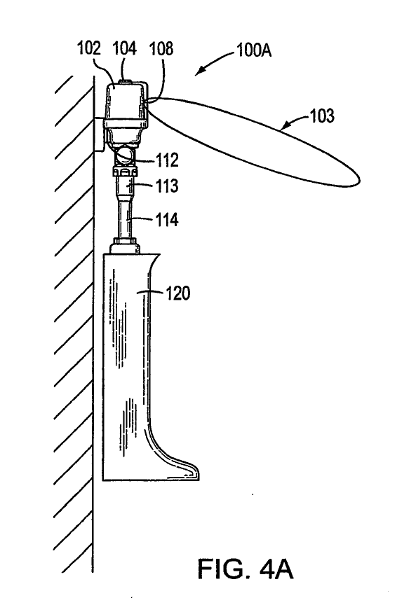

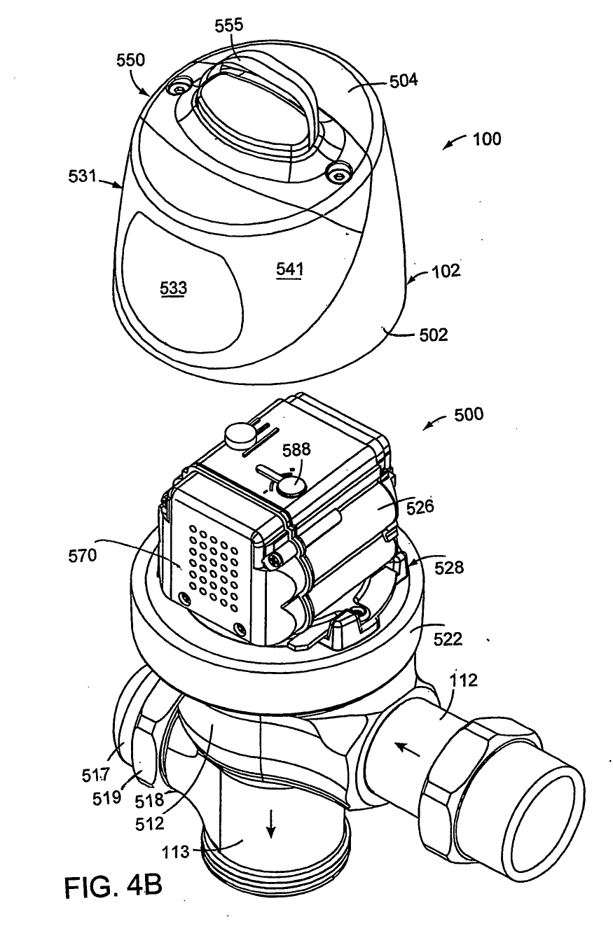

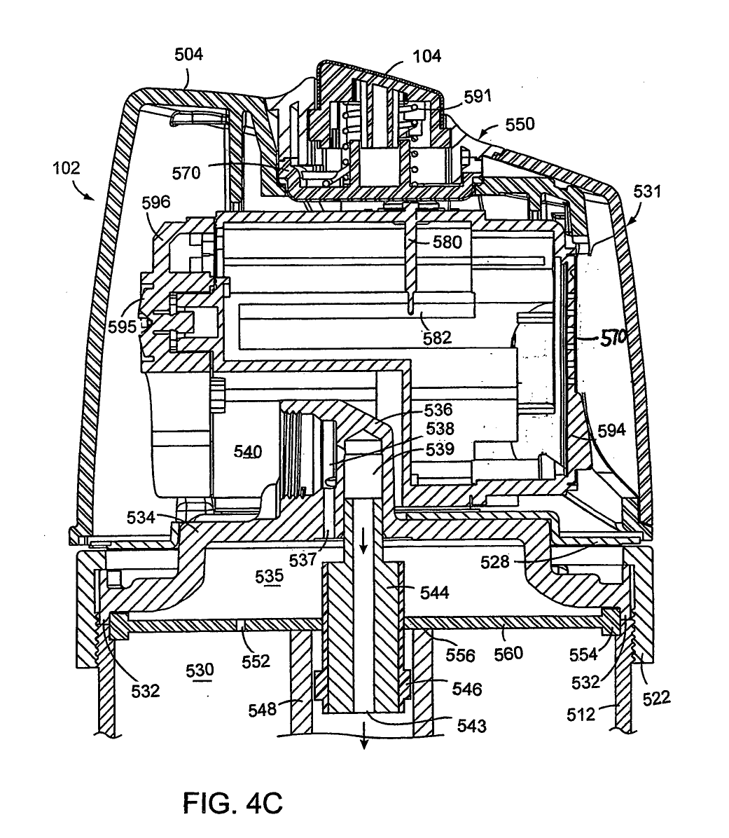

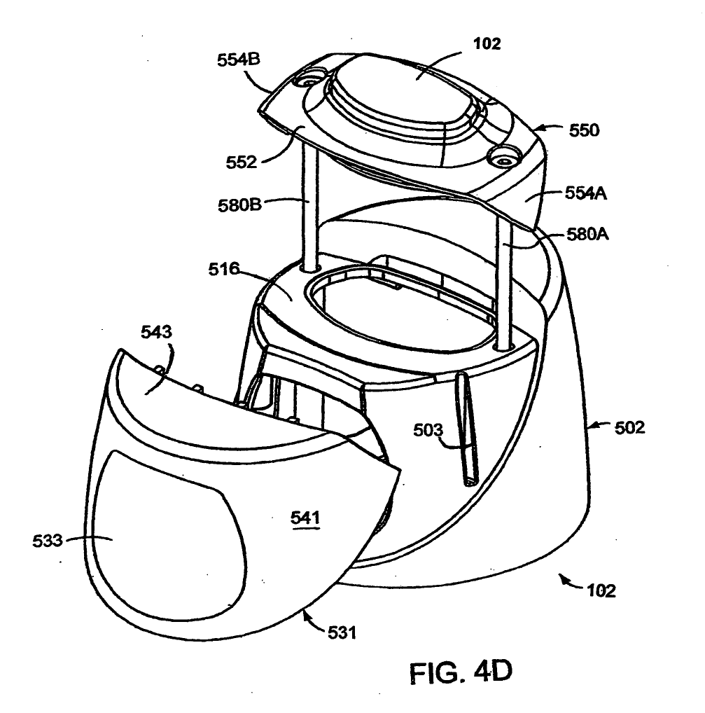

FIG. 4 shows schematically a side view of a toilet including an automatic flusher 100, and FIG. 4A shows schematically a side view of a urinal including an automatic flusher 100A. Flusher 100 receives pressurized water from a supply line 112 and employs a passive optical sensor to respond to actions of a target within a target region 103. After a user leaves the target region, a controller directs opening of a flush valve 102 that permits water flow from supply line 112 to a flush conduit 113 and to a toilet bowl 116.

FIG. 4A illustrates bathroom flusher 100A used for automatically flushing a urinal 120. Flusher 100A receives pressurized water from supply line 112. Flush valve 102 is controlled by a passive optical sensor that responds to actions of a target within a target region 103. After a user leaves the target region, a controller directs opening of a flush valve 102 that permits water flow from supply line 112 to a flush conduit 113.

Bathroom flushers 100 and 100A may have a modular design, wherein their cover can be partially opened to replace the batteries or the electronic module. Bathroom flushers with such a modular design are described in U.S. Patent Application 60/448,995, filed on Feb. 20, 2003, which is incorporated by reference for all purposes.

Referring to FIG. 4B, automatic bathroom flusher 100 includes a flusher body 512 coupled to a water supply line 112 and also coupled to a water output line 113 providing output to the connected toilet or urinal. In the automatic flusher design, manual port 518 is closed off using a cap 519 coupled to port 518 using a lock ring 517. Automatic bathroom flusher 100 also includes a flusher cover 102, which is a dome-like outer cover specifically designed for protection and easy servicing of control module 500. Flusher cover 100 also includes a manual override button 104 used to override the flusher's sensor. Furthermore, flusher cover 102 is designed to protect control module 500 in case of water leaks, as described below.

As shown in FIGS. 4B and 4D, flusher cover 102 includes a main cover body 502, a front cover 531, and a top cover 550. The entire flusher cover 102 is secured in place with respect to the flusher body using an attachment ring 522 connecting a pilot cap 534 to flusher body 512. Electronic control module 500 is positioned onto an alignment plate 528, which defines the module's position and orientation with respect to the front of the flusher. Electronic control module 500 includes electronic elements that control the entire operation of flusher 100, including a sensor and a microcontroller for execution of a detection and flushing algorithm (described below). The microcontroller provides signals to a solenoid driver that in turn provides drive signals to a solenoid actuator 540 (FIG. 4C). Solenoid actuator 540 controls the operation of the flush valve assembly that opens and closes water flow from input 112 to output 113. The following description describes this in more detail.

FIG. 4C is a cross-sectional view illustrating flusher 100 including electronic control module 500 and solenoid actuator 540, all located inside of external cover 102. Flusher body 512 is designed to receive the flush valve assembly including a flexible diaphragm 560, and a diaphragm feed-though assembly (which is described, for example, in U.S. Pat. Nos. 6,382,586 and 5,244,179 both of which are incorporated by reference). Electronic control module 500 includes a plastic housing 526 for enclosing batteries, electronic circuitry and a sensor. Preferably, the sensor is an optical active sensor that has a light source (i.e., a transmitter) and a light detector (i.e., a receiver) operating in the visible to infrared range. Alternatively, the sensor is an optical passive sensor operating in the visible to near IR range. FIG. 4B illustrates a passive optical sensor including a pinhole array 570, shown in FIGS. 6 and 6B.

The flushing assembly includes pressure cap (pilot chamber cap) 534, flexible diaphragm 560, and a pressure relief assembly coupled to solenoid actuator 540. Flexible diaphragm 560 separates an annular entrance chamber 530 from pilot chamber 535, both being located within valve body 512, wherein a bleed passage-552 provides communication between the two chambers. The pressure relief assembly includes a piloting button 538 coupled to an input passage 537 and an output passage 539 located inside a top part 536 of pilot cap 534.

As described in the PCT application PCT/US02/38758, which is incorporated by reference, piloting button 538 is screwed onto the distal part of actuator 540 to create a valve. Specifically, the plunger of actuator 540 acts onto the valve seat inside piloting button 538 to control water flow between passages 537 and 543. This arrangement provides a reproducible and easily serviceable closure for this solenoid valve. Co-operatively designed with piloting button 538 and actuator 540, there are several O-rings that provide tight water seals and prevent pressurized water from entering the interior of cover 102. The O-rings also seal piloting button 538 within the chamber inside the top part 536 and prevent any leakage through this chamber into the bore where actuator 540 is partially located. It is important to note that these seals are not under compression. The seat member precisely controls the stroke of the solenoid plunger as mentioned above. It is desired to keep this stroke short to minimize the solenoid power requirements.

Inside cover 102, electronic control module 500 is positioned on alignment plate 528, which in turn is located in contact with pilot chamber cap 534. Plate 528 includes an opening designed to accommodate top part 536 of pilot cap 534. Electronic control module 500 includes two circuit boards with control electronics (including preamplifiers and amplifiers for operating the above-mentioned optical sensor), a solenoid driver, and the batteries, all of which located inside plastic housing 526.

Referring still to FIG. 4C, supply line 112 communicates with entrance chamber 530 defined by valve body 512 and a chamber wall 548 formed near the upper end of flush output 113. Flexible diaphragm 560 is seated on a main valve seat 556 formed by the mouth of flush output 113, and has a circularly-shaped outer edge 554 located in contact with the periphery of pilot chamber cap 534. Retaining ring 522 clamps pilot chamber cap 534 at its periphery 532 with respect to flusher body 512, wherein outer edge 554 of diaphragm 560 is also clamped between periphery 532 and flusher body 512.

In the open state, the water supply pressure is larger in entrance chamber 530 than water pressure in pilot chamber 535, thereby unseating the flexible diaphragm 560. When flexible diaphragm 560 is lifted of seat 556, supply water flows from supply line 112, through the entrance chamber 530 by valve seat 556 into flush conduit 113. In the closed state, the water pressure is the same in entrance chamber 530 and in pilot chamber 535 since the pressure is equalized via bleed hole 552. The pressure equalization occurs when went passage 537 is closed by the plunger of solenoid actuator 540. Then, water pressure in the upper, pilot chamber 535 acts on a larger surface and thus exerts greater force on diaphragm 560 from above than the same pressure within entrance chamber 530, which acts on a smaller lower surface of diaphragm 560. Therefore, flexible diaphragm 560 ordinarily remains seated on seat 556 (when passage 537 is closed for some time and the pressure equalization occurs).

To flush the toilet, solenoid-operated actuator 540 relieves the pressure in pilot chamber 535 by permitting fluid flow between pilot entrance passage 537 and exit passage 543. The time in which it takes for the chamber to refill is determined by the stroke of the diaphragm. Furthermore, actuator 540 controls the pressure release time (i.e., time for venting pilot chamber 535), which in turn determines the time during which the flush valve is open for water to pass. Both actuator 540 and the stroke of the diaphragm assembly control the duration of the flush (for a selected size of bleed passage 552) and thus the volume of water passing through the flush valve. In many regions with a limited water supply, it is very important to closely control the volume of water that passes through the flush valve each time the flusher is operated. Various governments have passed different regulations defining what water flow is permitted through a flush valve in commercial washrooms. A novel design of the actuator and the control electronics can deliver a relatively precise amount of flush water, as described in PCT applications PCT/US02/38758 or PCT/US02/41576, both of which are incorporated by reference.

The design of actuator 540 and actuator button 538 is important for reproducible, long-term operation of flusher 100. Actuator 540 may have its plunger directly acting onto the seat of actuator button 538, forming a non-isolated design where water comes in direct contact with the moving armature of the solenoid actuator. This embodiment is described in U.S. Pat. No. 6,293,516 or U.S. Pat. No. 6,305,662, both of which are incorporated by reference. Alternatively, actuator 540 may have its plunger enclosed by a membrane acting as a barrier for external water that does not come in direct contact with the armature (and the linearly movable armature is enclosed in armature fluid. In this isolated actuator embodiment, the membrane is forced onto the seat of actuator button 538, in the closed position. This isolated actuator, including button 538 are described in detail in PCT application PCT/US01/51098, which is incorporated by reference.

Referring again to FIG. 4D, external cover 102 is designed for optimal operation and easy servicing of automatic flusher 100. Main cover body 502 provides overall protection and rigidity. Front cover 531 and top cover 550 have complementary shapes with main body 502 to form a dome-like structure and to enable easy disassembly (as shown in FIG. 4D by the exploded view). The main body 502, front cover 531 and top cover 550 fit together like a simple three-dimensional puzzle. In a preferred embodiment, these elements have surfaces arranged to provide a tight water seal. As also shown in FIG. 4D, screws 580A and 580B hold in place top cover 550 by tightening against the respective cooperating threads 530A and 530B located in pilot cap 534 (FIG. 4C). This arrangement holds in place and attaches together main cover 502 with front cover 531 and top cover 550, which all are coupled to the pilot chamber cover 534. This arrangement also holds control module 500 and plate 528 in place with respect to pilot cap 534, which in turn is attached to flusher body 512 by a retaining ring 522.

Importantly, the material of dome cover 102 is selected to provide protection for electronic control module 500 and actuator 540. Cover 102 is formed of a plastic that is durable and is highly resistant to the chemicals frequently found in washrooms used for cleaning purposes. The materials are also highly impact resistant (depending on the type of installation, i.e., public or private) so as to resist attempts of vandalism.

Alternatively, main body 502 is made of a non-corrosive metal (instead of plastic), while front cover 531 or top cover 550 are still made of plastic. It has been found that polysulfone is a highly desirable plastic material for this purpose. Front cover 531 includes optical window 533 and can also be made of a polysulfone plastic that does not impede or interfere with the transmission of infrared signals from the sensor. Preferably, window 533 masks or obscures the interior elements in flush valve 100. Preferably, a pigment is added to the polysulfone so that approximately 70 percent of visible light at all wave lengths will pass through optical window 533 and approximately 30 percent will be impeded. A pigment made by Amoco bearing spec number BK1615 provides a dark (not quite-black), deep lavender window 533, which obscures the interior components, but yet permits transmission of a very substantial portion of light at the used wavelengths. Window 533 is usually made of the same material as other portions of front cover 531, but may be more highly polished in contrast with the somewhat matte finish of the remaining portions of front cover 531.

Main body 502 is shaped to provide most of the enclosure function of cover 102 including structural support for front cover 531 and top cover 550. Front cover 531 includes optical sensor window 533, a wall member 541, top region 543 and two lips or slides co-operatively arranged with grooves 503, which are located in the main body 502. After front cover 531 is attached to main body 502 using the lips or slides, top cover is placed on the top surface 516 of main body 502. Top cover 550 includes a curved top surface 552 cooperatively arranged with a button retainer and a manual actuation button 104. Top cover 550 also includes side surfaces 554A and 554B, which are functionally important for lifting top cover 550 (after loosening screws 580A and 580B) without any tools. Main body 502 also includes a water passage (or a bleed hole) located in the rear of main body 502. In the case of an unlikely malfunction, there may be a water leak, for example, between passages 537 and 543, which could create water flow into cover 102. The water passage prevents water accumulation inside the flusher cover 102 and thus prevents flooding and possibly damaging to electronic module 500. Water passage, however, does not allow significant water flow from outside to inside of cover 102 (e.g., from the top or the side of cover 102 during cleaning). This is achieved by the shaped surface of the water passage directed downward. Cover 102 is designed to withstand high pressure cleaning, while still providing vent passage (i.e., water bleed opening). Additional description is provided in U.S. Application 60/448,995, filed on Feb. 20, 2003, which is incorporated by reference.

Top cover 550 is designed for accommodating a manual flush and saving batteries (and other electronic elements) during shipping and storage. The manual flush is performed by pressing on top button 104. The saving mode is achieved by holding down top button 104 in the depressed position using a shipping and storage strip 555, as described below. Top button 104 is designed cooperatively with a button insert guide. The button insert guide includes a cylindrical region designed for a magnet that is displaced up and down by the movement of button 104. The magnet is cooperatively arranged with a reed sensor located inside electronic control module 500.

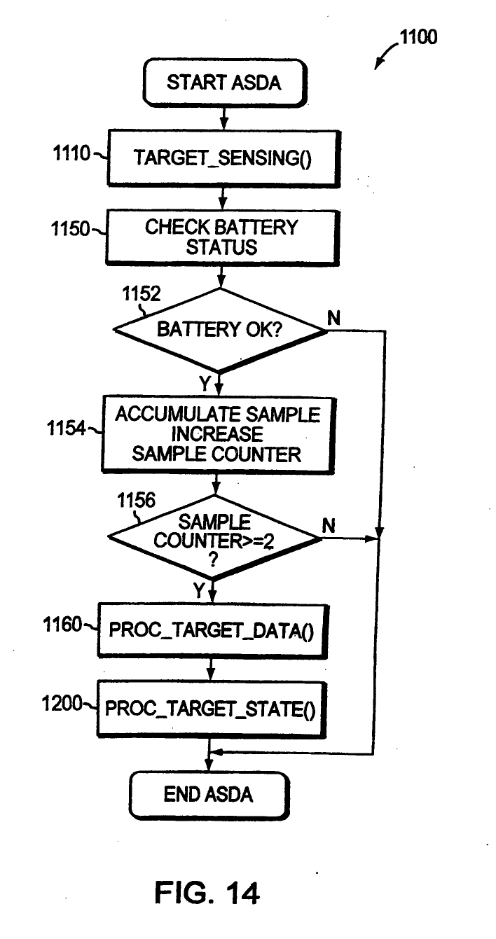

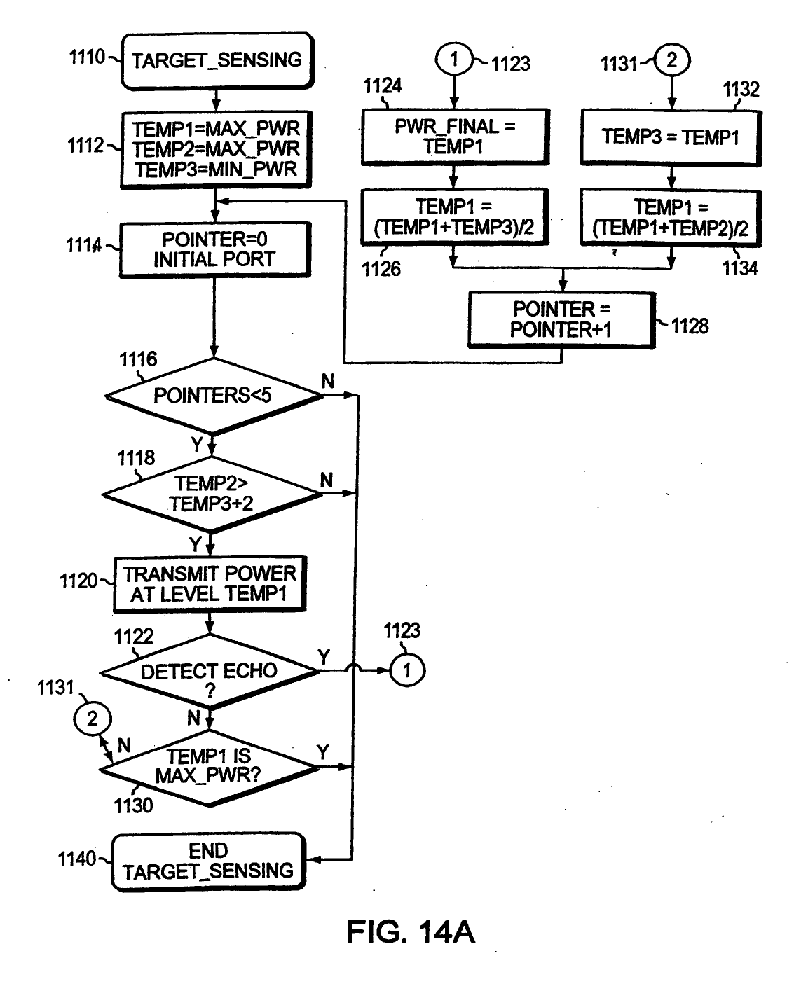

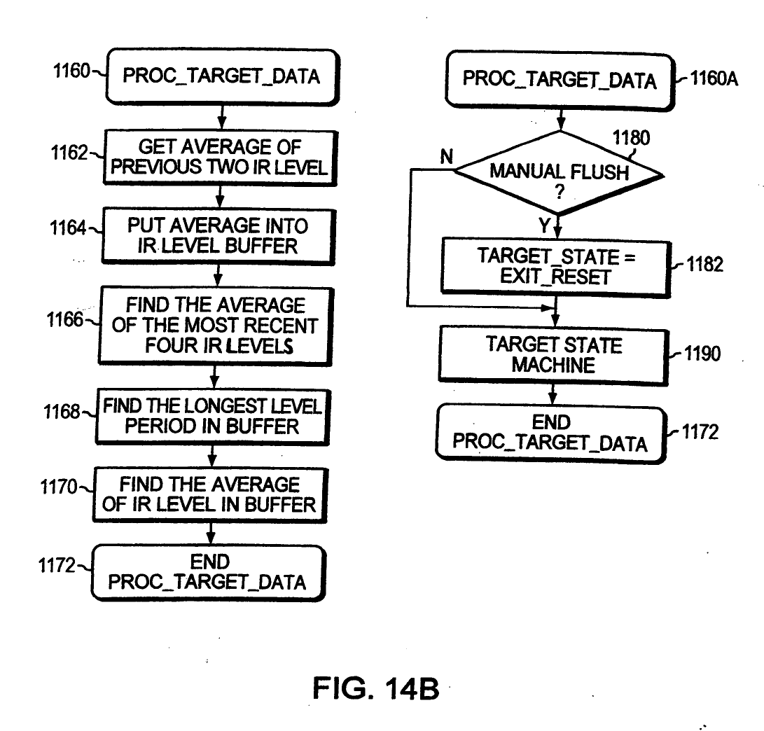

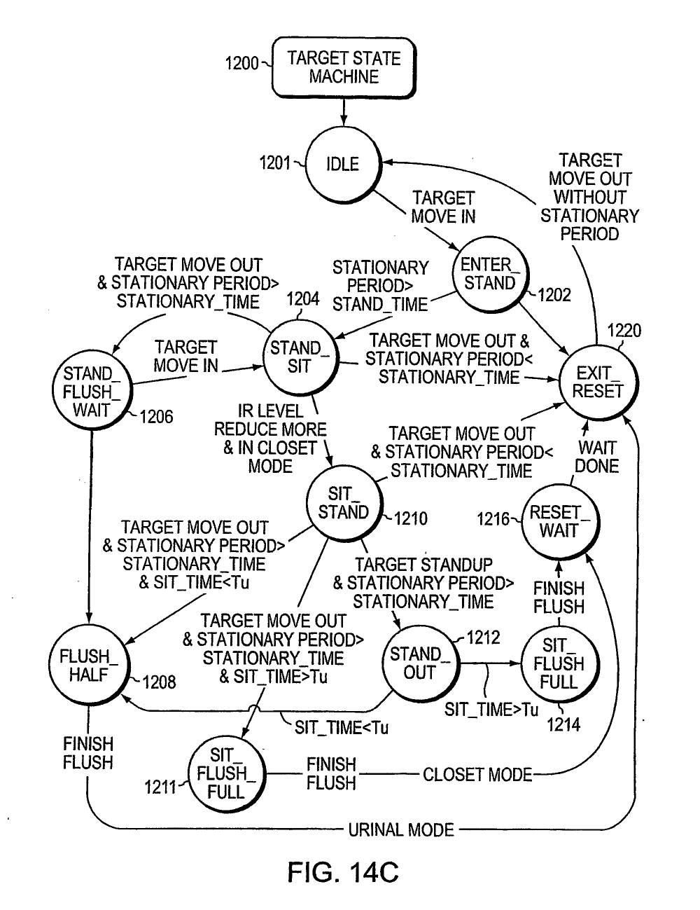

When depressing button 104, the reed sensor registers the magnet and provides a signal to the microcontroller that in turn initiates a flush cycle, as described in PCT Application PCT/US02/38758. Upon releasing button 104, a button spring pushes button 104 to its upper position, and thereby also displaces the magnet. In the upper position, the magnet is no longer sensed by the reed sensor. The uniform linear movement of button 104 is achieved by using a bail wire in cooperation with the spring. Manual actuation button 104 overrides the flush algorithm (e.g., as described in FIGS. 14-14C) and initiates a flush.

FIGS. 5 and 5A show schematically side and top views of an optical detection pattern used by the passive optical sensor installed in the automatic toilet flusher of FIG. 4. This detection pattern is associated with sensor port 108 and is shaped by a lens, or an element selected from the optical elements shown in FIGS. 6-6E. The pattern is angled below horizontal (H) and directed symmetrically with respect to toilet 116. The range is somewhat limited not to be influenced by a wall (W); this can be also done by limiting the detection sensitivity.

FIGS. 5B and 5C show schematically side and top views of a second optical detection pattern used by the passive optical sensor installed in the automatic toilet flusher of FIG. 4. This detection pattern is shaped by a lens, or another optical element. The pattern is angled both below horizontal (H) and above horizontal (H). Furthermore, the pattern is directed asymmetrically with respect to toilet 116, as shown in FIG. 5C.

FIGS. 5D and 5E show schematically side and top views of a third optical detection pattern used by the passive optical sensor installed in the automatic toilet flusher of FIG. 4. This detection pattern is again shaped by a lens, or another optical element. The pattern is angled above horizontal (H). Furthermore, the pattern is directed asymmetrically with respect to toilet 116, as shown in FIG. 5E.

FIGS. 5F and 5G show schematically side and top views of a fourth optical detection pattern used by the passive optical sensor installed in the automatic toilet flusher of FIG. 4. This detection pattern is angled below horizontal (H) and is directed asymmetrically across toilet 116, as shown in FIG. 5G. This detection pattern is particularly useful for “toilet side flushers,” described in U.S. application Ser. No. 09/916,468, filed on Jul. 27, 2001, or U.S. application Ser. No. 09/972,496, filed on Oct. 6, 2001, both of which are incorporated by reference.

FIGS. 5H and 5I, show schematically side and top views of an optical detection pattern used by the passive optical sensor installed in the automatic urinal flusher of FIG. 4A. This detection pattern is shaped by a lens, or another optical element. The pattern is angled both below horizontal (H) and above horizontal (H) to target ambient light changes caused by a person standing in front of urinal 120. This pattern is directed asymmetrically with respect to urinal 120 (as shown in FIG. 51), for example, to eliminate or at least reduce light changes caused by a person standing at a neighboring urinal.

FIGS. 5J, 5K and 5L, show schematically side and top views of another optical detection pattern used by the passive optical sensor installed in the automatic urinal flusher of FIG. 4A. This detection pattern is shaped by a lens, or another optical element, as mentioned above. The pattern is angled below horizontal (H) to eliminate the influence of light caused by a ceiling lamp. This pattern may be directed asymmetrically to the left or to the right with respect to urinal 120 (as shown in FIG. 5K or 5L). These detection patterns are particularly useful for “urinal side flushers,” described in U.S. application Ser. No. 09/916,468, filed on Jul. 27, 2001, or U.S. application Ser. No. 09/972,496, filed on Oct. 6, 2001.

In general, the field of view of a passive optical sensor can be formed using optical elements such as beam forming tubes, lenses, light pipes, reflectors, arrays of pinholes and arrays of slots having selected geometries. These optical elements can provide a down-looking field of view that eliminates the invalid targets such as mirrors, doors, and walls. Various ratios of the vertical field of view to horizontal field of view provide different options for target detection. For example, the horizontal field of view may be 1.2 wider than the vertical field of view or vice versa. A properly selected field of view can eliminate unwanted signals from an adjacent faucet or urinal. The detection algorithm includes a calibration routine that accounts for a selected field of view including the field's size and orientation.

FIGS. 6 through 6E illustrate different optical elements for producing desired detection patterns of the passive sensor. FIGS. 6 and 6B illustrate different arrays of pinholes. The thickness of the plate, the size and the orientation of the pinholes (shown in cross-section in FIGS. 6A and 6C) define the properties of the field of view. FIGS. 6D and 6E illustrate an array of slits for producing a detection pattern shown in FIGS. 5B and 5H. This plate may also include a shutter for covering the top or the bottom detection field.

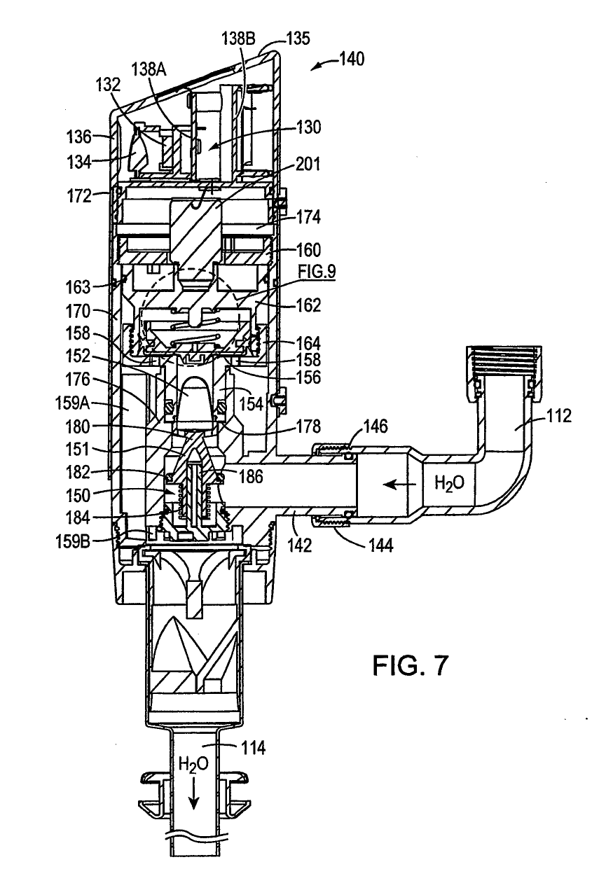

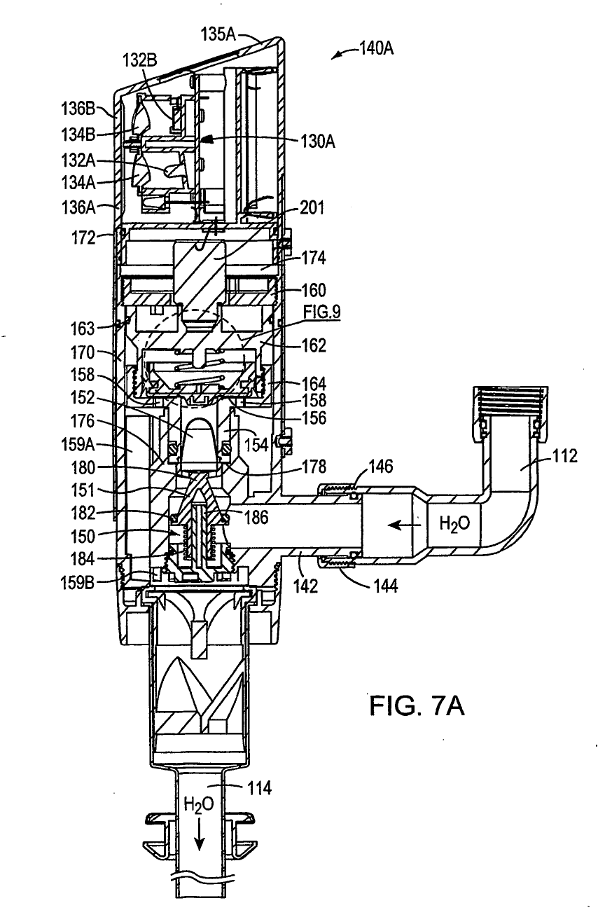

FIGS. 7 and 7A illustrate in detail automatic flush valves suitable for use with automatic bathroom flusher 100 or automatic bathroom flusher 100A. Other flush valves are described in the above-referenced PCT applications. Yet other suitable flush valves are described in U.S. Pat. Nos. 6,382,586 and 5,244,179, both of which are incorporated by reference. In each case, the flush valve is controlled by a passive optical sensor described herein.

Referring to FIG. 7, an automatic flush valve 140 is a high performance, electronically controlled or manually controlled tankless flush valve, which uses a passive optical sensor 130. Passive optical sensor 130 includes a lens 134 for defining the detection field and providing ambient light to a light receiver 132. Plastic enclosure 135 includes an optical window 136, which may also include optical elements described in connection with FIGS. 6-6E. The controller is located on a circuit board 138. Plastic enclosure 135 also houses the batteries for powering the entire flushing system.

Referring to FIG. 7A, an automatic flush valve 140A is a high performance, electronically controlled or manually controlled tankless flush valve, which uses an active optical sensor 130A. Active optical sensor 130A includes a light emitter 132A (e.g., a light emitting diode, LED) and a light receiver 132A (e.g., an IR diode). The light emitted from LED 132A is focused by a lens 134A and the reflected signal is collected by s lens 134B and focused onto detector 132B. Lenses 134A and 134B are designed for defining the detection region for the active optical sensor. Plastic enclosure 135A includes optical windows 136A and 136B, which may also include optical elements described in connection with FIGS. 6-6E. The control electronics is located on a circuit board. Plastic enclosure 135A also houses the batteries for powering the entire flushing system.

Referring to FIGS. 7 and 7A, flush valve 140, includes an input union 112, preferably made of a suitable plastic resin. Union 112 is attached via threads to an input fitting that interacts with the building water supply system. Furthermore, union 112 is designed to rotate on its own axis when no water is present so as to facilitate alignment with the inlet supply line. Union 112 is attached to an inlet pipe 142 by a fastener 144 and a radial seal 146, which enables union 112 to move in or out along inlet pipe 142. This movement aligns the inlet to the supply line. However, with fastener 144 secured, there is a water pressure applied by the junction of union 112 to inlet 142. This forms a unit that is rigidly sealed through seal 146. The water supply travels through union 112 to inlet 142 and through the inlet valve assembly 150 an inlet screen filter 152, which resides in a passage formed by member 178 and is in communication with a main valve seat 156. The operation of the entire main valve can be better understood by also referring to FIGS. 9, and 9A.

As also described in connection with FIGS. 8, 9, and 9A, electromagnetic actuator 201 controls operation of the main valve, which is a “fram piston valve” 270. In the opened state, water flows thru a passage 152 and thru passages 158 into passages 159A and 159B, into main outlet 114. In the closed state, the fram element 278 (FIGS. 9 and 9A) seals the valve main seat 156 thereby closing flow through passage 158. Automatic flusher 140 includes an adjustable input valve 150 controlled by rotation of a valve element 174 threaded together with valve elements 162 and 164. Valve elements 162 and 164 are sealed from body 170 via one or several o-rings 163. Furthermore, valve elements 162 and 164 are held down by threaded element 160, when element 174 is threaded all the way. This force is transferred to element 154 and 178. The resulting force presses down element 180.

When valve element 160 is unthreaded all the way, valve assembly 150 and 151 moves up due to the force of spring 184 located on guide element 186 in this adjustable input valve. The spring force combined with inlet fluid pressure from pipe 142 forces element 151 against the valve seat in contact with O-ring 182 resulting in a sealing action of the O-ring 182. O-Ring 182 (or another sealing element) blocks the flow of water to inner passage of 152, which in turn enables servicing of all internal valve elements including elements behind shut-off valve 150 without the need to shut off the water supply at the inlet 112. This is a major advantage of this embodiment.

According to another function of adjustable valve 140, the threaded retainer is fastened part way resulting in valve body elements 162 and 164 to push down the valve seat only partially. There is a partial opening that provides a flow restriction reducing the flow of input water thru valve 150. This novel function is designed to meet application specific requirements. In order to provide for the installer the flow restriction, the inner surface of the valve body includes application specific marks such as 1.6 W.C 1.0 GPF urinals etc. for calibrating the input water flow.

Automatic flush valve 140 is equipped with the above-described sensor-based electronic system located in housing 135. Alternatively, the sensor-based electronic flush system may be replaced by an all mechanical activation button or lever. Alternatively, the flush valve may be controlled by a hydraulically timed mechanical actuator that acts upon a hydraulic delay arrangement, as described in PCT Application PCT/US01/43273, which is incorporated by reference. The hydraulic system can be adjusted to a delay period corresponding to the needed flush volume for a given fixture such a 1.6 GPF W.C etc. The hydraulic delay mechanism can open the outlet orifice of the pilot section instead of electromagnetic actuator 201 for duration equal to the installer preset value.

Referring again to FIGS. 7 and 7A, depending on the passive optical sensor signal (or the active optical sensor signal), the microcontroller executes a control algorithm and provides ON and OFF signals to valve actuator 201, which, in turn, opens or closes water delivery. The microcontroller can also execute a half flush or delayed flush depending on the mode of use (e.g., a toilet, a urinal, a frequently used urinal as in a ball park). The microcontroller can also execute a timed flush (one flush per day or per week in facilities such as ski resorts in summer) to prevent drying of the water trap.

FIGS. 8, 8A and 8B illustrate an automatic valve 38 constructed and arranged for controlling water flow in automatic faucet 10. Specifically, automatic valve 38 receives water at a valve input port 202 and provides water from a valve output port 204, in the open state. Automatic valve 38 includes a body 206 made of a durable plastic or metal. Preferably, valve body 206 is made of a plastic material but includes a metallic input coupler 210 and a metallic output coupler 230. Input and output couplers 210 and 230 are made of metal (such as brass, copper or steel) so that they can provide gripping surfaces for a wrench used to connect them to water lines 24 and 25, respectively. Valve body 206 includes a valve input port 240, and a valve output port 244, and a cavity 207 for receiving the individual valve elements shown in FIG. 8.

Metallic input coupler 210 is rotatably attached to input port 240 using a metal C-clamp 212 that slides into a slit 214 inside input coupler 210 and also a slit 242 inside the body of input port 240 (FIG. 8). Metallic output coupler 230 is rotatably attached to output port 244 using a metal C-clamp 232 that slides into a slit 234 inside output coupler 230 and also a slit 246 inside the body of output port 244. When servicing the faucet 12, this rotatable arrangement prevents tightening the water line connection to any of the two valve couplers unless attaching the wrench to the designated surfaces of couplers 210 and 230. (That is, a service person cannot tighten the water input and output lines by gripping on valve body 206.) This protects the relatively softer plastic body 206 of automatic valve 38. However, body 206 can be made of a metal in which case the above-described rotatable coupling is not needed. A sealing O-ring 216 seals input coupler 210 to input port 240, and a sealing O-ring 238 seals output coupler 230 to input port 244.

Referring to FIGS. 8, 8A, and 8B, metallic input coupler 210 includes an inlet flow adjuster 220 cooperatively arranged with a flow control mechanism 310 (FIG. 8). Inlet flow adjuster 220 includes an adjuster piston 222, a closing spring 224 arranged around an adjuster pin 226 and pressing against a pin retainer 218. Input flow adjuster 220 also includes an adjuster rod 228 coupled to and displacing adjuster piston 222. Flow control mechanism 310 includes a spin cap 312 coupled by screw 314 to an adjustment cap 316 in communication with a flow control cam 320. Flow control cam 320 slides linearly inside body 206 upon turning adjustment cap 316. Flow control cam 320 includes inlet flow openings 321, a locking mechanism 323 and a chamfered surface 324. Chamfered surface 324 is cooperatively arranged with a distal end 229 of adjuster rod 228. The linear movement of flow control cam 320, within valve body 206, displaces chamfered surface 324 and thus displaces adjuster rod 228. Adjuster piston 222 also includes an inner surface 223 cooperatively arranged with an inlet seat 211 of input coupler 210. The linear movement of adjuster rod 228 displaces adjuster piston 222 between a closed position and an open position. In the closed position, sealing surface 223 seals inner seat 211 by the force of closing spring 224. In the opened position, adjuster rod 228 displaces adjuster pin 222 against closing spring 224 thereby providing a selectively sized opening between inlet seat 211 and sealing surface 223. Thus, by turning adjustment cap 316, adjuster rod 228 opens and closes inlet adjuster 220. Inlet adjuster 220 controls or closes completely the water flow from water line 24. The above-described manual adjustment can be replaced by an automatic motorized adjustment mechanism controlled by a microcontroller.

Referring still to FIGS. 8, 8A and 8B, automatic valve 38 also includes a removable inlet filter 330 removably located over an inlet filter holder 332, which is part of the lower valve housing. Inlet filter holder 332 also includes an O-ring and a set of outlet holes 267 shown in FIG. 8. The “fram piston” 270 is shown in detail in FIGS. 9 and 9A. Referring again to FIG. 8A, water flows from input port 202 of input coupler 210 through inlet flow adjuster 220 and then through inlet flow openings 321, and through inlet filter 330 inside inlet filter holder 332. Water then arrives at an input chamber 268 inside a cylindrical input element 276 providing pressure against a pliable member 278 (FIG. 9).

Automatic valve 38 also includes a service loop 340 (or a service rod) designed to pull the entire valve assembly, including attached actuator 200, out of body 206, after removing of plug 316. The removal of the entire valve assembly also removes the attached actuator 200 (or actuator 201) and the piloting button described in PCT Application PCT/US02/38757 and in PCT Application PCT/US02/38757, both of which are incorporated by reference. To enable easy installation and servicing, there are rotational electrical contacts located on a PCB at the distal end of actuator 200. Specifically, actuator 200 includes, on its distal end, two annular contact regions that provide a contact surface for the corresponding pins, all of which can be gold plated for achieving high quality contacts. Alternatively, a stationary PCB can include the two annular contact regions and the actuator may be connected to movable contact pins. Such distal, actuator contact assembly achieves easy rotational contacts by just sliding actuator 200 located inside valve body 206.

FIG. 8C illustrates automatic valve 38 including a leak detector for indicating a water leak or water flow across valve device 38. The leak detector includes an electronic measurement circuit 350 and at least two electrodes 348 and 349 coupled respectively to input coupler 210 and output coupler 230. (The leak detector may also include four electrodes for a four-point resistivity measurement). Valve body 206 is made of plastic or another non-conductive material. In the closed state, when there is no water flow between input coupler 210 and output coupler 230, electronic circuit 350 measures a very high resistance value between the two electrodes. In the open state, the resistance value between input coupler 210 and output coupler 230 drops dramatically because the flowing water provides a conductive path.

There are various embodiments of electronics 350, which can provide a DC measurement, an AC measurement including eliminating noise using a lock-in amplifier (as known in the art). Alternatively, electronics 350 may include a bridge or another measurement circuit for a precise measurement of the resistivity. Electronic circuit 350 provides the resistivity value to a microcontroller and thus indicates when valve 38 is in the open state. Furthermore, the leak detector indicates when there is an undesired water leak between input coupler 210 and output coupler 230. The entire valve 38 is located in an isolating enclosure to prevent any undesired ground paths that would affect the conductivity measurement. Furthermore, the leak detector can indicate some other valve failures when water leaks into the enclosure from valve 38. Thus, the leak detector can sense undesired water leaks that would be otherwise difficult to observe. The leak detector is constructed to detect the open state of the automatic faucet system to confirm proper operation of actuator 200.

Automatic valve 38 may include a standard diaphragm valve, a standard piston valve, or a novel “fram piston” valve 270 explained in detail in connection with FIGS. 9 and 9A. Referring to FIG. 9, valve 270 includes a distal body 276, which includes an annular lip seal 275 arranged, together with pliable member 278, to provide a seal between input port chamber 268 and output port chamber 269. The distal body 276 also includes one or several flow channels 267 (also shown in FIG. 8) providing communication (in the open state) between input chamber 268 and output chamber 269. Pliable member 278 also includes sealing members 279A and 279B arranged to provide a sliding seal, with respect to valve body 272, between pilot chamber 292 and output chamber 271. There are various possible embodiments of seals 279A and 279B (FIG. 9). This seal may be a one-sided seal or a two-sided seal as 279A and 279B shown in FIG. 9. Furthermore, there are various additional embodiments of the sliding seal including O-rings, etc.

The present invention envisions valve device 270 having various sizes. For example, the “full” size embodiment has the pin diameter A=0.070″, the spring diameter B=0.310″, the pliable member diameter C=0.730″, the overall fram and seal's diameter D=0.412″, the pin length E=0.450″, the body height F=0.2701″, the pilot chamber height G=0.220″, the fram member size H=0.160″, and the fram excursion I=0.100″. The overall height of the valve is about 1.35″ and diameter is about 1.174″.

The “half size” embodiment of the “fram piston” valve has the following dimensions provided with the same reference letters. In the “half size” valve A=0.070″, B=0.30, C=0.560″, D=0.650″, E=0.34″, F=0.310″, G=0.215″, H=0.125″, and I=0.60″. The overall length of the ½ embodiment is about 1.350″ and the diameter is about 0.455″. Different embodiments of the “fram piston” valve device may have various larger or smaller sizes.

Referring to FIGS. 9 and 9A, the fram piston valve 270 receives fluid at input port 268, which exerts pressure onto diaphragm-like member 278 providing a seal together with a lip member 275 in a closed state. Groove passage 288 inside pin 286 provides pressure communication with pilot chamber 292, which is in communication with actuator cavity 300 via communication passages 294A and 294B. An actuator (described in PCT Application PCT/US02/38757) provides a seal at surface 298 thereby sealing passages 294A and 294B and thus pilot chamber 300. When the plunger of actuator 200 moves away from surface 298, fluid flows via passages 294A and 294B to control passage 296 and to output port 269. This causes pressure reduction in pilot chamber 292. Therefore, diaphragm-like member 278 and piston-like member 288 move linearly within cavity 292, thereby providing a relatively large fluid opening at lip seal 275. A large volume of fluid can flow from input port 268 to output port 269.

When the plunger of actuator 200 seals control passages 294A and 294B, pressure builds up in pilot chamber 292 due to the fluid flow from input port 268 through “bleed” groove 288 inside guide pin 286. The increased pressure in pilot chamber 292 together with the force of spring 290 displace linearly, in a sliding motion over guide pin 286, from member 270 toward sealing lip 275. When there is sufficient pressure in pilot chamber 292, diaphragm-like pliable member 278 seals input port chamber 268 at lip seal 275. The soft member 278 includes an inner opening that is designed with guiding pin 286 to clean groove 288 during the sliding motion. That is, groove 288 of guiding pin 286 is periodically cleaned.

The embodiment of FIG. 9 shows the valve having a central input chamber 268 (and guide pin 286) symmetrically arranged with respect to vent passages 294A and 294B (and the location of the plunger of actuator 200). However, the valve device may have input chamber 268 (and guide pin 286) non-symmetrically arranged with respect to passages 294A, 294B and output vent passage 296. That is, in such a design, this valve has input chamber 268 and guide pin 286 non-symmetrically arranged with respect to the location of the plunger of actuator 200. The symmetrical and nonsymmetrical embodiments are equivalent.

Automatic valve 38 has numerous advantages related to its long term operation and easy serviceability. Automatic valve 38 includes inlet adjusted 220, which enables servicing of the valve without shutting off the water supply at another location. The construction of valve 38, including the inner dimensions of cavity 207 and actuator 200, enables easy replacement of the internal parts. A service person can remove screw 314 and spin cap 312, and then remove adjustment cap 316 to open valve 38. Valve 38 includes service loop 340 (or a service rod) designed to pull the entire valve assembly, including attached actuator 200, out of body 206. The service person can then replace any defective part, including actuator 200, or the entire assembly and insert the repaired assembly back inside valve body 206. Due to the valve design, such repair would take only a few minutes and there is no need to disconnect valve 38 from the water line or close the water supply. Advantageously, the “fram piston” design 270 provides a large stroke and thus a large water flow rate relative to its size.

Another embodiment of the “fram piston” valve device is described in PCT applications PCT/US02/34757, filed Dec. 4, 2002, and PCT/US03/20117, filed Jun. 24, 2003, both of which are incorporated by reference as if fully reproduced herein. Again, the entire operation of this valve device is controlled by a single solenoid actuator that may be a latching solenoid actuator or an isolated actuator described in PCT application PCT/US01/51054, filed on Oct. 25, 2001, which is incorporated by reference as if fully reproduced herein.

FIG. 10 schematically illustrates control electronics 400, powered by a battery 420. Control electronics 400 includes battery regulation unit 422, no or low battery detection unit 425, passive sensor and signal processing unit 402, and the microcontroller 405. Battery regulation unit 422 provides power for the whole controller system. It provides 6.0 V power through 6.0V power 1 to “no battery” Detector; it provides 6.0 V power to low battery detector; it also provides 6.0 V to power driver 408. It provides a regulated 3.0 V power to microcontroller 405.

“No battery” detector generates pulses to microcontroller 405 in form of “Not Battery” signals to notify microcontroller 405. Low Battery detector is coupled to the battery/power regulation through the 6.0V power. When power drops below 4.2V, the detector generates a pulse to the microcontroller (i.e., low battery signal). When the “low battery” signal is received, microcontroller will flash indicator 430 (e.g., an LED) with a frequency of 1 Hz, or may provide a sound alarm. After flushing 2000 times under low battery conditions, microcontroller will stop flushing, but still flash the LED.

As described in connection with FIG. 10B, passive sensor and signal processing module 402 converts the resistance of a photoresistor to a pulse, which is sent to microcontroller through the charge pulse signal. The pulse width changes represent the resistance changes, which in turn correspond to the illumination changes. The control circuit also includes a dock/reset unit that provides clock pulse generation, and it resets pulse generation. It generates a reset pulse with 4 Hz frequency, which according to the clock pulse, is the same frequency. The reset signal Is sent to microcontroller 405 through “reset” signal to reset the microcontroller or wake up the microcontroller from sleep mode.

A manual button switch may be formed by a reed switch, and a magnet. When the button is pushed down by a user, the circuitry sends out a signal to the clock/reset unit through manual signal IRQ, then forces the clock/reset unit to generate a reset signal. At the same time, the level of the manual signal level is changed to acknowledge to microcontroller 405 that it is a valid manual flush signal.

Referring still to FIG. 10, control electronics 400 receives signals from optical sensor unit 402 and controls an actuator 412, a controller or microcontroller 405, an input element (e.g., the optical sensor), a solenoid driver 408 (power driver) receiving power from a battery 420 regulated by a voltage regulator 422. Microcontroller 405 is designed for efficient power operation. To save power, microcontroller 405 is initially in a low frequency sleep mode and periodically addresses the optical sensor to see if it was triggered. After triggering, the microcontroller provides a control signal to a power consumption controller 418, which is a switch that powers up voltage regulator 422 (or a voltage boost 422), optical sensor unit 402, and a signal conditioner 416. (To simplify the block diagram, connections from power consumption controller 418 to optical sensor unit 402 and to signal conditioner 416 are not shown.)

Microcontroller 405 can receive an input signal from an external input element (e.g., a push button) that is designed for manual actuation or control input for actuator 410. Specifically, microcontroller 405 provides control signals 406A and 406B to power driver 408, which drives the solenoid of actuator 410. Power driver 408 receives DC power from battery and voltage regulator 422 regulates the battery power to provide a substantially constant voltage to power driver 408. An actuator sensor 412 registers or monitors the armature position of actuator 410 and provides a control signal 415 to signal conditioner 423. A low battery detection unit 425 detects battery power and can provide an interrupt signal to microcontroller 405.

Actuator sensor 412 provides data to microcontroller 405 (via signal conditioner 423) about the motion or position of the actuator's armature and this data is used for controlling power driver 408. The actuator sensor 412 may be an electromagnetic sensor (e.g., a pick up coil) a capacitive sensor, a Hall effect sensor, an optical sensor, a pressure transducer, or any other type of a sensor.

Preferably, microcontroller 405 is an 8-bit CMOS microcontroller TMP86P807M made by Toshiba. The microcontroller has a program memory of an 8 Kbytes and a data memory of 256 bytes. Programming is done using a Toshiba adapter socket with a general-purpose PROM programmer. The microcontroller operates at 3 frequencies (f_{c}=16 MHz, f_{c}=8 MHz and fₛ=332.768 kHz), wherein the first two clock frequencies are used in a normal mode and the third frequency is used in a low power mode (i.e., a sleep mode). Microcontroller 405 operates in the sleep mode between various actuations. To save battery power, microcontroller 405 periodically samples optical sensor 402 for an input signal, and then triggers power consumption controller 418. Power consumption controller 418 powers up signal conditioner 423 and other elements. Otherwise, optical sensor 402, voltage regulator 422 (or voltage boost 422) and a signal conditioner 423 are not powered to save battery power. During operation, microcontroller 405 also provides indication data to an indicator 430. Control electronics 400 may receive a signal from the passive optical sensor or the active optical sensor described above. The passive optical sensor includes only a light detector providing a detection signal to microcontroller 405.

Low battery detection unit 425 may be the low battery detector model no. TC54VN4202EMB, available from Microchip Technology. Voltage regulator 422 may be the voltage regulator part no. TC55RP3502EMB, also available from Microchip Technology (http://www.microchip.com). Microcontroller 405 may alternatively be a microcontroller part no. MCU COP8SAB728M9, available from National Semiconductor.

FIG. 10A schematically illustrates another embodiment of control electronics 400. Control electronics 400 receives signals from optical sensor unit 402 and controls actuator 411. As described above, the control electronics also includes microcontroller 405, solenoid driver 408 (i.e., power driver), voltage regulator 422, and a battery 420. Solenoid actuator 411 includes two coil sensors 411A and 411B. Coil sensors 411A and 411B provide a signal to the respective preamplifiers 416A and 416B and low pass filters 417A and 417B. A differentiator 419 provides the differential signal to microcontroller 405 in a feedback loop arrangement.

To open a fluid passage, microcontroller 405 sends OPEN signal 406B to power driver 408, which provides a drive current to the drive coil of actuator 410 in the direction that will retract the armature. At the same time, coils 411A and 411B provide induced signal to the conditioning feedback loop, which includes the preamplifier and the low-pass filter. If the output of a differentiator 419 indicates less than a selected threshold calibrated for the retracted armature (i.e., the armature didn't reach a selected position), microcontroller 405 maintains OPEN signal 406B asserted. If no movement of the solenoid armature is detected, microcontroller 405 can apply a different (higher) level of OPEN signal 406B to increase the drive current (up to several times the normal drive current) provided by power driver 408. This way, the system can move the armature, which is stuck due to mineral deposits or other problems.

Microcontroller 405 can detect the armature displacement (or even monitor armature movement) using induced signals in coils 411A and 411B provided to the conditioning feedback loop. As the output from differentiator 419 changes in response to the armature displacement, microcontroller 405 can apply a different (lower) level of OPEN signal 406B, or can turn off OPEN signal 406B, which in turn directs power driver 408 to apply a different level of drive current. The result usually is that the drive current has been reduced, or the duration of the drive current has been much shorter than the time required to open the fluid passage under worst-case conditions (that has to be used without using an armature sensor). Therefore, the control system saves considerable energy and thus extends the life of battery 420.

Advantageously, the arrangement of coil sensors 411A and 411B can detect latching and unlatching movement of the actuator armature with great precision. (However, a single coil sensor, or multiple coil sensors, or capacitive sensors may also be used to detect movement of the armature.) Microcontroller 405 can direct a selected profile of the drive current applied by power driver 408. Various profiles may be stored in, microcontroller 405 and may be actuated based on the fluid type, the fluid pressure (water pressure), the fluid temperature (water temperature), if the time actuator 410 has been in operation since installation or last maintenance, a battery level, input from an external sensor (e.g., a movement sensor or a presence sensor), or other factors. Based on the water pressure and the known sizes of the orifices, the automatic flush valve can deliver a known amount of flush water.

FIG. 10B provides a schematic diagram of a detection circuit used for the passive optical sensor 50. The passive optical sensor does not include a light source (no light emission occurs) and only includes a light detector that detects arriving light. As compared to the active optical sensor, the passive sensor enables reduced power consumption since all power consumption related to the IR emitter is eliminated. The light detector may be a photodiode, a photo-resistor or some other optical element providing electrical output depending on the intensity or the wavelength of the received light. The light receiver is selected to be active in the range or 350 to 1,500 nanometers and preferably 400 to 1,000 nanometers, and even more preferably, 500 to 950 nanometers. Thus, the light detector is not sensitive to body heat emitted by the user of faucet 10, 10A, 10B or 10C, or body heat emitted by the user located in front of flushers 100 or 100A.

FIG. 10B shows a schematic diagram of the detection circuit used by the passive sensor, which enables a significant reduction in energy consumption. The detection circuit includes a detection element D (e.g., a photodiode or a photo-resistor), two comparators (U1A, and U1B) connected to provide a read-out from the detection element upon receipt of a high pulse. Preferably, the detection element is a photo-resistor. The voltage V_{CC} is +5 V (or +3V) received from the power source. Resistors R₂ and R₃ are voltage dividers between V_{CC} and the ground. Diode D₁ is connected between the pulse input and output line to enable the readout of the capacitance at capacitor C₁ charged during the light detection.

Preferably, the photo-resistor is designed to receive light of intensity in the range of 1 lux to 1000 lux, by appropriate design of optical lens 54 or the optical elements shown in FIGS. 6 through 6E. For example, optical lens 54 may include a photochromatic material or a variable size aperture. In general, the photo-resistor can receive light of intensity in the range of 0.1 lux to 500 lux for suitable detection. The resistance of the photodiode is very large for low light intensity, and decreases (usually exponentially) with the increasing intensity.

Referring still to FIG. 10B, upon receiving a “high” pulse at the input connection, comparator U_{1A} receives the “high” pulse and provides the “high” pulse to node A. At this point, the corresponding capacitor charge is read out through comparator U_{1B} to the output 7. The output pulse is a square wave having a duration that depends on the photocurrent (that charged capacitor C₁ during the light detection time period). Thus, microcontroller 34 receives a signal that depends on the detected light.

In the absence of the high signal, comparator U_{1A} provides no signal to node A, and therefore capacitor C₁ is being charged by the photocurrent excited at the photo resistor D between V_{CC} and the ground. The charging and reading out (discharging) process is being repeated in a controlled manner by providing a high pulse at the control input. The output receives a high output, i.e., the square wave having duration proportional to the photocurrent excited at the photo resistor. The detection signal is in a detection algorithm executed by microcontroller 405.

By virtue of the elimination of the need to employ an energy consuming IR light source used in the active optical sensor, the system can be configured so as to achieve a longer battery life (usually many years of operation without changing the batteries). Furthermore, the passive sensor enables a more accurate means of determining presence of a user, the user motion, and the direction of user's motion.

The preferred embodiment as it relates to which type of optical sensing element is to be used is dependent upon the following factors: The response time of a photo-resistor is on the order or 20-50 milliseconds, whereby a photo-diode is on the order of several microseconds, therefore the use of a photo-resistor will require a significantly longer time form which impacts overall energy use.

Furthermore, the passive optical sensor can be used to determine light or dark in a facility and in turn alter the sensing frequency (as implemented in the faucet detection algorithm). That is, in a dark facility the sensing rate is reduced under the presumption that in such a modality the faucet or flusher will not be used. The reduction of sensing frequency further reduces the overall energy consumption, and thus this extends the battery life.

FIG. 11 illustrates various factors that affect operation and calibration of the passive optical system. The sensor environment is important since the detection depends on the ambient light conditions. If the ambient light in the facility changes from normal to bright, the detection algorithm has to recalculate the background and the detection scale. The detection process differs when the lighting conditions vary (585), as shown in the provided algorithms. There are some fixed conditions (588) for each facility such as the walls, toilet locations, and their surfaces. The provided algorithms periodically calibrate the detected signal to account for these conditions. The above-mentioned factors are incorporated in the following algorithm.

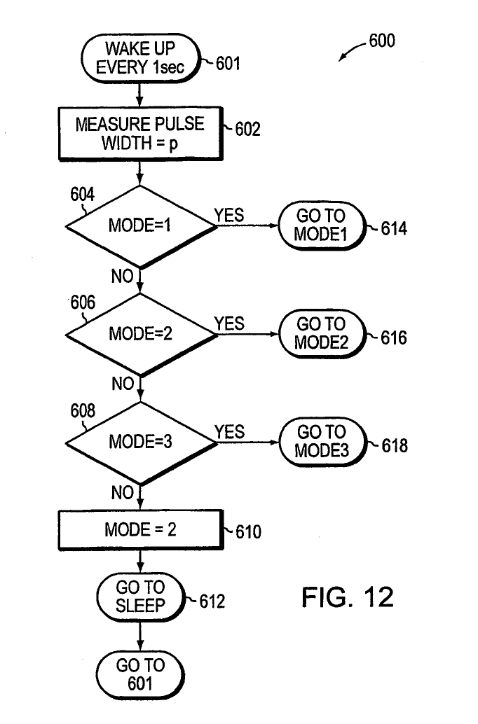

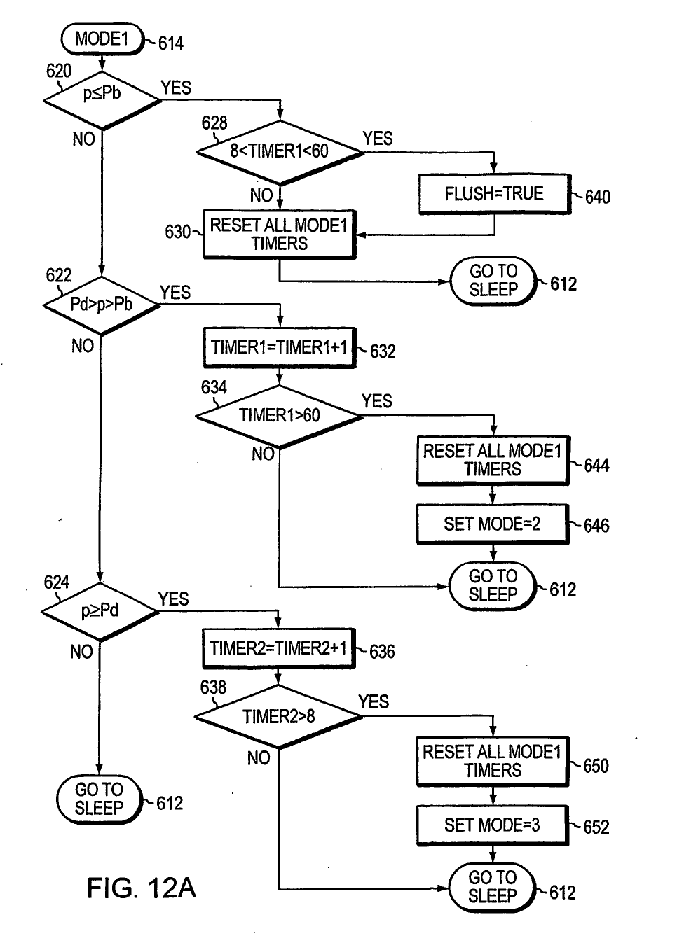

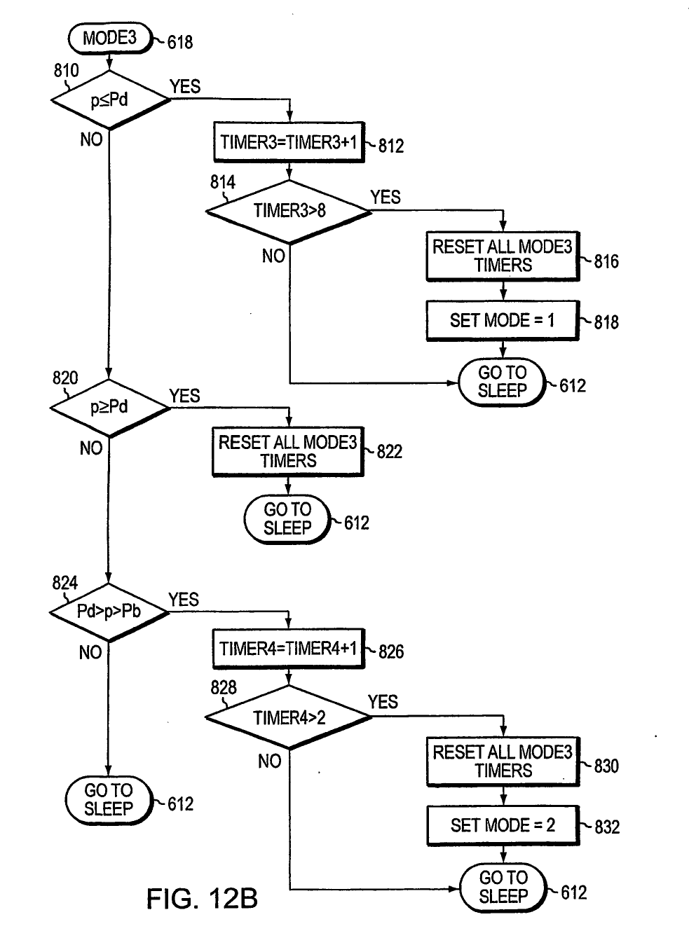

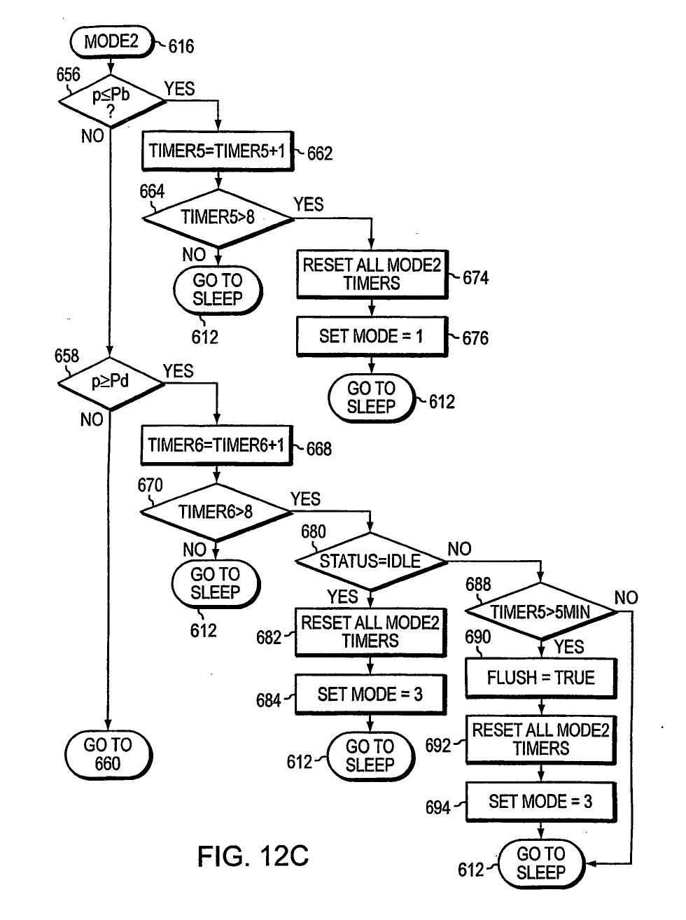

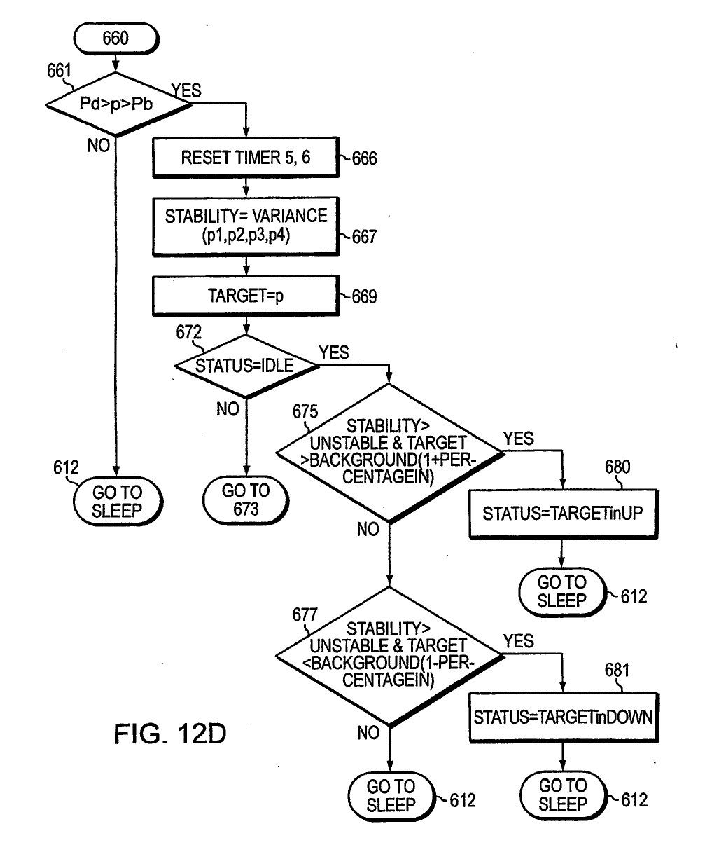

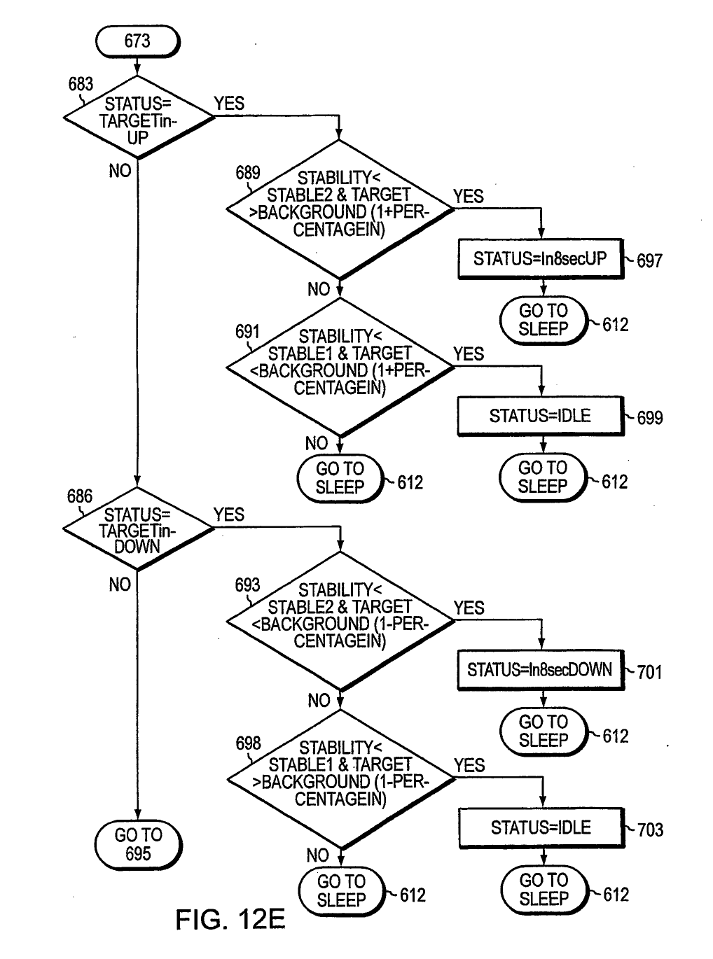

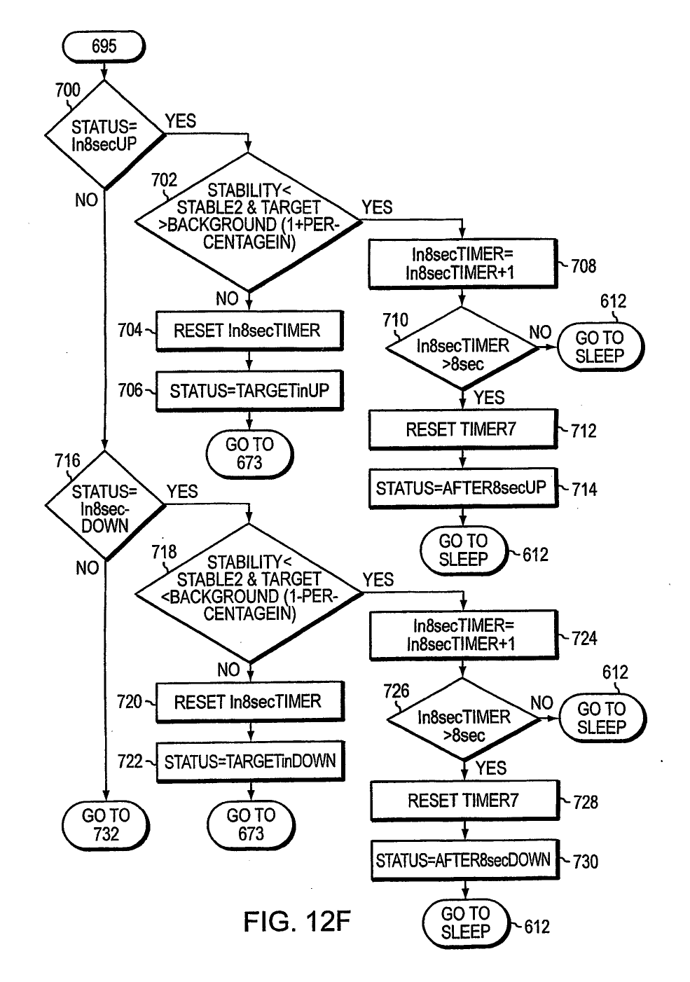

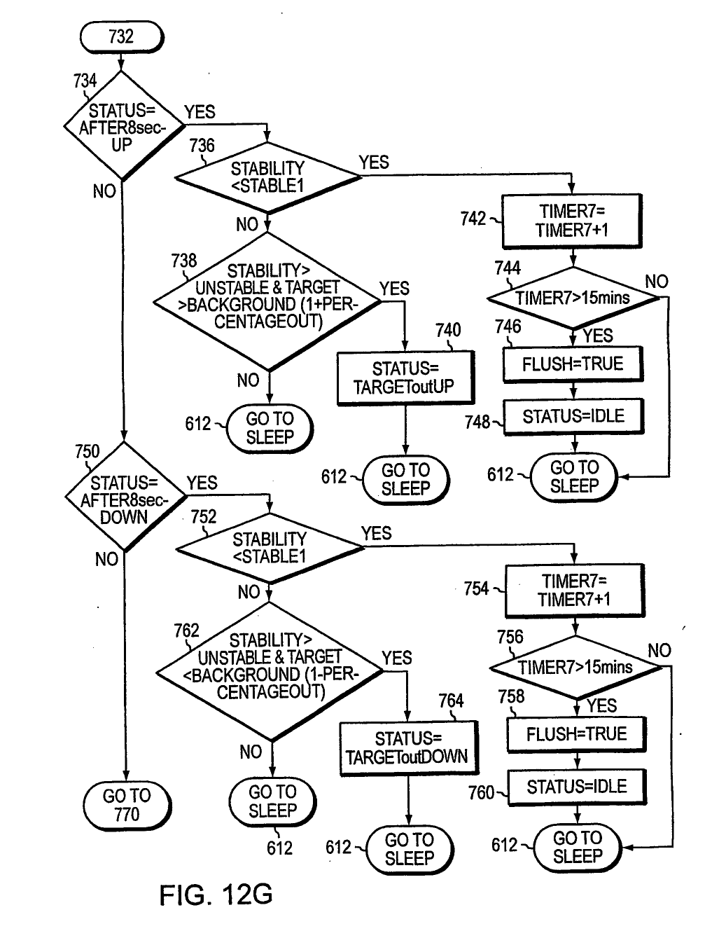

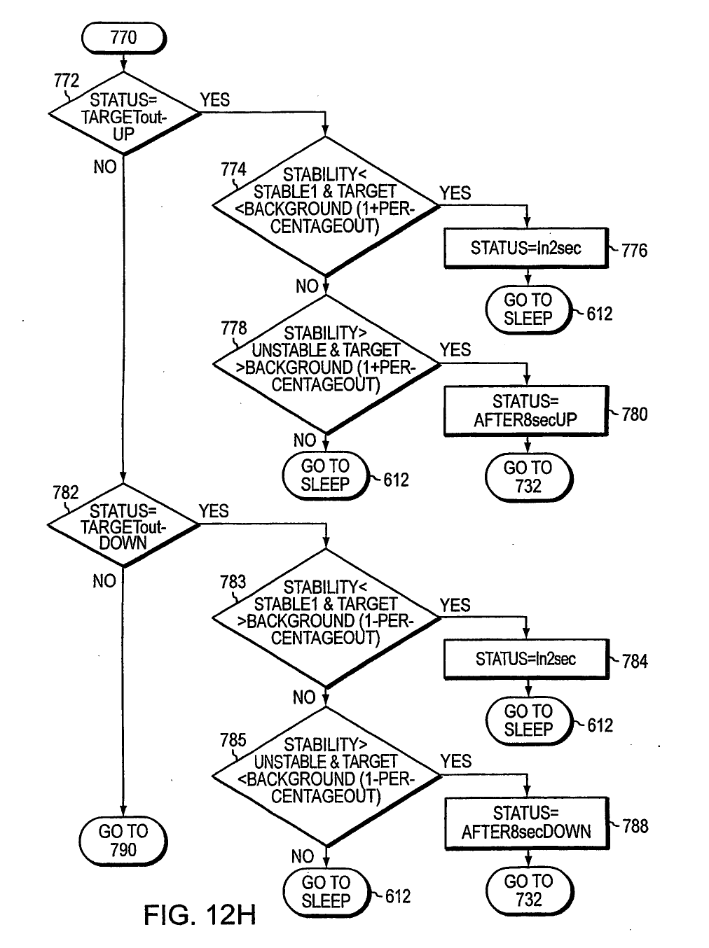

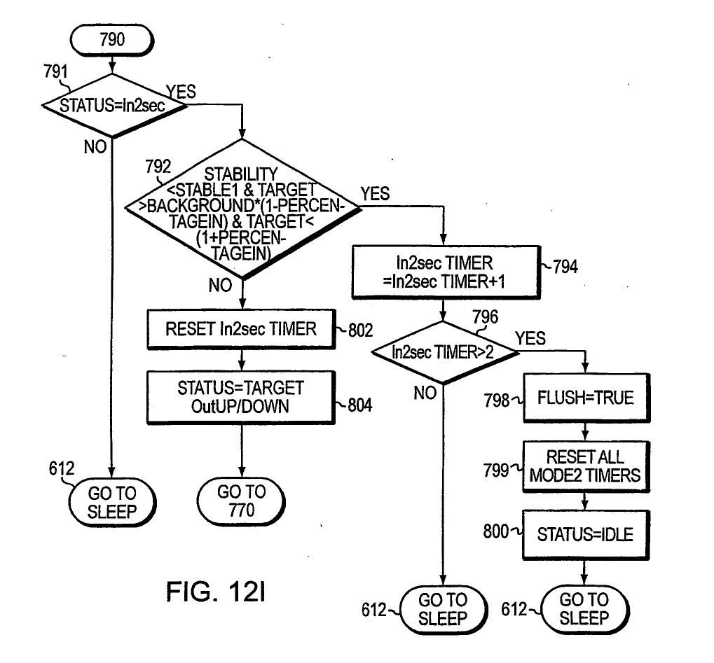

Referring to FIGS. 12-12I, the microcontroller is programmed to execute a flushing algorithm 600 for flushing toilet 116 or urinal 120 at different light levels. Algorithm 600 detects different users in front of the flusher as they are approaching the unit, as they are using the toilet or urinal, and as they are moving away from the unit. Based on these activities, algorithm 600 uses different states. There are time periods between each state in order to automatically flush the toilet at appropriately spaced intervals. Algorithm 600 also controls flushes at particular periods to make sure that the toilet has not been used without detection. The passive optical detector for algorithm 600 is preferably a photoresistor coupled to a readout circuit shown in FIG. 10B.

Algorithm 200 has three light modes: a Bright Mode (Mode 1), a Dark Mode (Mode 3), and a Normal Mode (Mode 2). The Bright Mode (Mode 1) is set as the microcontroller mode when resistance is less than 2 kΩ (Pb), corresponding to large amounts of light detected (FIG. 12). The Dark Mode (Mode 3) is set when the resistance is greater than 2 MΩ (Pd), corresponding to very little light detected (FIG. 12). The Normal Mode (Mode 2) is defined for a resistance is between 2 kΩ and 2 MΩ, corresponding to ambient, customary amounts of light are present. The resistance values are measured in terms of a pulse width (corresponding to the resistance of the photoresistor in FIG. 10B). The above resistance threshold values differ for different photoresistors and are here for illustration only.

The microcontroller is constantly cycling through algorithm 600, where it will wake up (for example) every 1 second, determine which mode it was last in (due to the amount of light it detected in the prior cycle). From the current mode, the microcontroller will evaluate what mode it should go to based on the current pulse width (p) measurement, which corresponds to the resistance value of the photoresistor.

The microcontroller goes through 6 states in Mode 2. The following are the states required to initiate the flush: An Idle status in which no background changes in light occur, and in which the microcontroller calibrates the ambient light; a Targetin status, in which a target begins to come into the field of the sensor; an In8Seconds status, during which the target comes in towards the sensor, and the pulse width measured is stable for 8 seconds (if the target leaves after 8 seconds, there is no flush); an After8Seconds status, in which the target has come into the sensor's field, and the pulse width is stable for more than 8 seconds, meaning the target has remained in front of the sensor for that time (and after which, if the target leaves, there is a cautionary flush); a TargetOut status, in which the target is going away, out of the field of the sensor; an In2Seconds status, in which the background is stable after the target leaves. After this last status, the microcontroller flushes, and goes back to the Idle status.

When the target moves closer to the sensor, the target can block the light, particularly when wearing dark, light-absorbent clothes. Thus, the sensor will detect less light during the Targetin status, so that resistance will go up (causing what will later be termed a TargetInUp status), while the microcontroller will detect more light during the TargetOut status, so that resistance will go down (later termed a TargetOutUp status). However, if the target wears light, reflective clothes, the microcontroller will detect more light as the target gets closer to it, in the Targetin status (causing what will later be described as a TargetInDown status), and less during the TargetOut status (later termed a TargetOutDown status). Two seconds after the target leaves the toilet, the microcontroller will cause the toilet to flush, and the microcontroller will return to the Idle status.

To test whether there is a target present, the microcontroller checks the Stability of the pulse width, or how variable the p values have been in a specific period, and whether the pulse width is more variable than a constant, selected background level, or a provided threshold value of the pulse width variance (Unstable). The system uses two other constant, pre-selected values in algorithm 600, when checking the Stability of the p values to set the states in Mode 2. One of these two pre-selected values is Stable1, which is a constant threshold value of the pulse width variance. A value below means that there is no activity in front of unit, due to the p values not changing in that period being measured. The second pre-selected value used to determine Stability of the p values is Stable2, another constant threshold value of the pulse width variance. In this case a value below means that a user has been motionless in front of the microcontroller in the period being measured.

The microcontroller also calculates a Target value, or average pulse width in the After8Sec status, and then checks whether the Target value is above (in the case of TargetInUp) or below (in the case of TargetInDown) a particular level above the background light intensity: BACKGROUND×(1+PERCENTAGEIN) for TargetInUp, and BACKGROUND×(1−PERCENTAGEIN) for TargetInDown. To check for TargetOutUp and TargetOutDown, the microcontroller uses a second set of values: BACKGROUND×(1+PERCENTAGEOUT) and BACKGROUND×(1−PERCENTAGEOUT).

Referring to FIG. 12, every 1 second (601), the microcontroller will wake up and measure the pulse width, p (602). The microcontroller will then determine which mode it was previously in: If it was previously in Mode 1 (604), it will enter Mode 1 (614) now. It will similarly enter Mode 2 (616) if it had been in Mode 2 in the previous cycle (606), or Mode 3 (618) if it had been in Mode 3 in the previous cycle (608). The microcontroller will enter Mode 2 as default mode (610), if it cannot determine which mode it entered in the previous cycle. Once the Mode subroutine is finished, the microcontroller will go into sleep mode (612) until the next cycle 600 starts with step 601.

Referring to FIG. 12A (MODE 1—bright mode), if the microcontroller was previously in Mode 1 based on the p value being less than or equal to 2 kΩ, and the value of p now remains as greater than or equal to 2 kΩ (620) for a time period measured by timer 1 as greater than 8 seconds, but less than 60 seconds (628), the microcontroller will cause a flush (640), all Mode 1 timers (timers 1 and 2) will be reset (630), and the microcontroller will go to sleep (612) until the next cycle 600 starts at step 601. However, if p changes while timer 1 counts for more than 8 seconds, or less than 60 (628), there will be no flush (640). Simply, all Mode 1 timers will be reset (630), the microcontroller will go to sleep (612), and Mode 1 will continue to be set as the microcontroller mode until the next cycle 600 starts.

If the microcontroller was previously in Mode 1, but the value of p is now greater than 2 kΩ but less than 2 MΩ (622), for greater than 60 seconds (634) based on the timer 1 count (632), all Mode 1 timers will be reset (644), the microcontroller will set Mode 2 (646) as the system mode, so that the microcontroller will start in Mode 2 in the next cycle 600, and the microcontroller will go to sleep (612). However, if p changes while timer 1 counts for 60 seconds (134 to 148), Mode 1 will remain the microcontroller mode and the microcontroller will go to sleep (612) until the next cycle 600 starts.

If the microcontroller was previously in Mode 1, and p is now greater than or equal to 2 MΩ (624) while timer 2 counts (636) for greater than 8 seconds (638), all Mode 1 timers will be reset (650), the microcontroller will set Mode 3 (652) as the new system mode, and the microcontroller will go to sleep (612) until the next cycle 600 starts. However, if p changes while timer 2 counts for 8 seconds, the microcontroller will go to sleep (steps 638 to 612), and Mode 1 will continue to be set as the microcontroller mode until the start of the next cycle 600.

Referring to FIG. 12B (MODE 3—dark mode), if the microcontroller was previously in Mode 3 based on the value of p having been greater than or equal to 2 MΩ, but the value of p is now less than or equal to 2 kΩ (810) for a period measured by timer 3 (812) as greater than 8 seconds (814), the microcontroller will reset timers 3 and 4, or all Mode 3 timers (816), the microcontroller will set Mode 1 as the state (818) until the start of the next cycle 600, and the microcontroller will go to sleep (612). However, if the value of p changes while timer 3 counts for 8 seconds, the microcontroller will go from step 814 to 612, so that the microcontroller will go to sleep, and Mode 3 will continue to be set as the microcontroller mode until the next cycle 600 starts.

If the microcontroller was previously in Mode 3 based on the value of p having been greater than or equal to 2 MΩ, and the value of p is still greater than or equal to 2 MΩ (820), the microcontroller will reset timers 3 and 4 (822), the microcontroller will go to sleep (612), and Mode 3 will continue to be set as the microcontroller mode until the start of the next cycle 600.

If the microcontroller was previously in Mode 3, but p is now between 2 kΩ and 2MΩ (824), for a period measured by timer 4 (826) as longer than 2 seconds (828), timers 3 and 4 will be reset (830), Mode 2 will be set as the mode (832) until the next cycle 600 starts, and the microcontroller will go to sleep (612). However, if p changes while timer 4 counts for longer than 2 seconds, Mode 3 will remain the microcontroller mode, and the microcontroller will go from step 828 to step 612, going to sleep until the next cycle 600 starts. If an abnormal value of p occurs, the microcontroller will go to sleep (612) until a new cycle starts.

Referring to FIG. 12C (MODE 2—normal mode), if the microcontroller mode was previously set as Mode 2, and now p is less than or equal to 2 kΩ (656), for a period measured by timer 5 (662) as more than 8 seconds (664), all Mode 2 timers will be reset (674), Mode 1 (Bright Mode) will be set as the microcontroller mode (676), and the microcontroller will go to sleep (612). However, if p changes while timer 5 counts for longer than 8 seconds, the microcontroller will go to sleep (steps 664 to 612), and Mode 2 will remain the microcontroller mode until the next cycle 600 starts.

However, if now p is greater than or equal to 2 MΩ (658) for a period measured by timer 6 (668) as longer than 8 seconds (670), the toilet is not in Idle status (i.e., there are background changes, 680), and p remains greater than or equal to 2 MΩ while timer 6 counts for over 5 minutes (688), the system will flush (690). After flushing, timers 5 and 6 will be reset (692), Mode 3 will be set as the microcontroller mode (694), and the microcontroller will go to sleep (612). Otherwise, if p changes while timer 6 counts for longer than 5 minutes, the system will go from step 688 to 612, and go to sleep.

If the microcontroller mode was previously set as Mode 2, now p is greater than or equal to 2 MΩ (658) for a period measured by timer 6 (668) as more than 8 seconds (670), but the toilet is in Idle status (680), timers 5 and 6 will be reset (682), Mode 3 will be set as microcontroller mode (684), and the microcontroller will go to sleep at step 612.

If p is greater or equal to 2 MΩ, but changes while timer 6 counts (668) to greater than 8 seconds (670), the microcontroller will go to sleep (612), and Mode 2 will remain as the microcontroller mode. If p is within a different value, the microcontroller will go to step 660 (shown in FIG. 12D).

Referring to FIG. 12D, alternatively, if the microcontroller mode was previously set as Mode 2, and p is greater than 2 kΩ and less than 2 MΩ (661), timers 5 and 6 will be reset (666), pulse width Stability will be checked by assessing the variance of the last four pulse width values (667), and the Target value is found by determining the pulse width average value (step 669).

At this point, when the status of the microcontroller is found to be Idle (672), the microcontroller goes on to step 675. In step 675, if the Stability is found to be greater than the constant Unstable value, meaning that there is a user present in front of the unit, and the Target value is larger than the Background×(1+PercentageIn) value, meaning that the light detected by the microcontroller has decreased, this leads to step 680 and a TargetInUp status (i.e., since a user came in, towards the unit, resistance increased because light was blocked or absorbed), and the microcontroller will go to sleep (612), with Mode 2 TargetInUp as the microcontroller mode and status.

When the conditions set in step 675 are not true, the microcontroller will check if those in 677 are. In step 677, if the Stability is found to be greater than the constant Unstable value, due to a user in front of the unit, but the Target value is less than the Background×(1−PercentageIn) value, due to the light detected increasing, this leads to a “TargetInDown” status in step 681, (i.e., since a user came in, resistance decreased because light off of his clothes is reflected), and the microcontroller will go to sleep (612), with Mode 2 TargetInDown as the microcontroller mode and status. However, if the microcontroller status is not Idle (672), the microcontroller will go to step 673 (shown in FIG. 12E).

Referring to FIG. 12E, if the system starts in the TargetInUp status (683), at step 689 the system will check whether the Stability value is less than the constant Stable2, and whether the Target value is greater than Background×(1+PercentageIn) (689). If both of these conditions are simultaneously met, which would mean that a user is motionless in front of the unit, blocking light, the microcontroller will now advance to In8SecUp status (697), and go to sleep (612). If the two conditions in step 689 are not met, the system will check whether Stability is less than Stable1 and Target is less than Background×(1+PercentageIn) at the same time (691), meaning that there is no user in front of the unit, and there is a large amount of light being detected by the unit. If this is the case, the system status will now be set as Mode 2 Idle (699), and the microcontroller will go to sleep (612). If neither of the sets of conditions in steps 689 and 691 is met, the system will go to sleep (612).

If the TargetInDown status (686) had been set in the previous cycle, the system will check whether Stability is less than Stable2 and Target is less than Background×(1−PercentageIn) at the same time in step 693. If this is so, which would mean that there is a user motionless in front of the unit, with more light being detected, the microcontroller will advance status to In8SecDown (701), and will then go to sleep (612).

If the two requirements in step 693 are not met, the microcontroller will check if Stability is less than Stable1 while at the same time Target is greater than Background×(1−PercentageIn) in step 698. If both are true, the status will be set as Mode 2 Idle (703), due to these conditions signaling that there is no activity in front of the unit, and that there is a large amount of light being detected by the unit, and it will go to sleep (612). If Stability and Target do not meet either set of requirements from steps 693 or 698, the microcontroller will go to sleep (612), and Mode 2 will continue to be the microcontroller status. If status is not Idle, TargetInUp or TargetInDown, the microcontroller will continue as in step 695 (shown in FIG. 12F) Referring to FIG. 12F, if In8SecUp had been set as the status (700), the unit will check whether Stability is less than Stable2, and at the same time Target is greater than Background×(1+PercentageIn) in step 702. If these conditions are met, meaning that there is a motionless user before the unit, and that there is still less light being detected, the timer for the In8Sec status will start counting (708). If the two conditions continue to be the same while the timer counts for longer than 8 seconds, timer 7 is reset (712), the microcontroller advances to After8SecUp status (714), and finally goes to sleep (612). If the two conditions change while the timer counts to above 8 seconds (710), the microcontroller will go to sleep (612). If in step 702 the requirements are not met by the values of Stability and Target, the In8Sec timer is reset (704), in step 706 the microcontroller status is set as TargetInUp, and the microcontroller will proceed to step 673 (FIG. 12E).

Referring to FIG. 12F, if the microcontroller status was set as In8SecDown (716), the microcontroller checks whether Stability is less than Stable2, and at the same time Target is less than Background×(1−PercentageIn) in step 718, to check whether the user is motionless before the unit, and whether it continues to detect a large amount of light. If the two values meet the simultaneous requirement, the In8Sec status timer will start counting (724). If it counts for longer than 8 seconds while the two conditions are met (726), timer 7 will be reset (728), the status will be advanced to After8SecDown (730), and the microcontroller will go to sleep (612).

If the timer does not count for longer than 8 seconds while Stability and Target remain at those ranges, the microcontroller will not advance the status, and will go to sleep (612). If the requirements of step 718 are not met by the Stability and Target values, the In8SecTimer will be reset (720), and the microcontroller status will be set to TargetInDown (722), where the microcontroller will continue to step 673 (FIG. 12E). If the Mode 2 state is none of those covered in FIGS. 12C-F, the system continues through step 732 (shown in FIG. 12G)

Referring to FIG. 12G, in step 734, if the system was in the After8SecUp status (734), it will check whether Stability is less than Stable1, that is, whether there is no activity before the unit. If so, timer 7 will start counting (742), and if Stability remains less than Stable1 until timer 7 counts for longer than 15 minutes (744), the microcontroller will flush (746), the Idle status will be set (748), and the microcontroller will go to sleep (612). If Stability does not remain less than the Stable1 value until timer 7 counts for longer than 15 minutes, the microcontroller will go to sleep (612) until the next cycle.

If Stability was not less than Stable1, the microcontroller checks whether it is greater than Unstable, and whether Target is greater than Background×(1+PercentageOut) (738). If both simultaneously meet these criteria, meaning that there is a user moving in front of the unit, but there is more light being detected because they are moving away, the microcontroller advances to Mode 2 TargetOutUp as the microcontroller status (740), and the microcontroller goes to sleep (612). If Stability and Target do not meet the two criteria in step 738, the microcontroller goes to sleep (612).

If the microcontroller was in After8SecDown (750), it will check whether the Stability is less than Stable1 at step 752. If so, timer 7 will begin to count (754), and if it counts for greater than 15 minutes (756), the microcontroller will flush (758), Idle status will be set (760), and the microcontroller will go to sleep (612). If Stability does not remain less than Stable1 until timer 7 counts to greater than 15 minutes, the microcontroller will go to sleep (612) until the next cycle.

If the Stability is not found to be less than Stable1 at step 752, the microcontroller will check whether Stability is greater than Unstable, while at the same time Target is less than Background×(1−PercentageOut) at step 762. If so, this means that there is a user in front of the unit, and that it detects less light because they are moving away, so that it will advance the status to TargetOutDown at step 764, and will go to sleep (612). Otherwise, if both conditions in step 762 are not met, the microcontroller will go to sleep (612). If the Mode 2 state is none of those covered in FIGS. 12C-G, system continues through step 770 (shown in FIG. 12H).

Referring to FIG. 12H, if TargetOutUp had been set as the status (772), the microcontroller will check whether Stability is less than Stable1 while Target is less than Background×(1+PercentageOut), in step 774. If so, it will set the status as In2Sec (776), and the microcontroller will go to sleep (612). However, if Stability and Target do not simultaneously meet the criteria in step 774, the microcontroller will check if Stability is greater than Unstable and at the same time Target is greater than Background×(1+PercentageOut) in step 778. If so, it will set the status as After8SecUp (780), and it will go to 732 where it will continue (See FIG. 12). If Stability and Target do not meet the criteria of either step 774 or 778, the microcontroller will go to sleep (612).

If the microcontroller is in TargetOutDown status (782), it will check whether Stability is less than Stable1, and Target greater than Background×(1−PercentageOut) simultaneously (783). If so, it would mean that there is no activity in front of the unit, and that there is less light reaching the unit, so that it will advance status to In2Sec (784), and go to sleep (612). However, if Stability and Target do not meet both criteria of step 783, the microcontroller will check whether Stability is greater than Unstable, and Target is less than Background×(1−PercentageOut) simultaneously in step 785. If so, the microcontroller will set status as After8SecDown (788), and go to step 732 where it will continue (See FIG. 12G). If Stability and Target meet neither set of criteria from steps 783 or 785, the microcontroller will go to sleep (612).

Referring to FIG. 121, if the microcontroller set In2Sec status in the previous cycle (791), it will check whether Stability is less than Stable1 (792), which is the critical condition: since the user has left, there are no fluctuations in the light detected via resistance. It will also check whether the Target value is either greater than Background×(1−PercentageIn), or less than Background×(1+PercentageIn), in step 792. If this is the case, there is no activity in front of the unit, and the light detected is neither of the two levels required to signify a user blocking or reflecting light, which would indicate that there is no user in front of the unit. The system would then start the In2Sec status timer in step 794, and if it counts for longer than 2 seconds (796) with these conditions still at hand, the microcontroller will flush (798), all Mode 2 timers will be reset in step 799, the status will be set back to Idle in step 800, and the microcontroller will go to sleep (612). If the Stability and Target values change while the In2Sec timer counts to greater than 2 seconds (796), the microcontroller will go to sleep (612) until the start of the next 600 cycle.

If Stability and Target values do not meet the two criteria set in step 792, the In2Sec timer is reset (802), the status is changed back to either TargetOutUp or TargetOutDown in step 804, and the microcontroller goes to step 770 (FIG. 12H). If the microcontroller is not in In2Sec status either, the microcontroller will go to sleep (612), and start algorithm 600 again.

FIGS. 13, 13A, and 13B illustrate a control algorithm for faucets 10, 10A and 10B. Algorithm 900 includes two modes. Mode 1 is used when the passive sensor is located outside the water stream (faucet 10B), and Mode 2 is used when the passive sensors field of view is inside the water stream (faucets 10 and 10A). In Mode 1 (algorithm 920) the sensor located outside the water stream detects the blocking of the light by a nearby user's hands, and checks for how long the low light remains steady, interpreting it as the user at the sink, but also excluding a darkening of the room the unit is placed in as a similar signal. This sensor then will directly turn off the water once the user has left the faucet, or once it no longer detects unstable, low levels of light.

In Mode 2 (algorithm 1000), the photoresistor inside the water stream also uses the above variables, but takes an additional factor into consideration: running water can also reflect light, so that the sensor may not be able to completely verify the user having left the faucet. In this case, the algorithm also uses a timer to turn the water off, while then actively checking whether the user is still there. Modes 1 or 2 may be selectable, for example, by a dipswitch.

Referring to FIG. 13, algorithm 900 commences after the power goes on (901), and the unit initializes the module in step 902. The microcontroller then checks the battery status (904), resets all timers and counters (906), and closes the valve (shown in FIGS. 1, 2, 4 and 4A) in step 908. All electronics are calibrated (910), and the microcontroller establishes a background light threshold level, (BLTH), in step 912. The microcontroller will then determine which mode to use in step 914: In Mode 1, the microcontroller executes algorithm 920 (to step 922, FIG. 13A) and in Mode 2, the microcontroller executes algorithm 1000 (to step 1002, FIG. 13B).

Referring to FIG. 13A, if the microcontroller uses Mode 1, the passive sensor scans for a target every ⅛ of a second (924). The scan and sleep time may be different for different light sensors (photodiode, photoresistor, etc. and their read out circuits). For example, the scan frequency can be every ¼ second or every ¾ second. Also, just as in the algorithm shown in FIG. 12, the microcontroller will go through the algorithm and then go to sleep in between the executed cycles. After scanning, the microcontroller measures the sensor level (SL), or value corresponding to the resistance of the photoresistor, at step 925. It will then compare the sensor level to the background light threshold level (BLTH): if the SL is greater than or equal to 25% of the BLTH (926), the microcontroller will further determine whether it is greater than or equal to 85% of the BLTH (927). These comparisons determine the level of ambient light: if the SL is higher than or equal to 85% of the BLTH calculated in step 912, it would mean that it is now suddenly very dark in the room (947), so that the microcontroller will go into Idle Mode, and scan every 5 seconds (948) until it detects the SL being less than 80% of the BLTH, meaning there is now more ambient light (949). Once this is detected, the microcontroller will establish a new BLTH for the room (950), and cycle back to step 924, at which it will continue to scan for a target every ⅛ of a second with the new BLTH.

If SL is smaller than 25% of the previously established BLTH, this would mean that the light in the room has suddenly dramatically increased (direct sunlight, for example). The scan counter starts counting to see if this change is stable (928) as the microcontroller cycles through steps 924, 925, 926, 928 and 929, until it reaches five cycles (929). Once it does reach the five cycles under the same conditions, it will establish a new BLTH in step 930 for the now brightly lit room, and begin a cycle anew at step 922 using this new BLTH.

If, however, the SL is between 25% greater than or equal to, but no greater than 85% of the BLTH (at steps 926 and 927), light is not at an extreme range, but regular ambient light, and the microcontroller will set the scan counter to zero at step 932, measure SL once more to check for a user (934), and assess whether the SL is between greater than 20% BLTH or less than 25% BLTH (20% BLTH<SL<25% BLTH) at step 936. If not, this would mean that there is a user in front of the unit sensor, as the light is lower than regular ambient light, causing the microcontroller to move on to step 944, where it will turn the water on for the user. Once the water is on, the microcontroller will set the scan counter to zero (946), scan for the target every ⅛ of a second (948), and continue to check for a high SL, that is, for low light, in step 950 by checking whether the SL is less than 20% of the BLTH. When SL decreases to less than 20% of BLTH (950), meaning that the light detected increased, the microcontroller will move on to step 952, turning on a scan counter. The scan counter will cause the microcontroller to continue scanning every ⅛ of a second and checking that SL is still less than 20% of BLTH until over 5 cycles through 948, 950, 952 and 954 have passed (954), which would mean that there now has been an increase in light which has lasted for more than 5 of these cycles, and that the user is no longer present. At this point the microcontroller will turn the water off (956). Once the water is turned off, the whole cycle is repeated from the beginning.

Referring to FIG. 13B (algorithm 1000 for faucet 10), the microcontroller scans for a target every ⅛ of a second (1004), although, again, the time it takes between any of the scans could be changed to another period, for example, every ¼ of a second. Once more, the microcontroller will go through the algorithm and then go to sleep in between cycles just as in the algorithm shown in FIG. 12. After scanning, the microcontroller will measure the sensor level (1006), and compare the SL against the BLTH. Once again, if the SL is greater than or equal to 25% of the BLTH, the microcontroller will check whether it is greater than or equal to 85% of the BLTH. If it is, it will take it to mean that the room must have been suddenly darkened (1040). The microcontroller will then go into Idle Mode at step 1042, and scan every 5 seconds until it detects the SL being less than 80% of the BLTH, meaning it now detects more light (1044). Once it does, the microcontroller will establish a new BLTH for the newly lit room (1046), and it will cycle back to step 1004, starting the cycle anew with the new BLTH for the room.

If the SL is between greater than or equal to 25% or less than 85% of the BLTH, the microcontroller will continue through step 1015, and setting the scan counter to zero. It will measure the SL at step 1016, and assess if it is greater than 20% BLTH, but smaller than 25% BLTH (20% BLTH<SL<25% BLTH), at step 1017. If it is not, meaning there is something blocking light to the sensor, the microcontroller will turn water on (1024); this also turns on a Water Off timer, or WOFF (1026). Then, the microcontroller will continue to scan for a target every ⅛ of a second (1028). The new SL is checked against the BLTH, and if the value of SL is not between less than 25% BLTH, but greater than 20% BLTH (20% BLTH<SL<25% BLTH), the microcontroller will loop back to step 1028 and continue to scan for the target while the water runs. If the SL is within this range (1030), the WOFF timer now starts to count (1032), looping back to the cycle at step 1028. The timer's function is simply to allow some time to pass between when the user is no longer detected and when the water is turned off, since, for example, the user could be moving the hands, or getting soap, and not be in the field of the sensor for some time. The time given (2 seconds) could be set differently depending upon the use of the unit. Once 2 seconds have gone by, the microcontroller will turn the water off at step 1036, and it will cycle back to 1002, where it will repeat the entire cycle.

However, if at step 1017 SL is greater than 20% BLTH, but smaller than 25% BLTH (20% BLTH<SL<25% BLTH), the scan counter will begin to count the number of times the microcontroller cycles through steps 1016, 1017, 1018 and 1020, until more than five cycles are reached. Then, it will go to step 1022, where a new BLTH will be established for the light in the room, and the microcontroller will cycle back to step 1002, where a new cycle through algorithm 1000 will occur, using the new BLTH value.

As described above, in general, the active optical sensor emits light at different light intensities and detects the corresponding echo from a target. (This intensity scanning is described in FIGS. 14A and 14B.) The passive optical sensor uses only a light detector that measures the increase or decrease or stability (over short times on the order of less than 2 sec.) of primarily ambient light. This sensor's algorithm executes several states described above. The state Targetin is entered when the target is moving in; the state In8Sec is entered just after the somewhat stationary target reached the sensor, after which point the After8Sec state is entered. Upon the departure of the target, the algorithm enter the TargetOut state, followed by the In2Sec state initiating a flush. From each of these states, the algorithm can enter the idle state (or a ResetWait state) if an error cause the prior state. The following active sensor detection algorithm uses similar states.

FIGS. 14, 14A, 14B and 14C illustrate an active sensor detection algorithm (ASDA) for detecting an object such as pants (i.e. “pants” detection algorithm). Algorithm 1100 is designed for use with an active optical sensor having a light source (e.g., a light emitting diode 132A and light detector, e.g., IR diode 132B (FIG. 7A). The microcontroller directs the source driver to provide an adjustable IR emitter current intensity for light emitting diode 132A while maintaining a fixed amplifier gain for IR receiver 132B.

In general, algorithm 1100 detects user movement by using up to 32 different IR beam intensities (emitted from LED 132A) scanned and reflected IR signals detected in succession. For example, the IR current needs to be higher when sensing a target far away from the flusher. On the other hand, algorithm 1100 can identify a user moving in or out (that is, closer and away from the active optical sensor) by using a comparison of detected IR current changes. The IR emitter scans the emitted light intensity from max IR beam to min IR beam (the LED current is changed form high to low). When gradually detecting the target (or user) at lower light intensities, the target is moving toward the flusher. The optical sensor may use various noise-reduction techniques. For example, the emitter may emit modulated light (use modulated source current) and the detector may be “locked” onto the modulation. For example, the light emitter may use a selected number of pulses and the detector will “look” for reflected light corresponding to these pulses. If the selected number of pulses is not detected, the detector received some outside noise and not a signal corresponding to the emitted light. Alternatively, the light emitter may use a sinusoidal excitation current and the light detector may be coupled to a lock-in amplifier for eliminating the noise.

As shown in FIG. 14C, the control logic uses different target states as follows: IDLE (1201), ENTER_STAND (1202), STAND_SIT (1204), SIT_STAND (1210), STAND_FLUSH_WAIT (1206), FLUSH_HALF (1208), SIT_FLUSH_FULL (1211), STAND_OUT (1212), SIT_FLUSH_FULL (1214), RESET_WAIT (1216), and EXIT_RESET (1220). All the states are based upon a target or user behavior in the IR sensing field. When a target or user enters the optical field (emitted from LED and detected IR echo), the state will be set to ENTER_STAND state. The state will be set into STAND_SIT state while a target stops moving after an ENTER_STAND state set, that is, the target is substantially stationary for longer than “STAND_TIME”.

For example, when a user moves toward the sensing field, the state will change from IDLE to ENTER_STAND. If a user spends enough time in front of the flusher, the state will be changed to STAND_SIT. If the user gets even closer to the flusher, the state will become SIT_STAND. Each state can proceed to a subsequent “Use” state or can enter the EXIT_RESET state if the prior state was entered in error. Thus, the algorithm provides a “self correction”. Then, the unit will turn back to idle state again.

Referring to FIG. 14, the active sensor detection algorithm (ASDA) 1100 uses a target sensing sub-routine 1110 that cycles through up to 32 different levels of light emission intensity emitted from IR light emitting diode 132A (FIG. 7A). For each intensity, IR detector 132B detects the corresponding reflected signal. When using a noise-reduction technique, IR light emitting diode 132A emits, for example, 4 pulses of equal intensity having a duration of about 20 μsec and being spaced apart 100 μsec. IR detector 132B detects the reflected light that should also consist of 4 pulses. Any other signal corresponds to noise.

As shown in FIG. 14A, the maximum and minimum light source powers are selected and stored in temporary buffers (step 1112 through 1118). Light source 132A emits the corresponding optical signal at the power level stored in a temporary buffer 1, and light detector 132B detects the corresponding reflected signal. As shown in step 1122 if no echo is detected, the power level is cycled one step higher up to maximum power. Alternatively, the power level may be cycled from maximum value down to a minimum value. The power increase is performed according to steps 1132 and 1134 and the entire process is repeated starting with step 1114. In step 1122, if the corresponding echo signal is detected, the current power level is assigned the final value (step 1124). The next power level is averaged as shown in block 1126, and the pointer numbering is increased (step 1128). Next, the entire cycle is repeated starting with step 1114. This way, the light source increases the power values up to a specific power value where the corresponding echo is detected.

Referring still to FIG. 14, in steps 1150 through and 1152, the processor checks the battery status and then proceeds to accumulating sample data as shown in step 1154. The accumulated optical data is processed using the algorithm shown in FIG. 14B. In steps 1162 through 1166, the processor finds the average of the most recent four IR detection levels. Next, the processors finds the longest level period in the buffer (Step 1168), and finds the average of the IR level in the buffer (step 1170)). Before each data is processed, the processor checks if a manual flush was actuated by a user (step 1180). If a manual flush was actuated, the processor exits the present target state as shown in block 1182; that is, the processor enters EXIT_RESET (1220) and initiates a flush. The flush will be a full flush unless the prior state was STAND_FLUSH_WAIT (1206), in which case the processor initiates a half flush. Alternatively, if no manual flush was actuated, the processor continues determining the individual target states, as shown in FIG. 14C.

Referring to FIG. 14C, the processor is in IDLE (1201) until a user is detected. The IR emitter scans the IR intensities, and when at an intensity the IR echo is detected, the sensor moves to a lower intensity. If a user is detected for five IR values that are less than IR max, and the target appears in three samples saved in the roll (explained in connection with FIG. 14A), the processor moves to ENTER_STAND (1202). Subsequently, if the target is not detected in three subsequent samples in the roll, the processor will go to EXIT_RESET (1220). Alternatively, if the stationary period is larger than 2.5 seconds (i.e., stand time), the processor enters STAND_SIT (1204). Next, if the IR detected power level is smaller than the preceding IR power level for five or six subsequent detection steps (i.e., the detected IR value is less than the recent 8 second average IR level) and this occurs repeatedly in two samples in the roll, the processor will enter SIT_STAND (1210). In this state, the user is likely sitting on the toilet, or is very close. The IR detection occurs at a very low intensity level. Otherwise, if the stationary period is less than the stationary time, the processor will move to EXIT_RESET (1220).

In STAND_SIT (1204), if the stationary period is larger than stationary time and the target moves out, the processor will enter STAND_FLUSH_WAIT (1206). From this state, the processor may move to FLUSH_HALF (1208), in which a flush is initiated. Alternatively, the target may move in and the processor will enter STAND_SIT (1204). This happens, for example, when a user moves inside a bathroom stall. When the IR detection level is reduced (as described above), the processor enters SIT_STAND (1210). In this state, the user is very close to the flusher. When the target moves out (detected at a higher IR level) and the stationary period is larger than stationary time (selected, for example, 6 seconds), the processor can execute either a half flush or a full flush algorithm. If the stationary period is larger than a selected stationary time, and sit time is smaller than selected use time, the processor enters FLUSH_HALF (1208).

In FLUSH_HALF, a half flush is initiated, usually after a user providing a liquid waste. This state saves flush water and proceeds to EXIT_RESET (1220). If the target stood up and the stationary period is larger than stationary time, the processor enters STAND_OUT (1212). From this state, if the sit time is less than use time (Tu), the processor enters FLUSH_HALF (1208). Otherwise, the processor enters SIT_FLUSH_FULL (1214), and the algorithm initiates a full flush usually after the user deposited a solid waste.

In SIT_STAND (1210), if the target moves out and the stationary period is larger than the selected stationary time, and the sit time is larger than use time (Tu), the processor enters SIT_FLUSH_FULL (1214). In this state, the processor initiates a full flush and moves to RESET_WAIT (1216). The flush is initiated usually after a short delay time to enable the user's movement away from the toilet. STAND_OUT (1212) is designed for a user who used the toilet, stood up and was waiting for a flush before leaving the bathroom stall. In this state, the active sensor still registers the user, but at a distance.

The system may determine whether the absolute value of the difference between the current gain and the gain listed in the top stack entry exceeds a threshold gain change. If it does not, the current call of this routine results in no new entry's being pushed onto the stack, but the contents of the existing top entry's timer field are incremented. The result is instead that the gain's changed absolute value was indeed greater than the threshold, then the routine pushes a new entry onto the stack, placing the current gain in that entry's gain field and giving the timer field the value of zero. In short, a new entry is added whenever the target's distance changes by a predetermined step size, and it keeps track of how long the user has stayed in roughly the same place without making a movement as great as that step size.

The routine also gives the entry's in/out field an “out” value, indicating that the target is moving away from the flusher if the current gain exceeds the previous entry's gain, and it gives that field an “in” value if the current gain is less than the previous entry's gain. In either case, the routine then performs the step of incrementing the timer (to a value of “1”) and moves from the stack-maintenance part of the routine to the part in which the valve-opening criteria are actually applied.

Applying the first criterion, (i.e., namely, whether the top entry's in/out field indicates that the target is moving away), if the target does not meet this criterion, the routine performs the step of setting the flush flag to the value that will cause subsequent routines not to open the flush valve, and the routine returns. If that criterion is met, on the other hand, the routine performs the step of determining whether the top entry and any immediately preceding entries indicate that the target is moving away are preceded by a sequence of a predetermined minimum number of entries that indicated that the target was moving in. If they were not, then it is unlikely that a user had actually approached the facility, used it, and then moved away, so the routine again returns after resetting the flush flag. Note that the applied criterion is independent of absolute reflection percentage; it is based only on reflection-percentage changes, requiring that the reflection percentage traverse a minimum range as it increases.

If the system determines that the requisite number of inward-indicating entries did precede the outward-indicating entries, then the routine imposes the criterion of determining whether the last inward-movement-indicating entry has a timer value representing at least, e.g., 5 seconds. This criterion is imposed to prevent a flush from being triggered when the facility was not actually used. Again, the routine returns after resetting the flush flag if this criterion is not met.

If it is met, on the other hand, then the routine imposes the criteria of which are intended to determine whether a user has moved away adequately. If the target appears to have moved away by more then a threshold amount, or has moved away slightly less but has appeared to remain at that distance for greater then a predetermined duration, then, the routine sets the flush flag before returning. Otherwise, it resets the flush flag.

The above described flusher uses a novel algorithm for delivering variable amounts of water for flushing. The flush algorithm is executed by the microcontroller, which controls the operation of the solenoid actuator as described above. The algorithm causes delivery of a selected amount of water depending on the use. For example, the algorithm can direct delivery of a “full” amount of water for a “full flush,” 50% of the full amount of water i.e., “half flush”, or any other selected amount of water for varying pressure levels in the input water pipe. The delivered amount of water depends on the water pressure, detected by the actuator, the size of the valve opening, and the open time of the flusher valve. The following algorithm explains specifically various important concepts and the logic of the flush system. Each block in algorithm 1300 may represent one or several steps or subroutines, or several blocks may be combined into a single step or subroutine. A person of ordinary skill in the art can use various ways to write a source code for executing algorithm 1300, and similarly algorithm 1300 can be illustrated differently while still embodying the presently described concept and logic of the flush actuation.

Algorithm 1300 is used in various toilet and urinal flushers and includes different modes of operation for different uses and different amounts of flush water used. Depending on the use, the various modes may be selected initially at the time of installation using appropriate dip switches mounted on the flusher. Alternatively, the various modes may be selected via a user interface at the time of installation, or subsequently by an operator. Upon providing power, the entire system powers up (Step 1302) and the electronic module is initialized (step 1304). The microcontroller receives battery check status data (step 1306), and the unit resets all timers used in the algorithm described below (step 1308). The solenoid valve is initially closed (step 1310), and the unit enters the idle mode (step 1312). Depending on the mode setting, the algorithm enters mode A, B, C, D, or E, as described below.

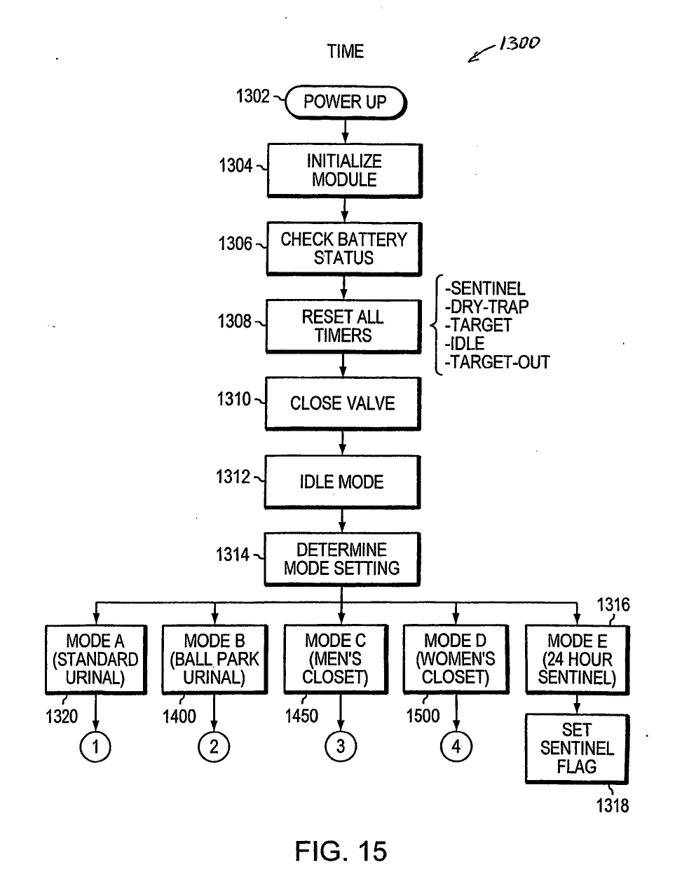

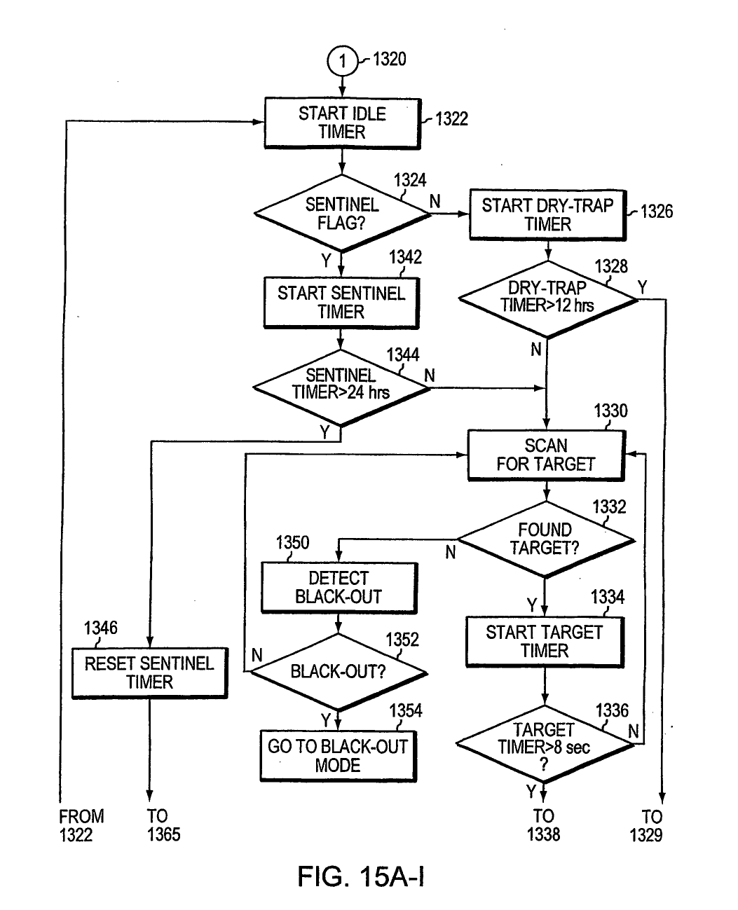

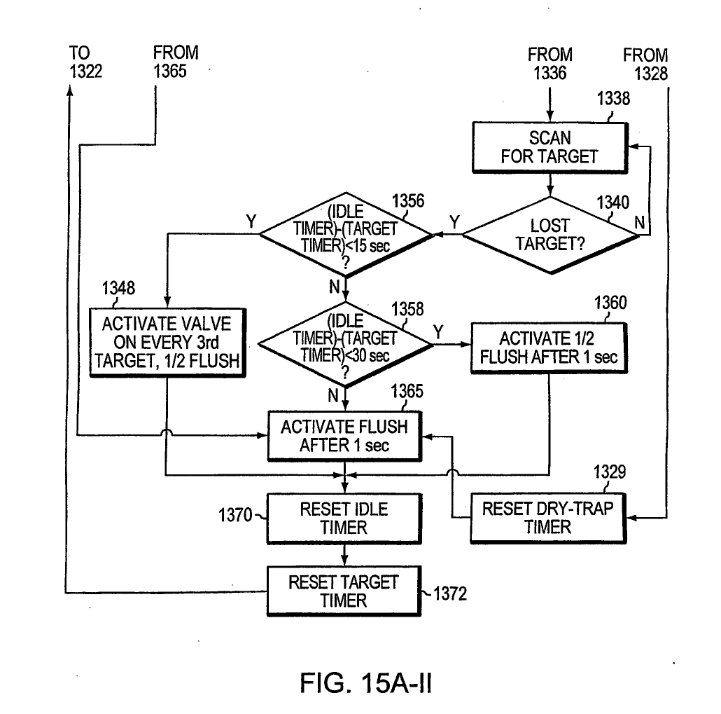

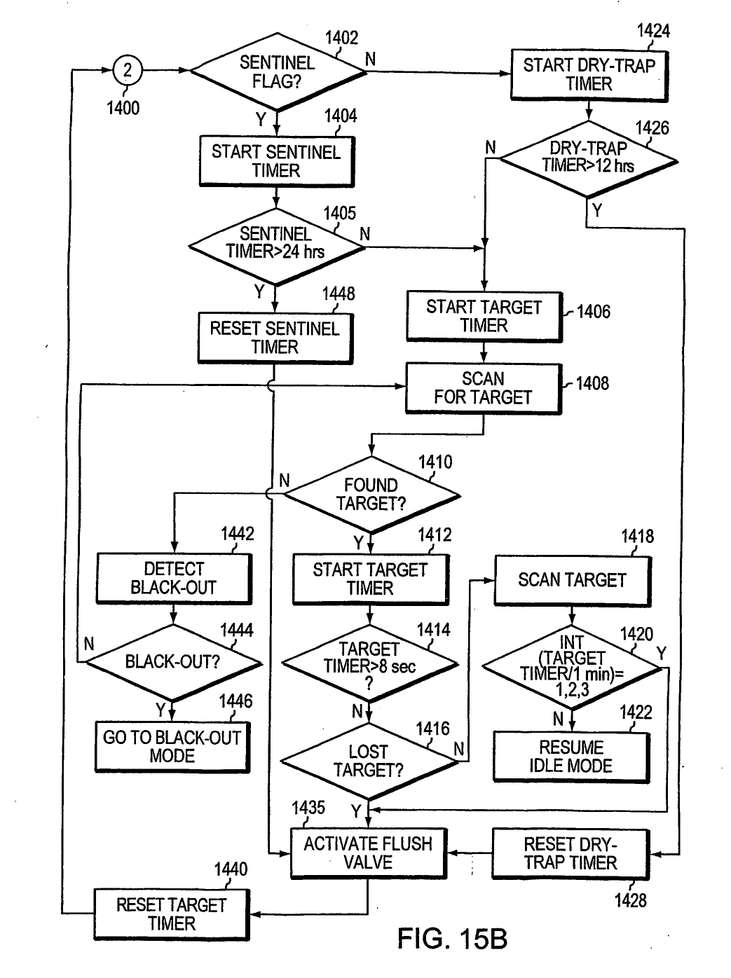

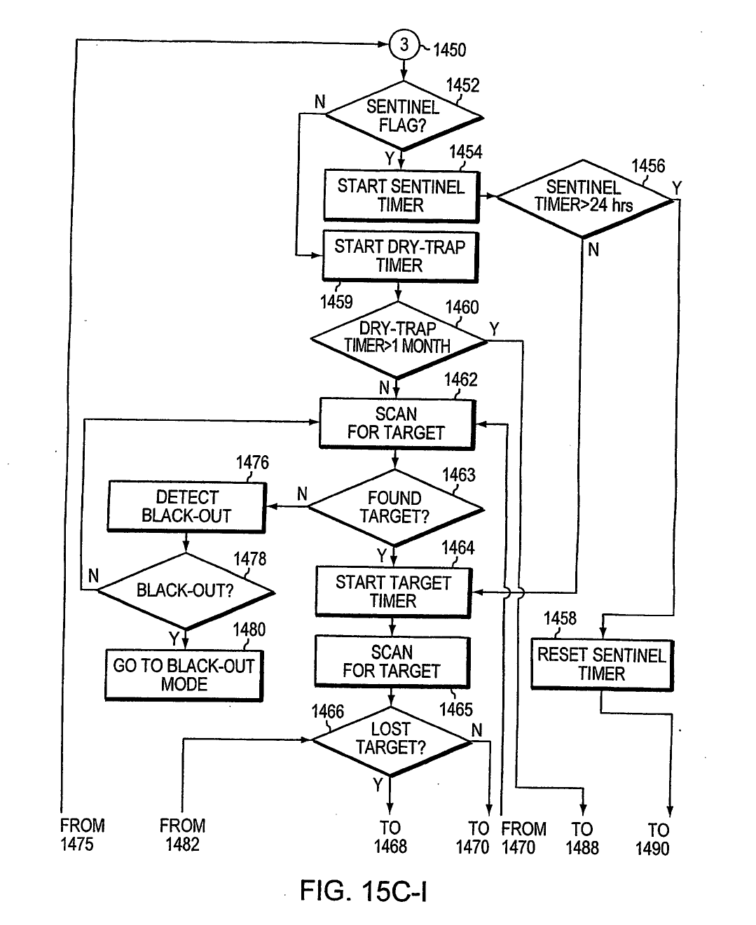

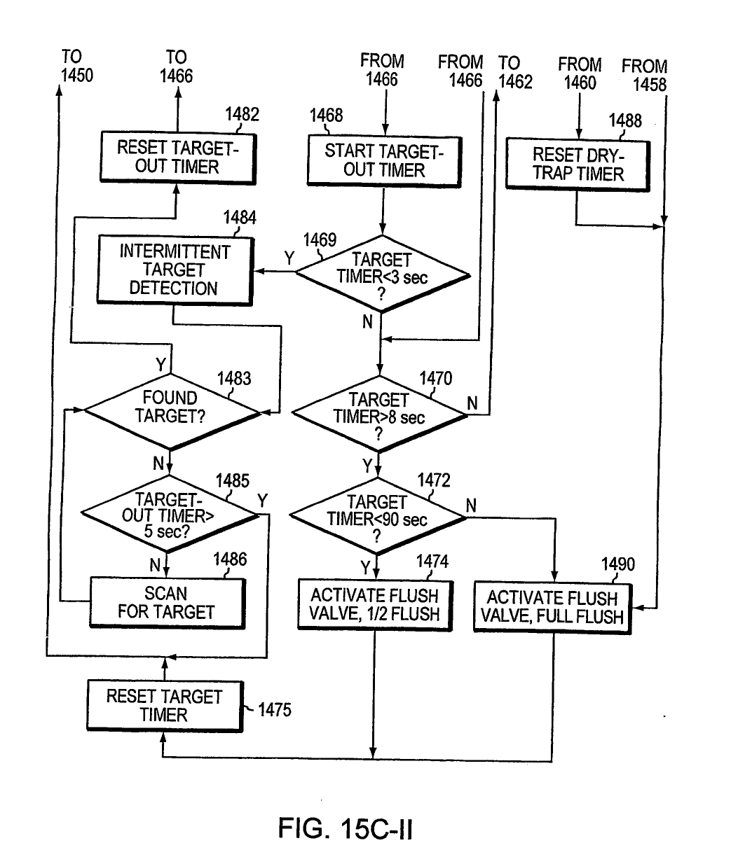

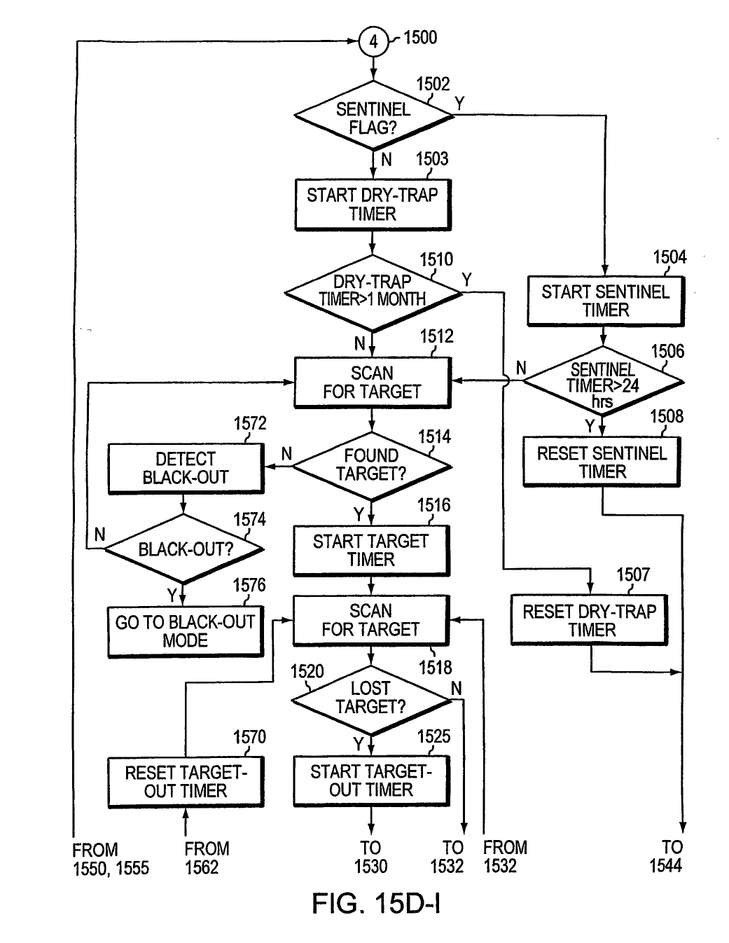

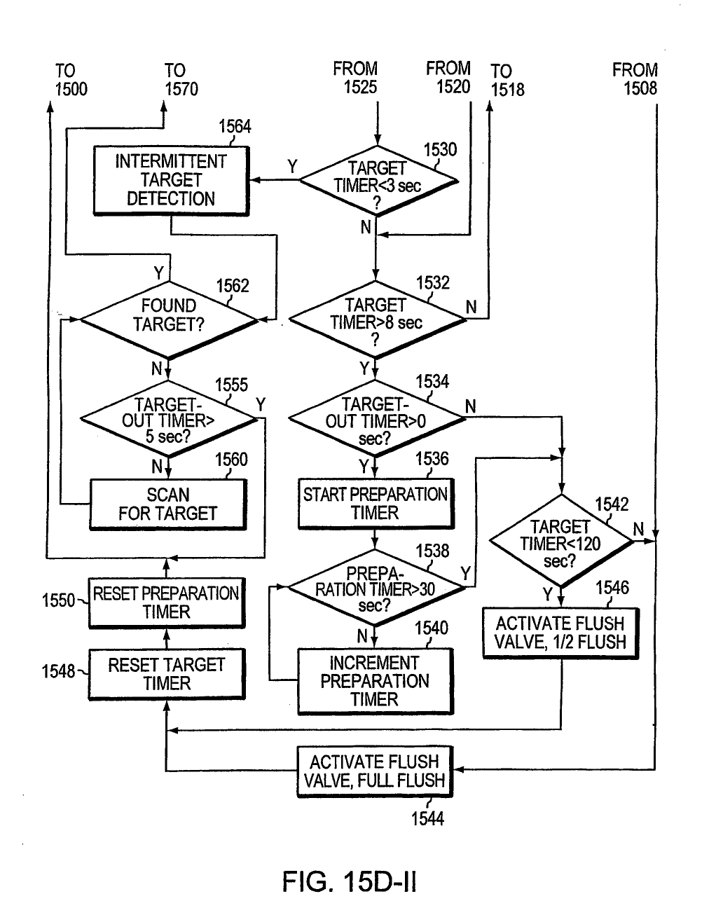

FIG. 15 illustrates flush algorithm 1300 for delivering selected water amounts depending on the use. Algorithm 1300 includes several modes that can be selected manually (using a dip switch upon installation) or automatically (step 1314). Algorithm 1300 can be executed for optical data detected either by the active optical sensor or the passive optical sensor.

FIGS. 15A-I and 15A-II illustrate a standard urinal mode (1320). The algorithm starts the idle timer at step 1322. In step 1324, if the sentinel flag is set (step 1318), the algorithm starts the sentinel timer (step 1342). After starting the sentinel timer at step 1342, if the timer counts for longer than 24 hours before the urinal is flushed or used (step 1344), it is reset at step 1346, and the microcontroller activates a flush after one second (Step 1365). In Step 1344, if the timer counts for less than 24 hours before the facility is flushed, the flusher will simply scan for a target (step 1330). The scan for target routine (step 1330) is also executed when the sentinel flag is not set at step 1324, a dry trap timer is started (step 1326), and it counts for longer than 12 hours (step 1328).

In general, for all modes, the scan for target routine is executed differently for the passive optical sensor and for the active optical sensor. The passive optical sensor detects an approaching target as described in FIGS. 12-12I. The active optical sensor detects an approaching target as described in FIGS. 14-14C.

At Step 1332, if a target is found, the algorithm starts a target timer (Step 1334). If the target timer counts for less than 8 seconds, the algorithm returns to step 1330, and continues scanning for a target. If the target's timer counts for longer than 8 seconds, the algorithm performs another scan for a target in Step 1338. In Step 1340, if the target is lost, the algorithm checks for the value of the time counted by the idle timer minus the target timer (Step 1356). If the difference between the times counted by the two timers is less than 15 seconds, the algorithm activates the valve on every third target detected, providing a water amount equivalent to a half flush (Step 1348). After providing a half flush (Step 1348), the algorithm resets the idle timer (Step 1370), resets the target timer (1372), and starts the idle timer once more to begin the cycle anew at Step 1322.

If the difference between the times counted by the idle timer and the target timer is greater than 15 but less than 30 seconds (Step 1358), the flusher executes a half-flush after one second at Step 1360. It will then restart the algorithm, resetting the idle and target timers (steps 1370 and 1372), and starting the idle timer (step 1322).

If the difference in times counted by the idle timer and the target timer is also greater than 30 seconds (step 1358), then the algorithm executes a full flush after one second (Step 1365). After flushing the toilet or urinal, the idle timer and target timers are reset (Steps 1370 and 1372), and the system restarts the idle timer in Step 1322. At this time, the entire Mode A is repeated.

If a target is not found at step 1332, the algorithm executes a detect blackout routine (Step 1350), where light in the bathroom is measured. If there is light in the bathroom, i.e., there is no “blackout,” the algorithm continues scanning for a target at Step 1330. If there is a blackout (Step 1352), the algorithm enters the blackout mode (Step 1354), in which the flusher enters a “sleep mode” to save battery power. This subroutine detects no use, for example, at night or on weekends.

FIG. 15B illustrates a “Ball Park Urinal Mode” (1400). If the sentinel flag is set at step 1402, the algorithm starts the sentinel timer (Step 1404). If this timer counts for less than 24 hours before the toilet is flushed, a target timer is started (step 1406) and the system scans for a target at step 1408. If a target is found, the target timer is started (step 1412). When the target timer does not count for longer than 8 seconds at step 1414, if the target is lost (step 1416), the flush valve will be activated at step 1435, and the target timer will be reset (step 1440), so the algorithm can begin anew. If the target is not lost at step 1416, a new target scan will take place at step 1418.

Once the sentinel timer counts for longer than 24 hours before the urinal is flushed, the timer is reset (step 1448), the flush valve is activated (step 1435), and the target timer is reset (step 1440), so the whole cycle begins anew.

If a sentinel flag is not set at step 1402, a dry-trap timer is started at step 1424. If at step 1426 this timer has counted for less than 12 hours before the urinal is flushed, the algorithm will next resume at step 1406, where the target timer will begin to count. However, if the dry-trap timer has counted for longer than 12 hours without the urinal being flushed, the timer is reset (step 1428), the flush valve is activated (step 1435), and the target timer is reset (step 1440), so the algorithm can begin once more.

If a target is not found at step 1410, the algorithm executes a detect blackout routine (Step 1442). If there is no blackout, the algorithm continues to step 1408, to scan for a target. If a blackout is detected, the algorithm enters the blackout mode (Step 1446).

FIGS. 15C-I and 15C-II illustrate a “men's closet mode” (1450). If the sentinel flag is set at step 1452, a sentinel timer is started (step 1454), and if it has counted for less than 24 hours (step 1456) before the toilet is flushed, the target timer is started (step 1464). The flusher scans for the target at step 1465, and if it lost the target (step 1466), the target-out timer is started (step 1468). Otherwise, the algorithm resumes at step 1470. If the target timer counts for less than three seconds (step 1469), the microcontroller starts intermittent target detection at step 1484. The three second objective has been added to ascertain that any target found is not simply a passerby. If a target is found (step 1483), the target-out timer is reset at step 1482, and the algorithm goes back to step 1466 to check whether the target is lost once more.

If the target timer counted for over three seconds (step 1469), the microcontroller checks whether the target timer has counted for longer than 8 seconds (step 1470) while the target was lost. If so, it will check whether the period of time counted by the target timer was less than 90 seconds: that is, how long the user was in the facility. If use was for longer than 90 seconds, it will cause a full flush to occur (step 1490). If the timer counted for less than 90 seconds, it will activate the flush valve and cause a half flush (step 1474). Once either flush has occurred, the target timer will be reset at step 1475, and the algorithm will begin once more.

However, if after intermittent target detection the target is still not found at step 1483, the microcontroller checks whether the target-out timer has counted for greater than 5 seconds. It will check for a target (cycle from step 1486 through 1483) until the target-out timer counts for longer than 5 seconds, at which point the algorithm begins anew.

If the sentinel timer counts for longer than 24 hours before flushing occurs (1456), it is reset at step 1458, and a full flush is initiated at step 1490. The target timer is reset at step 1475, and the cycle begins once more.

If the sentinel flag is not set at step 1452, the dry-trap timer will start (step 1459), and if it counts for a short period of time before detecting use, it will begin to scan for a target at step 1462. However, once the timer counts for over one month (step 1460), it will be reset at step 1488, the flush valve will be activated, causing a full flush (step 1490), and the target timer will be reset at step 1475. At that point the algorithm will start once more.

If no target is found at step 1463, the microcontroller will check for a blackout (steps 1476 and 1478). If none is detected at step 1478 it will go back to scanning for a target (step 1462). However, if one is detected, the algorithm will go to blackout mode (step 1480).

FIGS. 15D-I and 15D-II) illustrate a “women's closet mode” (1500). If the sentinel flag is set (step 1502), the sentinel timer starts (step 1504). If the sentinel timer counts for less than 24 hours before the toilet is flushed (1506), target scanning will begin at step 1512. If a target is found (step 1514), the target timer will start (step 1516), and another target scan will occur (step 1518). If the target is lost (step 1520), the target-out timer will be started at step 1525. If in the meantime the target timer has counted for less than three seconds at step 1530, the algorithm will determine that it is sensing intermittent target detection (step 1564), and it will check for a found target once more at step 1562. If a target is not found at step 1562, and the target-out timer has counted for less than 5 seconds (step 1555), the unit will scan for a target once more (step 1560), and move to step 1562. Once a target is found at step 1562, the algorithm will go on to step 1570, reset the target-out timer, and go back to step 1518, where it will continue to scan for a target. If the target is not lost at step 1520, the algorithm will go directly to step 1532.

If the target timer has counted for longer than three seconds at step 1530, it will move on to step 1532, where it will determine if it has counted for greater than 8 seconds. If it has yet to count for more than 8 seconds, the algorithm will go back to step 1518. However, once the target timer has counted for longer than 8 seconds, the microcontroller will go to step 1534, to determine if any time has passed since it activated the target-out timer at step 1525. If the target-out timer has counted at all, the preparation timer will start (step 1536). The algorithm will cause the preparation timer to count for over 30 seconds (steps 1538 and 1540), at which point the microcontroller will determine whether the target timer has counted for less than 120 seconds. If so, the flush valve will be activated, and a half flush will occur (step 1546), after which the target timer and preparation timers will be reset (steps 1548 and 1550), and the algorithm will begin once more.

However, if the target timer has counted for longer than 120 seconds while the preparation timer was counting, the flush valve will be activated, and a full flush will occur at step 1544, after which the target and preparation timers will be reset in steps 1548 and 1550, and the algorithm will begin anew.

If the sentinel flag is not set at step 1502, the dry-trap timer will start (step 1503). If the dry-trap timer counts for a short period of time (step 1510), if will begin to scan for a target at step 1512. However, once the timer counts for over one month (step 1510), it will be reset at step 1507 or 1508, the flush valve will be activated, causing a full flush (step 1544), and the target and preparation timers will be reset at steps 1548 and 1550, so that the algorithm can start once more.

If no target is found at step 1514, the microcontroller will check for a blackout (steps 1572 and 1574). If none is detected at step 1574 it will go back to scanning for a target (step 1512). However, if a blackout is detected, the algorithm will go to blackout mode (step 1576).

Importantly, algorithm 1300 may use the above-described states for the passive optical sensor (FIGS. 12-12I) and the above-described states for the active optical sensor (FIGS. 14-14C). The use of these states significantly reduces errors arising due to variation in target optical properties and ambient light.

Having described various embodiments and implementations of the present invention, it should be apparent to those skilled in the relevant art that the foregoing is illustrative only and not limiting, having been presented by way of example only. There are other embodiments or elements suitable for the above-described embodiments, described in the above-listed publications, all of which are incorporated by reference as if fully reproduced herein. The functions of any one element may be carried out in various ways in alternative embodiments. Also, the functions of several elements may, in alternative embodiments, be carried out by fewer, or a single, element.

1. An electronic system for controlling fluid flow, comprising:
an electromagnetic actuator;
a controller coupled to a power driver constructed to provide a drive signal to said actuator and thereby opening or closing a valve for the fluid flow; and
an optical sensor constructed and arranged to provide a signal to said controller.

2. The electronic system of claim 1 further including a leak detector constructed to detect said fluid flow across said closed valve.

3. The electronic system of claim 2 wherein said leak detector includes at least two electric leads, said electric leads being coupled to measure electric signal across said closed valve to determine said fluid flow across said valve in the closed state.

4. The electronic system of claim 3 wherein said leak detector including said electric leads are constructed and arranged to measure resistance across said closed valve.

5. The electronic system of claim 3 wherein said leak detector including said electric leads are constructed and arranged to measure capacitance across said closed valve.

6. The electronic system of claim 3 wherein said leak detector including said electric leads are constructed and arranged to measure inductance across said closed valve.

7. The electronic system of claim 3 further including an indicator constructed to indicate a leak detected by said leak detector.

8. The electronic system of claim 2 installed to control water flow in a faucet.

9. The electronic system of claim 2 installed to control water flow in a bathroom flusher.

10. An method for controlling a valve system for opening and closing fluid flow, comprising:
providing a controller coupled to a power driver constructed to provide a drive signal to an actuator, said actuator being arranged to cause opening or closing of a fluid valve, said controller being operatively coupled to an optical sensor constructed and arranged to provide a detection signal to said controller;
initiating said optical sensor to sense a target; and
directing signal from said controller to said power driver based on a signal from said sensor.

11. The method for controlling a valve system according to claim 10, wherein said initiating said optical sensor to sense a target includes detecting ambient light.

12. The method for controlling a valve system according to claim 10, wherein said initiating said optical sensor to sense a target includes emitting light from a light emitter and detecting reflected light by a light detector.

13. The method for controlling a valve system according to claim 10 further including detecting a fluid leak across said fluid valve.

14. The method for controlling a valve system according to claim 13 further including indicating existence of said fluid leak.

15. The method for controlling a valve system according to claim 13, wherein said fluid valve is a valve of a faucet.

16. The method for controlling a valve system according to claim 13, wherein said fluid valve is a valve of a bathroom flusher.

17. The method for controlling a valve system according to claim 16, wherein said bathroom flusher provides water to a toilet.

18. The method for controlling a valve system according to claim 17, wherein said bathroom flusher provides different amounts of water depending of the use of said toilet.

19. The method for controlling a valve system according to claim 16, wherein said bathroom flusher provides water to a urinal.

20. The method for controlling a valve system according to claim 19, wherein said bathroom flusher provides different amounts of water depending of the use of said urinal.

21-35. (canceled)

36. The method of controlling a valve system according to claim 10 including periodically sampling said light detector using said controller.

37. The method of controlling a valve system according to claim 10 including determining by said controller said opening and closing of said flow valve based on a background level of said ambient light and a present level of said ambient light.

38. The method of controlling a valve system according to claim 10 wherein said controller constructed to perform said periodic sampling of said detector based on the amount of the amount of light previously detected.

39. The method of controlling a valve system according to claim 10 wherein said controller is constructed to adjust a sample period based on the detected amount of light after determining whether a facility is in use.

40. The method of controlling a valve system according to claim 10 wherein said controller is constructed to cycle sleep and measurement periods.

41-66. (canceled)
